(19) United States
(12) Patent Application Publication
(10) Pub. No.: US 2024/0333164 A1
(43) Pub. Date: Oct. 3, 2024

(54) SWITCH-MODE POWER CONVERTERS IN DISCONTINUOUS CONDUCTION MODE AND METHODS THEREOF

(71) Applicant: ON-BRIGHT ELECTRONICS (SHANGHAI) CO., LTD., Shanghai (CN)

(72) Inventors: TUOFU LIN, Shanghai (CN); QIAN FANG, Shanghai (CN); XIUHONG ZHANG, Shanghai (CN)

(21) Appl. No.: 18/737,490

(22) Filed: Jun. 7, 2024

Related U.S. Application Data
(63) Continuation-in-part of application No. 18/623,531, filed on Apr. 1, 2024.

(30) Foreign Application Priority Data
Mar. 31, 2023 (CN) 202310341749.1
Apr. 10, 2023 (CN) 202310377486.X

(51) Int. Cl. H02M 3/335; H02M 1/00; H02M 3/00

(52) U.S. Cl. CPC H02M 3/33571; H02M 1/0012; H02M 3/01

(57) ABSTRACT

Controller and method for a power converter. According to some embodiments, a controller for a power converter, the power converter including a first transistor and a second transistor coupled to the first transistor, the controller including: a logic controller including a signal generator and configured to generate a first logic signal and a second logic signal; and a driver configured to generate a first control signal and a second control signal based at least in part on the first logic signal and the second logic signal, output the first control signal to the first transistor, and output the second control signal to the second transistor; wherein the signal generator is configured to generate a phase control signal.

### 1. CROSS-REFERENCES TO RELATED APPLICATIONS

This application claims priority to Chinese Patent Application No. 202310377486.X, filed Apr. 10, 2023, incorporated by reference herein for all purposes. Additionally, this application is a continuation-in-part of U.S. patent application Ser. No. 18/623,531, filed Apr. 1, 2024, which claims priority to Chinese Patent Application No. 202310341749.1, filed Mar. 31, 2023. U.S. patent application Ser. No. 18/623,531 is incorporated by reference herein for all purposes, and Chinese Patent Application No. 202310341749.1 is incorporated by reference herein for all purposes.

### 2. FIELD OF THE DISCLOSURE

Certain embodiments of the present disclosure are directed to circuits. More particularly, some embodiments of the disclosure provide discontinuous conduction mode. Merely by way of example, some embodiments of the disclosure have been applied to asymmetrical half-bridge flyback switch-mode power converters. But it would be recognized that the disclosure has a much broader range of applicability.

### 3. BACKGROUND OF THE DISCLOSURE

With the development of consumer electronics, the demand for portable chargers, especially high-power miniaturized chargers with large power density, have increased significantly. Many conventional chargers, such as flyback power supplies, often have large size and low power efficiency. In contrast, conventional chargers that use half-bridge resonant circuit (LLC) often have high power efficiency and high power density, but these conventional chargers usually are costly to make and often do not work well with a wide range of output voltage. For medium and high power levels, asymmetrical half-bridge flyback switch-mode power converters usually can improve power efficiency, reduce charger size, raise power density, and/or reduce charger cost.

FIG. 1 is a simplified diagram showing certain components of a conventional asymmetrical half-bridge flyback switch-mode power converter. The asymmetrical half-bridge flyback switch-mode power converter 100 includes a control unit 110, a switch unit 120, a resonance unit 130, a transformer unit 140, a rectifying unit 150, an output unit 160, and a feedback unit 170.

The switch unit 120 receives an input voltage 101 (e.g., Vᵢₙ) and also receives one or more control signals 111 from the control unit 110. For example, the input voltage 101 (e.g., Vᵢₙ) is a DC voltage. Additionally, the switch unit 120 includes one or more switches. In response to the one or more control signals 111, the one or more switches of the switch unit 120 are opened and/or closed, and the switch unit 120 generates a voltage 121 based at least in part on the input voltage 101 (e.g., Vᵢₙ). The voltage 121 is received by the resonance unit 130, which processes the voltage 121. The resonance unit 130 is directly or indirectly connected to the transformer unit 140, which directly or indirectly outputs a signal 141 to the control unit 110. Additionally, the transformer unit 140 is connected to the rectifying unit 150. The rectifying unit 150 outputs a rectified voltage and/or a rectified current to the output unit 160. In response, the output unit 160 generates an output voltage and/or an output current. Additionally, the output unit 160 is connected to the feedback unit 170, which provides a feedback signal 171 to the control unit 110. Based at least in part on the signal 141 and/or the feedback signal 171, the control unit 110 generates the one or more control signals 111, which are outputted to the switch unit 120. In some examples, the transformer unit 140 represents an ideal transformer that does not include a leakage inductor and also does not include a magnetizing inductor on the primary side. For example, in an equivalent current, an actual transformer includes an ideal transformer and also includes a leakage inductor and a magnetizing inductor on the primary side. As an example, in an equivalent current, if the inductance of the leakage inductor of an actual transformer is equal to zero and the inductance of the magnetizing inductor of the actual transformer is infinite, the actual transformer is an ideal transformer.

FIG. 2 is a simplified diagram showing a conventional asymmetrical half-bridge flyback switch-mode power converter. The asymmetrical half-bridge flyback switch-mode power converter 100 includes a bridge rectifier 296, capacitors 298, 234, 262, 284 and 286, switches 222, 224 and 252, a primary inductor 240, a secondary winding 244, an auxiliary winding 246, a synchronous rectification controller 254, resistors 272, 274, 276, 278, 282 and 294, a shunt regulator 288 (e.g., TL431), an optocoupler 264, and a controller chip 210. For example, in an equivalent circuit, the primary inductor 240 includes a primary winding 242, a magnetizing inductor 248 with a magnetizing inductance Lₘ, and a leakage inductor 232 with a leakage inductance Lᵣ. As an example, in an equivalent circuit, the asymmetrical half-bridge flyback switch-mode power converter 100 includes an actual transformer, which includes an ideal transformer and also includes the leakage inductor 232 and the magnetizing inductor 248 on the primary side, wherein the ideal transformer includes the primary winding 242, the secondary winding 244 and the auxiliary winding 246.

The control unit 110 includes the controller chip 210, the switch unit 120 includes the switches 222 and 224, the resonance unit 130 includes the capacitor 234 and the leakage inductor 232 with the leakage inductance Lᵣ, the transformer unit 140 includes the primary winding 242, the secondary winding 244 and the auxiliary winding 246, the rectifying unit 150 includes the switch 252 and the synchronous rectification controller 254, the output unit 160 includes the capacitor 262, and the feedback unit 170 includes the resistors 272, 274, 276 and 278, the capacitors 284 and 286, the shunt regulator 288 (e.g., TL431), and the optocoupler 264. Also, the controller chip 210 include terminals (e.g., pins) 220, 212, 214, 216, and 218. For example, the switch 222 is a transistor (e.g., a metal-oxide-semiconductor field-effect transistor and/or a gallium nitride transistor). As an example, the switch 224 is a transistor (e.g., a metal-oxide-semiconductor field-effect transistor and/or a gallium nitride transistor).

As shown in FIG. 2, the asymmetrical half-bridge flyback switch-mode power converter 100 receives an AC voltage 290 and generates an output voltage 292 (e.g., Vₒᵤₜ) and an output current 293 (e.g., Iₒᵤₜ). For example, the output current 293 has a positive value if the output current 293 flows out of the asymmetrical half-bridge flyback switch-mode power converter 100.

The switch unit 120 includes the switches 222 and 224. The switch 222 includes terminals 256, 226 and 258, and the switch 224 includes terminals 266, 228 and 268. The terminal 256 of the switch 222 receives the input voltage 101 (e.g., Vᵢₙ), and the terminal 268 of the switch 224 is biased to a ground voltage (e.g., zero volt). The terminal 258 of the switch 222 and the terminal 266 of the switch 224 are connected to each other. The switch unit 120 receives one or more control signals 111, which includes a control signal 211 and a control signal 213. The control signal 211 is received by the terminal 226 of the switch 222, and the control signal 213 is received by the terminal 228 of the switch 224. The switch 222 is opened and/or closed by the control signal 211, and the switch 224 is opened and/or closed by the control signal 213. The terminal 258 of the switch 222 and the terminal 266 of the switch 224 are biased to the voltage 121 (e.g., V_{HB}).

The resonance unit 130 includes the capacitor 234 and the leakage inductor 232 with the leakage inductance Lᵣ. A current 233 (e.g., I_{Lr}) flows through the leakage inductor 232 with the leakage inductance Lᵣ. For example, the current 233 (e.g., I_{Lr}) has a positive value if the current 233 flows from the leakage inductor 232 to the magnetizing inductor 248 and/or the primary winding 242. As an example, the current 233 (e.g., I_{Lr}) has a negative value if the current 233 flows from the magnetizing inductor 248 and/or the primary winding 242 to the leakage inductor 232.

One terminal of the leakage inductor 232 receives the voltage 121 from the terminal 258 of the switch 222 and the terminal 266 of the switch 224, and another terminal of the leakage inductor 232 is connected to one terminal of the primary winding 242 and one terminal of the magnetizing inductor 248. Additionally, one terminal of the capacitor 234 is connected to the terminal 268 of the switch 224 and is biased to the ground voltage (e.g., zero volt). Another terminal of the capacitor 234 is connected to another terminal of the primary winding 242 and another terminal of the magnetizing inductor 248. For example, the magnetizing inductor 248 and the primary winding 242 are connected in parallel. As an example, the primary winding 242 is a part of the ideal transformer that also includes the secondary winding 244 and the auxiliary winding 246.

A magnetization current 249 (e.g., I_{Lm}) flows through the magnetizing inductor 248 with the magnetizing inductance Lₘ. For example, the magnetization current 249 (e.g., I_{Lm}) has a positive value if the magnetization current 249 flows from the magnetizing inductor 248 to the capacitor 234. As an example, the magnetization current 249 (e.g., I_{Lm}) has a negative value if the magnetization current 249 flows from the capacitor 234 to the magnetizing inductor 248. Additionally, a current 247 (e.g., Iₚᵣᵢ) flows through the primary winding 242. For example, the current 247 (e.g., Iₚᵣᵢ) has a positive value if the current 247 flows from the primary winding 242 to the capacitor 234. As an example, the current 247 (e.g., Iₚᵣᵢ) has a negative value if the current 247 flows from the capacitor 234 to the primary winding 242. Moreover, the current 233 (e.g., I_{Lr}) is equal to a sum of the magnetization current 249 (e.g., I_{Lm}) and the current 247 (e.g., Iₚᵣᵢ). For example, if the current 247 (e.g., Iₚᵣᵢ) is equal to zero, the current 233 (e.g., I_{Lr}) is equal to the magnetization current 249 (e.g., I_{Lm}). As an example, if the current 247 (e.g., Iₚᵣᵢ) is not equal to zero, the current 233 (e.g., I_{Lr}) is not equal to the magnetization current 249 (e.g., I_{Lm}). Also, a secondary current 245 (e.g., I_{sec}) flows through the secondary winding 244. For example, the secondary current 245 (e.g., I_{sec}) has a positive value if the secondary current 245 flows from the switch 252 to the secondary winding 244. As an example, the secondary current 245 (e.g., I_{sec}) has a negative value if the secondary current 245 flows from the secondary winding 244 to the switch 252.

The auxiliary winding 246 is connected to the resistors 294 and 282, which generate the signal 141 and outputs the signal 141 to the control unit 110. Additionally, the secondary winding 244 is connected to the rectifying unit 150, which includes the switch 252 and the synchronous rectification controller 254. The synchronous rectification controller 254 generates a control signal 253, which is used to open and/or close the switch 252.

The rectifying unit 150 is connected to the output unit 160, which is configured to generate the output voltage (e.g., the output voltage 292) and/or the output current (e.g., the output current 293). The output unit 160 includes the capacitor 262, and the capacitor 262 is used to reduce and/or eliminate the ripple in the output voltage (e.g., the output voltage 292). Additionally, the output unit 160 is also connected to the feedback unit 170, which includes the resistors 272, 274, 276 and 278, the capacitors 284 and 286, the shunt regulator 288 (e.g., TL431), and the optocoupler 264. The feedback unit 170 outputs the feedback signal 171 to the control unit 110.

The control unit 110 includes the controller chip 210, which includes the terminals (e.g., pins) 220, 212, 214, 216, and 218. The terminal 220 (e.g., GH) outputs the control signal 211, and the terminal 212 (e.g., GL) outputs the control signal 213. Additionally, the terminal 214 (e.g., AUX) receives the signal 141, and the terminal 216 (e.g., FB) receives the signal 171. Moreover, the terminal 218 (e.g., GND) is biased to the ground voltage (e.g., zero volt).

The asymmetrical half-bridge flyback switch-mode power converter 100 operates in different modes. For example, the asymmetrical half-bridge flyback switch-mode power converter 100 operates in a critical conduction mode (CRM). As an example, the asymmetrical half-bridge flyback switch-mode power converter 100 operates in a discontinuous conduction mode (DCM). For example, the asymmetrical half-bridge flyback switch-mode power converter 100 operates in a burst mode. Also, as shown in FIG. 2, the resonance unit 130 is coupled to the terminals 266 and 268 of the switch 224, but alternatively, the resonance unit 130 is coupled to the terminals 256 and 258 of the switch 222.

Hence it is highly desirable to improve the technique for switch-mode power converters.

### 4. BRIEF SUMMARY OF THE DISCLOSURE

Certain embodiments of the present disclosure are directed to circuits. More particularly, some embodiments of the disclosure provide discontinuous conduction mode. Merely by way of example, some embodiments of the disclosure have been applied to asymmetrical half-bridge flyback switch-mode power converters. But it would be recognized that the disclosure has a much broader range of applicability.

According to some embodiments, a controller for a power converter, the power converter including a first transistor and a second transistor coupled to the first transistor, the controller including: a logic controller including a signal generator and configured to generate a first logic signal and a second logic signal; and a driver configured to generate a first control signal and a second control signal based at least in part on the first logic signal and the second logic signal, output the first control signal to the first transistor, and output the second control signal to the second transistor; wherein the signal generator is configured to generate a phase control signal; wherein the signal generator is further configured to: change the phase control signal from a first logic level to a second logic level to start a first switching phase of a first period of a discontinuous conduction mode; change the phase control signal from the second logic level to the first logic level to end the first switching phase of the first period of the discontinuous conduction mode and to start a first idle phase of the first period of the discontinuous conduction mode; and change the phase control signal from the first logic level to the second logic level to end the first idle phase of the first period of the discontinuous conduction mode and to start a second switching phase of a second period of the discontinuous conduction mode; wherein: the first period of the discontinuous conduction mode includes the first switching phase and the first idle phase; and the first switching phase of the first period of the discontinuous conduction mode includes N cycles of a critical conduction mode, N being a positive integer.

According to certain embodiments, a controller for a power converter includes: a logic controller configured to generate a first logic signal and a second logic signal; and a driver configured to generate a first control signal and a second control signal based at least in part on the first logic signal and the second logic signal; wherein the logic controller includes a determination unit configured to: receive a first input signal indicating a first envelope period of a first period of a discontinuous conduction mode; receive a second input signal indicating a first number of cycles of a critical conduction mode for a first switching phase of the first period of the discontinuous conduction mode; determine an average switching frequency for the first period of the discontinuous conduction mode based at least in part on the first input signal and the second input signal; compare the determined average switching frequency for the first period of the discontinuous conduction mode with a predetermined reference frequency value to generate a comparison result; and determine a second number of cycles of the critical conduction mode for a second switching phase of a second period of the discontinuous conduction mode based on at least information associated with the comparison result; wherein: the first switching phase of the first period of the discontinuous conduction mode includes the first number of cycles of the critical conduction mode; and the second switching phase of the second period of the discontinuous conduction mode includes the second number of cycles of the critical conduction mode.

According to some embodiments, a controller for a power converter includes: a logic controller configured to generate a first logic signal and a second logic signal; and a driver configured to generate a first control signal and a second control signal based at least in part on the first logic signal and the second logic signal; wherein the logic controller includes a determination unit configured to: receive a first input signal indicating an envelope period of a first period of a discontinuous conduction mode; determine an envelope frequency of the first period of the discontinuous conduction mode based at least in part on the first input signal; compare the envelope frequency of the first period of the discontinuous conduction mode with at least one value selected from a group consisting of a predetermined reference frequency value and a predetermined threshold frequency value to generate a comparison result; receive a second input signal indicating a first number of cycles of a critical conduction mode for a first switching phase of the first period of the discontinuous conduction mode; and determine a second number of cycles of the critical conduction mode for a second switching phase of a second period of the discontinuous conduction mode based on at least information associated with the comparison result and the second input signal; wherein the predetermined threshold frequency value is larger than the predetermined reference frequency value; wherein: the first switching phase of the first period of the discontinuous conduction mode includes the first number of cycles of the critical conduction mode; and the second switching phase of the second period of the discontinuous conduction mode includes the second number of cycles of the critical conduction mode.

According to certain embodiments, a method for a power converter including a first transistor and a second transistor coupled to the first transistor, the method including: generating a first logic signal and a second logic signal; receiving the first logic signal and the second logic signal; generating a first control signal and a second control signal based at least in part on the first logic signal and the second logic signal; outputting the first control signal to the first transistor; and outputting the second control signal to the second transistor; wherein the generating a first logic signal and a second logic signal includes generating a phase control signal; wherein the generating a phase control signal includes: changing the phase control signal from a first logic level to a second logic level to start a first switching phase of a first period of a discontinuous conduction mode; changing the phase control signal from the second logic level to the first logic level to end the first switching phase of the first period of the discontinuous conduction mode and to start a first idle phase of the first period of the discontinuous conduction mode; and changing the phase control signal from the first logic level to the second logic level to end the first idle phase of the first period of the discontinuous conduction mode and to start a second switching phase of a second period of the discontinuous conduction mode; wherein: the first period of the discontinuous conduction mode includes the first switching phase and the first idle phase; and the first switching phase of the first period of the discontinuous conduction mode includes N cycles of a critical conduction mode, N being a positive integer.

According to some embodiments, a method for a power converter includes: generating a first logic signal and a second logic signal; receiving the first logic signal and the second logic signal; and generating a first control signal and a second control signal based at least in part on the first logic signal and the second logic signal; wherein the generating a first logic signal and a second logic signal includes: receiving a first input signal indicating a first envelope period of a first period of a discontinuous conduction mode; receiving a second input signal indicating a first number of cycles of a critical conduction mode for a first switching phase of the first period of the discontinuous conduction mode; determining an average switching frequency for the first period of the discontinuous conduction mode based at least in part on the first input signal and the second input signal; comparing the determined average switching frequency for the first period of the discontinuous conduction mode with a predetermined reference frequency value to generate a comparison result; and determining a second number of cycles of the critical conduction mode for a second switching phase of a second period of the discontinuous conduction mode based on at least information associated with the comparison result; wherein: the first switching phase of the first period of the discontinuous conduction mode includes the first number of cycles of the critical conduction mode; and the second switching phase of the second period of the discontinuous conduction mode includes the second number of cycles of the critical conduction mode.

According to certain embodiments, a method for a power converter includes: generating a first logic signal and a second logic signal; receiving the first logic signal and the second logic signal; and generating a first control signal and a second control signal based at least in part on the first logic signal and the second logic signal; wherein the generating a first logic signal and a second logic signal includes: receiving a first input signal indicating an envelope period of a first period of a discontinuous conduction mode; determining an envelope frequency of the first period of the discontinuous conduction mode based at least in part on the first input signal; comparing the envelope frequency of the first period of the discontinuous conduction mode with at least one value selected from a group consisting of a predetermined reference frequency value and a predetermined threshold frequency value to generate a comparison result; receiving a second input signal indicating a first number of cycles of a critical conduction mode for a first switching phase of the first period of the discontinuous conduction mode; and determining a second number of cycles of the critical conduction mode for a second switching phase of a second period of the discontinuous conduction mode based on at least information associated with the comparison result and the second input signal; wherein the predetermined threshold frequency value is larger than the predetermined reference frequency value; wherein: the first switching phase of the first period of the discontinuous conduction mode includes the first number of cycles of the critical conduction mode; and the second switching phase of the second period of the discontinuous conduction mode includes the second number of cycles of the critical conduction mode.

Depending upon embodiment, one or more benefits may be achieved. These benefits and various additional objects, features and advantages of the present disclosure can be fully appreciated with reference to the detailed description and accompanying drawings that follow.

### 5. BRIEF DESCRIPTION OF THE DRAWINGS

FIG. 1 is a simplified diagram showing certain components of a conventional asymmetrical half-bridge flyback switch-mode power converter.

FIG. 2 is a simplified diagram showing a conventional asymmetrical half-bridge flyback switch-mode power converter.

FIG. 3 shows simplified timing diagrams for the conventional asymmetrical half-bridge flyback switch-mode power converter as shown in FIG. 2 in the critical conduction mode (CRM) according to some embodiments.

FIG. 4 shows simplified timing diagrams for the conventional asymmetrical half-bridge flyback switch-mode power converter as shown in FIG. 2 in the discontinuous conduction mode (DCM) according to certain embodiments.

FIG. 5 is a simplified diagram showing an asymmetrical half-bridge flyback switch-mode power converter according to certain embodiments of the present disclosure.

FIG. 6 is a simplified diagram showing the controller chip of the asymmetrical half-bridge flyback switch-mode power converter as shown in FIG. 5 according to some embodiments of the present disclosure.

FIG. 7 shows simplified timing diagrams for the asymmetrical half-bridge flyback switch-mode power converter as shown in FIG. 5 and FIG. 6 in a discontinuous conduction mode (DCM) with N equal to 3 according to some embodiments of the present disclosure.

FIG. 8A is a simplified diagram showing a peak value of the magnetization current as a function of the output current for the asymmetrical half-bridge flyback switch-mode power converter as shown in FIG. 5 and FIG. 6 according to certain embodiments of the present disclosure.

FIG. 8B is a simplified diagram showing an envelope frequency of the discontinuous conduction mode (DCM) as a function of the output current, showing an average switching frequency of the discontinuous conduction mode (DCM) as a function of the output current, and showing a switching frequency of the critical conduction mode (CRM) as a function of the output current for the asymmetrical half-bridge flyback switch-mode power converter as shown in FIG. 5 and FIG. 6 according to some embodiments of the present disclosure.

FIG. 8C is a simplified diagram showing the number of cycles of critical conduction mode (CRM) during a switching phase of the discontinuous conduction mode (DCM) as a function of the output current for the asymmetrical half-bridge flyback switch-mode power converter as shown in FIG. 5 and FIG. 6 according to certain embodiments of the present disclosure.

FIG. 9A is a simplified diagram showing a peak value of the magnetization current as a function of the output current for the asymmetrical half-bridge flyback switch-mode power converter as shown in FIG. 5 and FIG. 6 according to certain embodiments of the present disclosure.

FIG. 9B is a simplified diagram showing an envelope frequency of the discontinuous conduction mode (DCM) as a function of the output current, showing an average switching frequency of the discontinuous conduction mode (DCM) as a function of the output current, and showing a switching frequency of the critical conduction mode (CRM) as a function of the output current for the asymmetrical half-bridge flyback switch-mode power converter as shown in FIG. 5 and FIG. 6 according to some embodiments of the present disclosure.

FIG. 9C is a simplified diagram showing the number of cycles of critical conduction mode (CRM) during a switching phase of the discontinuous conduction mode (DCM) as a function of the output current for the asymmetrical half-bridge flyback switch-mode power converter as shown in FIG. 5 and FIG. 6 according to certain embodiments of the present disclosure.

FIG. 10A is a simplified diagram showing the output current as a function of time for the asymmetrical half-bridge flyback switch-mode power converter as shown in FIG. 5 and FIG. 6 according to certain embodiments of the present disclosure.

FIG. 10B is a simplified diagram showing the control signal as a function of time and showing a peak value of the magnetization current as a function of the output current for the asymmetrical half-bridge flyback switch-mode power converter as shown in FIG. 5 and FIG. 6 according to some embodiments of the present disclosure.

FIG. 10C is a simplified diagram showing an envelope frequency of the discontinuous conduction mode (DCM) as a function of time, showing an average switching frequency of the discontinuous conduction mode (DCM) as a function of time, and showing a switching frequency of the critical conduction mode (CRM) as a function of time for the asymmetrical half-bridge flyback switch-mode power converter as shown in FIG. 5 and FIG. 6 according to certain embodiments of the present disclosure.

FIG. 10D is a simplified diagram showing the number of cycles of critical conduction mode (CRM) during a switching phase of the discontinuous conduction mode (DCM) as a function of time for the asymmetrical half-bridge flyback switch-mode power converter as shown in FIG. 5 and FIG. 6 according to some embodiments of the present disclosure.

FIG. 11 is a simplified diagram showing certain components of the logic controller as part of the controller chip of the asymmetrical half-bridge flyback switch-mode power converter as shown in FIG. 5 and FIG. 6 according to certain embodiments of the present disclosure.

FIG. 12 is a simplified diagram showing the current-N determination unit of the logic controller as part of the controller chip of the asymmetrical half-bridge flyback switch-mode power converter as shown in FIG. 5, FIG. 6 and FIG. 11 according to some embodiments of the present disclosure.

FIG. 13 shows simplified timing diagrams for the asymmetrical half-bridge flyback switch-mode power converter as shown in FIG. 5, FIG. 6, FIG. 11 and FIG. 12 in a discontinuous conduction mode (DCM) according to some embodiments of the present disclosure.

FIG. 14 is a simplified diagram showing the current-N determination unit of the logic controller as part of the controller chip of the asymmetrical half-bridge flyback switch-mode power converter as shown in FIG. 5, FIG. 6 and FIG. 11 according to some embodiments of the present disclosure.

FIG. 15 is a simplified diagram showing a method for the logic controller of the controller chip as part of the asymmetrical half-bridge flyback switch-mode power converter as shown in FIG. 5 and FIG. 6 according to certain embodiments of the present disclosure.

FIG. 16 is a simplified diagram showing a method for determining the number of cycles of critical conduction mode (CRM) for a switching phase of a current cycle of the discontinuous conduction mode (DCM) according to some embodiments of the present disclosure.

FIG. 17 is a simplified diagram showing a method for determining the number of cycles of critical conduction mode (CRM) for a switching phase of a current cycle of the discontinuous conduction mode (DCM) according to certain embodiments of the present disclosure.

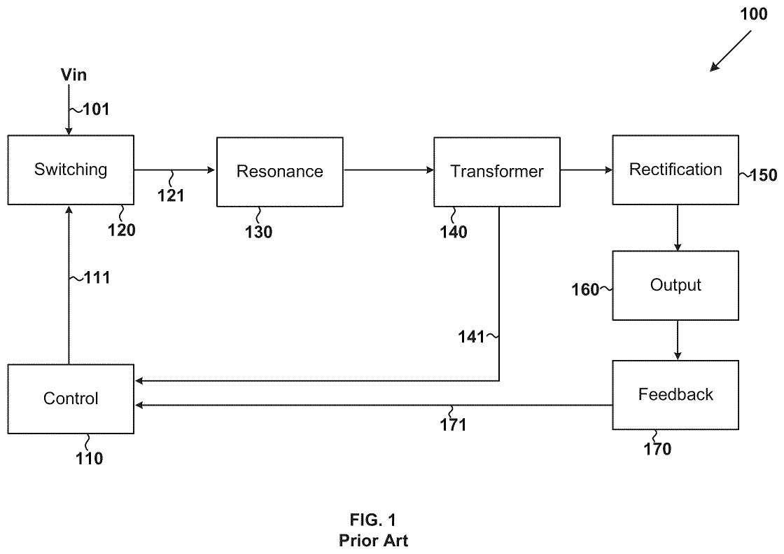

### 6. DETAILED DESCRIPTION OF THE DISCLOSURE

Certain embodiments of the present disclosure are directed to circuits. More particularly, some embodiments of the disclosure provide discontinuous conduction mode. Merely by way of example, some embodiments of the disclosure have been applied to asymmetrical half-bridge flyback switch-mode power converters. But it would be recognized that the disclosure has a much broader range of applicability.

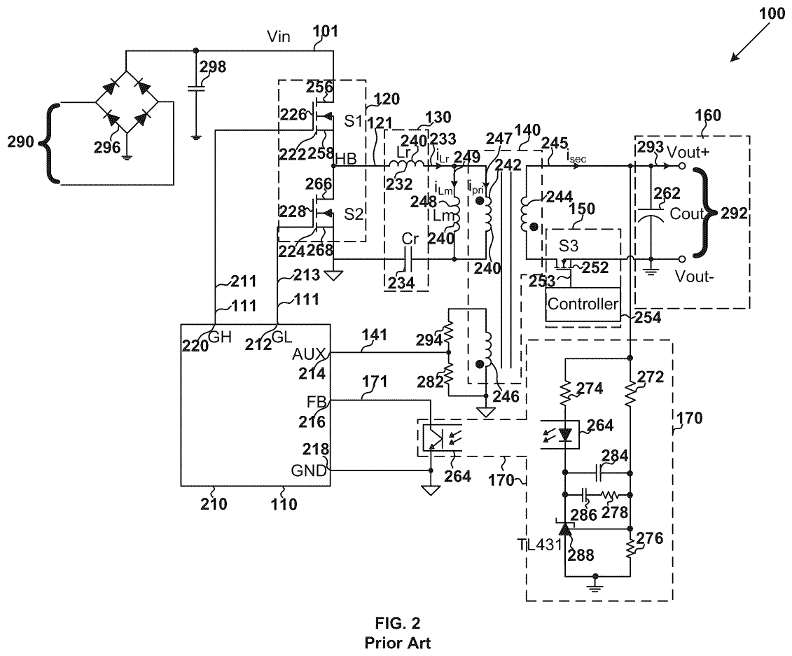

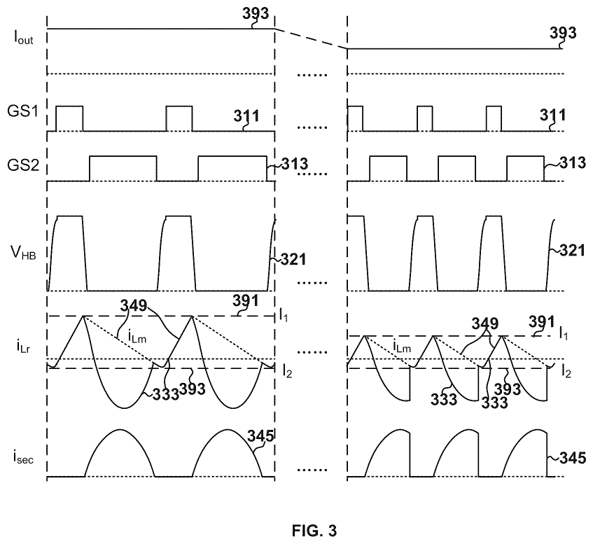

FIG. 3 shows simplified timing diagrams for the conventional asymmetrical half-bridge flyback switch-mode power converter 100 as shown in FIG. 2 in the critical conduction mode (CRM) according to some embodiments. The waveform 393 represents the output current 293 as a function of time, the waveform 311 represents the control signal 211 as a function of time, the waveform 313 represents the control signal 213 as a function of time, the waveform 321 represents the voltage 121 as a function of time, the waveform 333 represents the current 233 as a function of time, the waveform 349 represents the magnetization current 249 as a function of time, and the waveform 345 represents the secondary current 245 as a function of time. In some examples, the conventional asymmetrical half-bridge flyback switch-mode power converter 100 operates in the critical conduction mode (CRM) under heavy load. For example, if the control signal 211 is at a logic high level, the switch 222 is closed, and if the control signal 211 is at a logic low level, the switch 222 is open. As an example, if the control signal 213 is at a logic high level, the switch 224 is closed, and if the control signal 213 is at a logic low level, the switch 224 is open. In certain examples, the waveform 333 is shown as a solid line, and the waveform 349 is shown as a dashed line. For example, when the current 233 (e.g., I_{Lr}) is not equal to the magnetization current 249 (e.g., I_{Lm}), both the solid line and the dashed line are visible in FIG. 3. As an example, when the current 233 (e.g., I_{Lr}) is equal to the magnetization current 249 (e.g., I_{Lm}), the solid line is visible but the dashed line is not visible in FIG. 3.

As shown by the waveform 311, when the control signal 211 is at the logic high level and the switch 222 is closed, the current 233 and the magnetization current 249 are equal to each other as shown by the waveform 333 and the waveform 349 according to certain embodiments. Also as shown by the waveform 313, when the control signal 213 is at the logic high level and the switch 224 is closed, the magnetization current 249 decreases from a current value 391 (e.g., I₁) to a current value 393 (e.g., I₂), wherein the current value 391 is larger than zero and the current level 393 is smaller than zero, according to some embodiments. For example, the current value 391 (e.g., I₁) is the peak value of the magnetization current 249. As an example, the current value 393 (e.g., I₂) is the valley value of the magnetization current 249. In certain examples, in the critical conduction mode (CRM), the current value 393 (e.g., I₂) is adjusted in order to achieve zero-voltage switching for the switch 222.

As shown by the waveforms 311 and 313, when the control signal 211 is at the logic high level and the control signal 213 is at the logic low level, the switch 222 is closed and the switch 224 is open according to certain embodiments. In some examples, if the switch 222 is closed and the switch 224 is open, the input voltage 101 (e.g., Vᵢₙ) stores energy to the actual transformer and the capacitor 234, wherein the actual transformer includes the ideal transformer, the leakage inductor 232 and the magnetizing inductor 248, and the ideal transformer includes the primary winding 242, the secondary winding 244 and the auxiliary winding 246.

Also as shown by the waveforms 311 and 313, when the control signal 211 is at the logic low level and the control signal 213 is at the logic high level, the switch 222 is open and the switch 224 is closed, according to some embodiments. In certain examples, if the switch 222 is open and the switch 224 is closed, through the resonance of the leakage inductor 232 and the capacitor 234 and through the magnetizing inductor 248, the energy is transferred to the secondary side of the actual transformer (e.g., the secondary winding 244).

In certain embodiments, as shown by the waveform 393, the output current 293 is determined as follows:

$${I}_{out} = \frac{{N}_{ps}}{2} ( {I}_{1} + {I}_{2} ) \qquad ( Equation 1 )$$

where Iₒᵤₜ represents the output current 293. Additionally, Nₚₛ represents the turns ratio that is equal to the ratio of the number of turns in the primary winding 242 to the number of turns in the secondary winding 244. Moreover, I₁ represents the current value 391, which is the peak value of the magnetization current 249. Also, I₂ represents the current value 393, which is the valley value of the magnetization current 249. For example, according to Equation 1, the current value 391 (e.g., I₁) is adjusted in order to adjust Iₒᵤₜ.

In some embodiments, during the resonance of the leakage inductor 232 and the capacitor 234, the resonance frequency is determined as follows:

$${f}_{r} = \frac{1}{2 π \sqrt{{L}_{r} {C}_{r}}} \qquad ( Equation 2 )$$

where fᵣ represents the resonance frequency. Additionally, Lᵣ represents the inductance of the leakage inductor 232, and Cᵣ represents the capacitance of the capacitor 234. For example, according to Equation 2, the resonance frequency depends on the inductance of the leakage inductor 232 and the capacitance of the capacitor 234. As an example, the resonance period for the resonance of the leakage inductor 232 and the capacitor 234 is determined as follows:

$$\\ \begin{matrix}{T}_{r} = \frac{1}{{f}_{r}} = 2 π \sqrt{{L}_{r} {C}_{r}} & ( Equation 3 )\end{matrix}$$

where Tᵣ represents the resonance period. Additionally, Lᵣ represents the inductance of the leakage inductor 232, and Cᵣ represents the capacitance of the capacitor 234.

As shown in FIG. 3, the magnetization current 249 is equal to the current value 391 (e.g., I₁) at the beginning of a demagnetization process, and the magnetization current 249 is equal to the current value 393 (e.g., I₂) at the end of the demagnetization process according to certain embodiments. For example, the time duration for the magnetization current 249 to decreases from the current value 391 (e.g., I₁) to the current value 393 (e.g., I₂) is a demagnetization period. As an example, in order to achieve low-voltage switching and/or zero-voltage switching on both the primary side and the secondary side of the actual transistor, the following condition needs to be satisfied:

$$\\ \begin{matrix}{T}_{dem} \approx 0.6 \times {T}_{r} & ( Equation 4 )\end{matrix}$$

where T_{dem} represents the demagnetization period, and Tᵣ represents the resonance period.

Also as shown in FIG. 3, if the load of the asymmetrical half-bridge flyback switch-mode power converter 100 decreases, the peak value of the magnetization current 249 (e.g., I₁) decreases according to some embodiments. For example, if the load of the asymmetrical half-bridge flyback switch-mode power converter 100 decreases, the demagnetization period also decreases. As an example, if the load of the asymmetrical half-bridge flyback switch-mode power converter 100 decreases, the switching frequency of the asymmetrical half-bridge flyback switch-mode power converter 100 also decreases. In certain examples, as shown by the waveform 313, when the control signal 213 changes from the logic high level to the logic low level and the switch 224 becomes open, the current 233 experiences a sudden change and the secondary current 245 also experiences a sudden change. For example, if the load of the asymmetrical half-bridge flyback switch-mode power converter 100 decreases, when the control signal 213 changes from the logic high level to the logic low level and the switch 224 becomes open, the magnitude of the sudden change in the current 233 and the magnitude of the sudden change in the secondary current 245 become larger. As an example, if the load of the asymmetrical half-bridge flyback switch-mode power converter 100 decreases, the efficiency of the conventional asymmetrical half-bridge flyback switch-mode power converter 100 operates in the critical conduction mode (CRM) becomes lower.

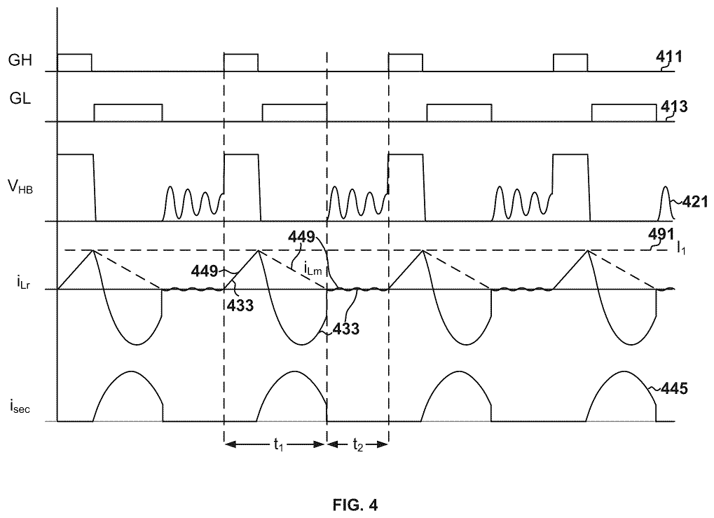

In certain embodiments, when the load of the asymmetrical half-bridge flyback switch-mode power converter 100 is low, the conventional asymmetrical half-bridge flyback switch-mode power converter 100 changes its mode from the critical conduction mode (CRM) to the discontinuous conduction mode (DCM). FIG. 4 shows simplified timing diagrams for the conventional asymmetrical half-bridge flyback switch-mode power converter 100 as shown in FIG. 2 in the discontinuous conduction mode (DCM) according to certain embodiments. The waveform 411 represents the control signal 211 as a function of time, the waveform 413 represents the control signal 213 as a function of time, the waveform 421 represents the voltage 121 as a function of time, the waveform 433 represents the current 233 as a function of time, the waveform 449 represents the magnetization current 249 as a function of time, and the waveform 445 represents the secondary current 245 as a function of time. In some examples, the waveform 433 is shown as a solid line, and the waveform 449 is shown as a dashed line. For example, when the current 233 (e.g., I_{Lr}) is not equal to the magnetization current 249 (e.g., I_{Lm}), both the solid line and the dashed line are visible in FIG. 4. As an example, when the current 233 (e.g., I_{Lr}) is equal to the magnetization current 249 (e.g., I_{Lm}), the solid line is visible but the dashed line is not visible in FIG. 4. In certain examples, each period of the discontinuous conduction mode (DCM) includes a switching phase (e.g., a time duration t₁) and an idle phase (e.g., a time duration t₂). For example, during the time duration t₁, the control signal 211 is at the logic high level and the control signal 213 is at the logic low level, and afterwards, the control signal 211 is at the logic low level and the control signal 213 is at the logic high level. As an example, during the time duration t₂, both the control signals 211 and 213 are at the logic low level, and both the switches 222 and 224 are open.

In some embodiments, the magnetization current 249 changes between a current value 491 (e.g., a peak value) and zero. For example, as shown in FIG. 4, when the asymmetrical half-bridge flyback switch-mode power converter 100 operates in the discontinuous conduction mode (DCM), the output current 293 is determined as follows:

$$\\ \begin{matrix}{I}_{out} = \frac{{N}_{ps}}{2} \times {I}_{1} \times \frac{{t}_{1}}{{t}_{1} + {t}_{2}} & ( Equation 5 )\end{matrix}$$

where Iₒᵤₜ represents the output current 293. Additionally, Nₚₛ represents the turns ratio that is equal to the ratio of the number of turns in the primary winding 242 to the number of turns in the secondary winding 244. Moreover, I₁ represents the current value 491, which is the peak value of the magnetization current 249. Also, t₁ represents the time duration when the asymmetrical half-bridge flyback switch-mode power converter 100 is in the switching phase of the discontinuous conduction mode (DCM), and t₂ represents the time duration when the asymmetrical half-bridge flyback switch-mode power converter 100 is in the idle phase of the discontinuous conduction mode (DCM).

In certain embodiments, according to Equation 5, when the asymmetrical half-bridge flyback switch-mode power converter 100 operates in the discontinuous conduction mode (DCM), the switching phase (e.g., the time duration t₂) is changed in order to adjust the load (e.g., the output current 293) of the asymmetrical half-bridge flyback switch-mode power converter 100. For example, when the asymmetrical half-bridge flyback switch-mode power converter 100 operates in the discontinuous conduction mode (DCM), the peak value of the magnetization current 249 (e.g., I₁) is set so that the demagnetization period satisfies the following condition in order to achieve high efficiency:

$$\\ \begin{matrix}{T}_{dem} \approx 0.6 \times {T}_{r} & ( Equation 6 )\end{matrix}$$

where T_{dem} represents the demagnetization period, and Tᵣ represents the resonance period.

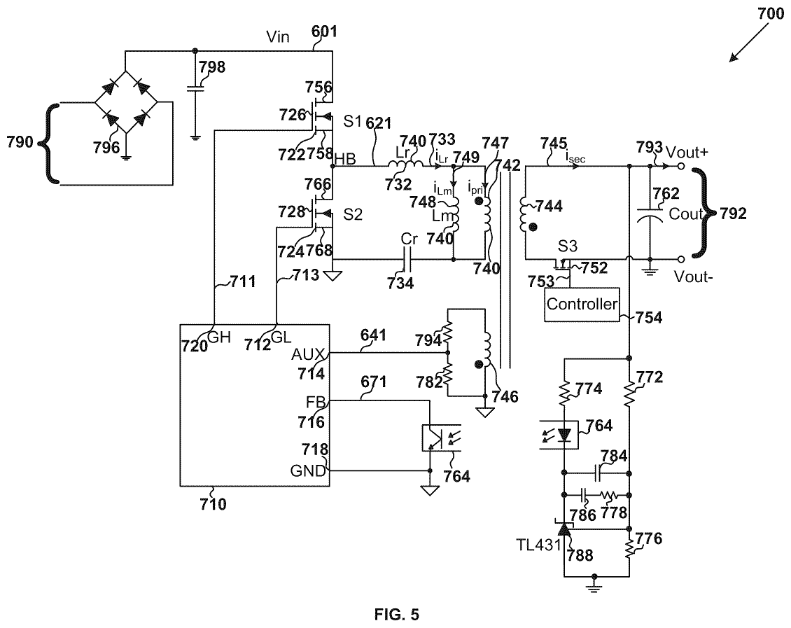

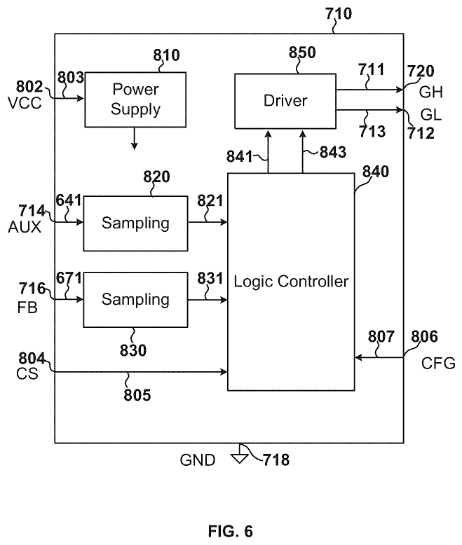

FIG. 5 is a simplified diagram showing an asymmetrical half-bridge flyback switch-mode power converter according to certain embodiments of the present disclosure. This diagram is merely an example, which should not unduly limit the scope of the claims. One of ordinary skill in the art would recognize many variations, alternatives, and modifications. The asymmetrical half-bridge flyback switch-mode power converter 700 includes a bridge rectifier 796, capacitors 798, 734, 762, 784 and 786, switches 722, 724 and 752, a primary inductor 740, a secondary winding 744, an auxiliary winding 746, a synchronous rectification controller 754, resistors 772, 774, 776, 778, 782 and 794, a shunt regulator 788 (e.g., TL431), an optocoupler 764, and a controller chip 710. In some examples, the controller chip 710 is implemented according to at least FIG. 6 and FIG. 11. For example, in an equivalent circuit, the primary inductor 740 includes a primary winding 742, a magnetizing inductor 748 with a magnetizing inductance Lₘ, and a leakage inductor 732 with a leakage inductance Lᵣ. As an example, in an equivalent circuit, the asymmetrical half-bridge flyback switch-mode power converter 700 includes an actual transformer, which includes an ideal transformer and also includes the leakage inductor 732 and the magnetizing inductor 748 on the primary side, wherein the ideal transformer includes the primary winding 742, the secondary winding 744 and the auxiliary winding 746. In certain examples, the controller chip 710 include terminals (e.g., pins) 720, 712, 714, 716, and 718. For example, the switch 722 is a transistor (e.g., a metal-oxide-semiconductor field-effect transistor and/or a gallium nitride transistor). As an example, the switch 724 is a transistor (e.g., a metal-oxide-semiconductor field-effect transistor and/or a gallium nitride transistor). Although the above has been shown using a selected group of components for the asymmetrical half-bridge flyback switch-mode power converter, there can be many alternatives, modifications, and variations. For example, some of the components may be expanded and/or combined. Other components may be inserted to those noted above. Depending upon the embodiment, the arrangement of components may be interchanged with others replaced. Further details of these components are found throughout the present specification.

As shown in FIG. 5, in an equivalent circuit, the actual transformer of the asymmetrical half-bridge flyback switch-mode power converter 700 includes the ideal transformer and also includes the leakage inductor 732 and the magnetizing inductor 748 according to some embodiments. For example, the ideal transformer includes the primary winding 742, the secondary winding 744 and the auxiliary winding 746, but does not include the leakage inductor 732 and does not include the magnetizing inductor 748. As an example, in an equivalent current, if the inductance of the leakage inductor 732 of the actual transformer is equal to zero and the inductance of the magnetizing inductor 748 of the actual transformer is infinite, the actual transformer is the same as the ideal transformer.

Also as shown in FIG. 5, the asymmetrical half-bridge flyback switch-mode power converter 700 receives an AC voltage 790 and generates an output voltage 792 (e.g., Vₒᵤₜ) and an output current 793 (e.g., Iₒᵤₜ) according to certain embodiments. For example, the output current 793 has a positive value if the output current 793 flows out of the asymmetrical half-bridge flyback switch-mode power converter 700.

In certain embodiments, the switch 722 includes terminals 756, 726 and 758, and the switch 724 includes terminals 766, 728 and 768. For example, the terminal 756 of the switch 722 receives an input voltage 601 (e.g., Vᵢₙ), and the terminal 768 of the switch 724 is biased to a ground voltage (e.g., zero volt). As an example, the input voltage 601 (e.g., Vᵢₙ) is a DC voltage. For example, the terminal 758 of the switch 722 and the terminal 766 of the switch 724 are connected to each other. In some examples, a control signal 711 is received by the terminal 726 of the switch 722, and a control signal 713 is received by the terminal 728 of the switch 724. For example, the switch 722 is opened and/or closed by the control signal 711, and the switch 724 is opened and/or closed by the control signal 713. As an example, the terminal 758 of the switch 722 and the terminal 766 of the switch 724 are biased to a voltage 621 (e.g., V_{HB}).

In some embodiments, a current 733 (e.g., I_{Lr}) flows through the leakage inductor 732 with the leakage inductance Lᵣ. For example, the current 733 (e.g., I_{Lr}) has a positive value if the current 733 flows from the leakage inductor 732 to the magnetizing inductor 748 and/or the primary winding 742. As an example, the current 733 (e.g., I_{Lr}) has a negative value if the current 733 flows from the magnetizing inductor 748 and/or the primary winding 742 to the leakage inductor 732.

According to certain embodiments, one terminal of the leakage inductor 732 receives the voltage 621 from the terminal 758 of the switch 722 and the terminal 766 of the switch 724, and another terminal of the leakage inductor 732 is connected to one terminal of the primary winding 742 and one terminal of the magnetizing inductor 748. In some examples, one terminal of the capacitor 734 is connected to the terminal 768 of the switch 724 and is biased to the ground voltage (e.g., zero volt). In certain examples, another terminal of the capacitor 734 is connected to another terminal of the primary winding 742 and another terminal of the magnetizing inductor 748. For example, the magnetizing inductor 748 and the primary winding 742 are connected in parallel. As an example, the primary winding 742 is a part of the ideal transformer that also includes the secondary winding 744 and the auxiliary winding 746.

According to some embodiments, a magnetization current 749 (e.g., I_{Lm}) flows through the magnetizing inductor 748 with the magnetizing inductance Lₘ. For example, the magnetization current 749 (e.g., I_{Lm}) has a positive value if the magnetization current 749 flows from the magnetizing inductor 748 to the capacitor 734. As an example, the magnetization current 749 (e.g., I_{Lm}) has a negative value if the magnetization current 749 flows from the capacitor 734 to the magnetizing inductor 748. In certain examples, a current 747 (e.g., Iₚᵣᵢ) flows through the primary winding 742. For example, the current 747 (e.g., Iₚᵣᵢ) has a positive value if the current 747 flows from the primary winding 742 to the capacitor 734. As an example, the current 747 (e.g., Iₚᵣᵢ) has a negative value if the current 747 flows from the capacitor 734 to the primary winding 742. In some examples, the current 733 (e.g., I_{Lr}) is equal to a sum of the magnetization current 749 (e.g., I_{Lm}) and the current 747 (e.g., Iₚᵣᵢ). For example, if the current 747 (e.g., Iₚᵣᵢ) is equal to zero, the current 733 (e.g., I_{Lr}) is equal to the magnetization current 749 (e.g., I_{Lm}). As an example, if the current 747 (e.g., Iₚᵣᵢ) is not equal to zero, the current 733 (e.g., I_{Lr}) is not equal to the magnetization current 749 (e.g., I_{Lm}). In certain examples, a secondary current 745 (e.g., I_{sec}) flows through the secondary winding 744. For example, the secondary current 745 (e.g., I_{sec}) has a positive value if the secondary current 745 flows from the switch 752 to the secondary winding 744. As an example, the secondary current 745 (e.g., I_{sec}) has a negative value if the secondary current 745 flows from the secondary winding 744 to the switch 752.

In certain embodiments, the auxiliary winding 746 is connected to the resistors 794 and 782, which generate a signal 641 and outputs the signal 641 to the controller chip 710. For example, the secondary winding 744 is connected to the switch 752. As an example, the synchronous rectification controller 754 generates a control signal 753, which is used to open and/or close the switch 752. In some examples, the capacitor 762 is used to reduce and/or eliminate the ripple in the output voltage 792. In certain examples, the output voltage 792 is used to generate a feedback signal 771 that is outputted to the controller chip 710.

In some embodiments, the controller chip 710 includes the terminals (e.g., pins) 720, 712, 714, 716, and 718. For example, the terminal 720 (e.g., GH) outputs the control signal 711, and the terminal 712 (e.g., GL) outputs the control signal 713. As an example, the terminal 714 (e.g., AUX) receives the signal 641, and the terminal 716 (e.g., FB) receives a signal 671. For example, the terminal 718 (e.g., GND) is biased to the ground voltage (e.g., zero volt).

According to certain embodiments, the asymmetrical half-bridge flyback switch-mode power converter 700 operates in different modes. For example, the asymmetrical half-bridge flyback switch-mode power converter 700 operates in a critical conduction mode (CRM). As an example, the asymmetrical half-bridge flyback switch-mode power converter 700 operates in a discontinuous conduction mode (DCM). For example, the asymmetrical half-bridge flyback switch-mode power converter 700 operates in a burst mode.

According to some embodiments, when the asymmetrical half-bridge flyback switch-mode power converter 700 operates in the discontinuous conduction mode (DCM), after N cycles (e.g., N consecutive cycles) of critical conduction mode (CRM), both the switch 722 and the switch 724 remain open for a time duration after the demagnetization process has ended, wherein N is a positive integer. For example, after the time duration has ended, the control signal 713 changes from the logic low level to the logic high and the switch 724 becomes closed, in order to reduce the magnetization current 749 to a valley value in order to achieve zero-voltage switching for the switch 722. As an example, after the time duration has ended, the asymmetrical half-bridge flyback switch-mode power converter 700 undergoes another N cycles (e.g., N consecutive cycles) of critical conduction mode (CRM). In certain examples, for the asymmetrical half-bridge flyback switch-mode power converter 700, each period of the discontinuous conduction mode (DCM) includes N cycles (e.g., N consecutive cycles) of critical conduction mode (CRM) and an additional time duration that follows the N cycles (e.g., N consecutive cycles) of critical conduction mode (CRM), wherein N is a positive integer and the additional time duration is larger than zero.

As mentioned above and further emphasized here, FIG. 5 is merely an example, which should not unduly limit the scope of the claims. One of ordinary skill in the art would recognize many variations, alternatives, and modifications. For example, the bridge rectifier 796 and the capacitor 798 are replaced by another circuit that is also configured to convert the AC voltage 790 to a DC voltage (e.g., the input voltage 601). As an example, a boost PFC circuit is used to convert the AC voltage 790 to a DC voltage (e.g., the input voltage 601).

FIG. 6 is a simplified diagram showing the controller chip 710 of the asymmetrical half-bridge flyback switch-mode power converter 700 as shown in FIG. 5 according to some embodiments of the present disclosure. This diagram is merely an example, which should not unduly limit the scope of the claims. One of ordinary skill in the art would recognize many variations, alternatives, and modifications. The controller chip 710 includes the terminal 720 (e.g., a pin), the terminal 712 (e.g., a pin), the terminal 714 (e.g., a pin), the terminal 716 (e.g., a pin), and the terminal 718 (e.g., a pin), and the controller chip 710 also includes a terminal 802 (e.g., a pin), a terminal 804 (e.g., a pin), and a terminal 806 (e.g., a pin). Additionally, the controller chip 710 includes a power supply unit 810, a sampling unit 820, a sampling unit 830, a logic controller 840 (e.g., a signal generator), and a driver 850. For example, the logic controller 840 of the controller chip 710 is implemented according to at least FIG. 11. Although the above has been shown using a selected group of components for the controller chip, there can be many alternatives, modifications, and variations. For example, some of the components may be expanded and/or combined. Other components may be inserted to those noted above. Depending upon the embodiment, the arrangement of components may be interchanged with others replaced. Further details of these components are found throughout the present specification.

For example, the power supply unit 810 is implemented using one or more software components, one or more hardware components, and/or one or more combinations of software and hardware components, and/or the power supply unit 810 is implemented in one or more circuits, such as one or more analog circuits and/or one or more digital circuits. As an example, the sampling unit 820 is implemented using one or more software components, one or more hardware components, and/or one or more combinations of software and hardware components, and/or the sampling unit 820 is implemented in one or more circuits, such as one or more analog circuits and/or one or more digital circuits. For example, the sampling unit 830 is implemented using one or more software components, one or more hardware components, and/or one or more combinations of software and hardware components, and/or the sampling unit 830 is implemented in one or more circuits, such as one or more analog circuits and/or one or more digital circuits. As an example, the logic controller 840 is implemented using one or more software components, one or more hardware components, and/or one or more combinations of software and hardware components, and/or the logic controller 840 is implemented in one or more circuits, such as one or more analog circuits and/or one or more digital circuits. For example, the driver 850 is implemented using one or more software components, one or more hardware components, and/or one or more combinations of software and hardware components, and/or the driver 850 is implemented in one or more circuits, such as one or more analog circuits and/or one or more digital circuits.

In certain embodiments, the power supply unit 810 is connected to the terminal 802 (e.g., VCC). For example, the power supply unit 810 receives a chip supply voltage 803 (e.g., Vₑₑ) from the terminal 802. As an example, the power supply unit 810 provides power to one or more other components of the controller chip 710. In some embodiments, the sampling unit 820 is connected to the terminal 714 (e.g., AUX). For example, the sampling unit 820 receives the signal 641 from the terminal 714. As an example, the sampling unit 820 samples the signal 641 and generates a sampled signal 821.

According to certain embodiments, the sampling unit 830 is connected to the terminal 716 (e.g., FB). For example, the sampling unit 830 receives the signal 671 from the terminal 716. As an example, the sampling unit 830 samples the signal 671 and generates a sampled signal 831. According to some embodiments, the logic controller 840 is connected to the terminal 804 (e.g., CS) and the terminal 806 (e.g., CFG). For example, the logic controller 840 receives a signal 805 from the terminal 804, wherein the signal 805 represents the current 733 (e.g., I_{Lr}). As an example, the logic controller 840 receives a signal 807 from the terminal 806, wherein the signal 807 is used to adjust one or more operation parameters of the controller chip 710.

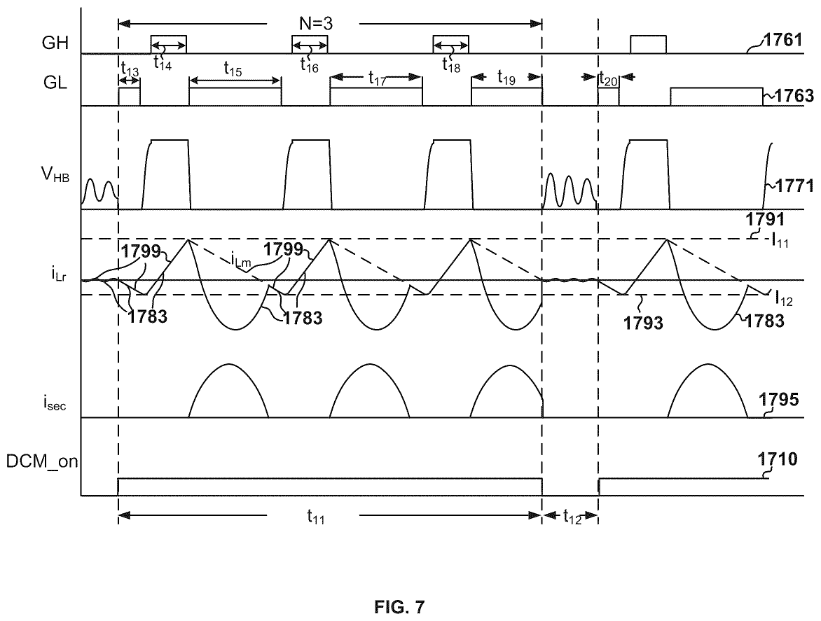

In certain embodiments, the logic controller 840 receives the signals 821, 831, 805 and 807, and generates signals (e.g., logic signals) 841 and 843. For example, the logic controller 840 generates a signal 2001 (e.g., a phase control signal) as shown by the waveform 1710 in FIG. 7. As an example, the logic controller 840 uses at least the signal 821, the signal 831, the signal 841, the signal 843 and/or the signal 2001 to generate the signal 2001 (e.g., a phase control signal) as shown in FIG. 11.

In some embodiments, the driver 850 receives the signals 841 and 843 and generates the control signal 711 and the control signal 713 based at least in part on the signals 841 and 843. For example, if the signal 841 (e.g., a logic signal) is at the logic high level, the control signal 711 is at the logic high level, and if the signal 841 (e.g., a logic signal) is at the logic low level, the control signal 711 is at the logic low level. As an example, if the signal 843 (e.g., a logic signal) is at the logic high level, the control signal 713 is at the logic high level, and if the signal 843 (e.g., a logic signal) is at the logic low level, the control signal 713 is at the logic low level. In some examples, the driver 850 is connected to the terminal 720 (e.g., GH) and the terminal 712 (e.g., GL). For example, the driver 850 outputs the control signal 711 at the terminal 720. As an example, the driver 850 outputs the control signal 713 at the terminal 712.

FIG. 7 shows simplified timing diagrams for the asymmetrical half-bridge flyback switch-mode power converter 700 as shown in FIG. 5 and FIG. 6 in a discontinuous conduction mode (DCM) with N equal to 3 according to some embodiments of the present disclosure. These diagrams are merely examples, which should not unduly limit the scope of the claims. One of ordinary skill in the art would recognize many variations, alternatives, and modifications. The waveform 1761 represents the control signal 711 as a function of time, the waveform 1763 represents the control signal 713 as a function of time, the waveform 1771 represents the voltage 621 as a function of time, the waveform 1783 represents the current 733 as a function of time, the waveform 1799 represents the magnetization current 749 as a function of time, the waveform 1795 represents the secondary current 745 as a function of time, and the waveform 1710 represents the signal 2001 as a function of time. In some examples, the waveform 1783 is shown as a solid line, and the waveform 1799 is shown as a dashed line. For example, when the current 733 (e.g., I_{Lr}) is not equal to the magnetization current 749 (e.g., I_{Lm}), both the solid line and the dashed line are visible in FIG. 7. As an example, when the current 733 (e.g., I_{Lr}) is equal to the magnetization current 749 (e.g., I_{Lm}), the solid line is visible but the dashed line is not visible in FIG. 7. In certain examples, the magnetization current 749 changes between a current value 1791 (e.g., a peak value) and a current value 1793 (e.g., a valley value) as shown by the waveform 1799.

According to certain embodiments, one cycle (e.g., one period) of the discontinuous conduction mode (DCM) includes a switching phase (e.g., a time duration t₁₁) and an idle phase (e.g., a time duration t₁₂). For example, an idle phase ends and a switching phase starts at a same time, and the switching phase ends and another idle phase starts at another same time. In some examples, the asymmetrical half-bridge flyback switch-mode power converter 700 undergoes three cycles (e.g., three consecutive cycles) of critical conduction mode (CRM) during the switching phase (e.g., the time duration t₁₁), and after the demagnetization process has ended, both the switch 722 and the switch 724 remain open during the idle phase (e.g., the time duration t₁₂). For example, during the switching phase (e.g., the time duration t₁₁), the signal 2001 is at a logic high level as shown by the waveform 1710. As an example, during the idle phase (e.g., the time duration t₁₂), the signal 2001 is at a logic low level as shown by the waveform 1710.

In some embodiments, during the switching phase (e.g., the time duration t₁₁), as shown by the waveforms 1763 and 1761, the control signal 713 remains at the logic high level and the control signal 711 remains at the logic low level during time durations t₁₃, t₁₅, t₁₇ and t₁₉. In certain examples, at the beginning of the time duration t₁₃, at the beginning of the time duration t₁₅, at the beginning of the time duration t₁₇, and at the beginning of the time duration t₁₉, the control signal 713 changes from the logic low level to the logic high level, and at the end of the time duration t₁₃, at the end of the time duration t₁₅, at the end of the time duration t₁₇, and at the end of the time duration t₁₉, the control signal 713 changes from the logic high level to the logic low level, as shown by the waveform 1763. For example, during the time duration t₁₃, the magnetization current 749 decreases from zero to the current value 1793 (e.g., the valley value) as shown by the waveform 1799. As an example, during the time duration t₁₅, the magnetization current 749 decreases from the current value 1791 (e.g., the peak value) to the current value 1793 (e.g., the valley value) as shown by the waveform 1799. For example, during the time duration t₁₇, the magnetization current 749 decreases from the current value 1791 (e.g., the peak value) to the current value 1793 (e.g., the valley value) as shown by the waveform 1799. As an example, during the time duration t₁₉, the magnetization current 749 decreases from the current value 1791 (e.g., the peak value) to zero. In some examples, the time duration t₁₉ is equal to the demagnetization period of the asymmetrical half-bridge flyback switch-mode power converter 700. In some examples, the time duration t₁₅ and the time duration t₁₇ are equal. For example, the sum of the time duration t₁₃ and the time duration t₁₉ is equal to the time duration t₁₅. As an example, the sum of the time duration t₁₃ and the time duration t₁₉ is equal to the time duration t₁₇.

In certain embodiments, during the switching phase (e.g., the time duration t₁₁), as shown by the waveforms 1761 and 1763, the control signal 711 remains at the logic high level and the control signal 713 remains at the logic low level during time durations t₁₄, t₁₆ and tis. In some examples, at the beginning of the time duration t₁₄, at the beginning of the time duration t₁₆, and at the beginning of the time duration t₁₅, the control signal 711 changes from the logic low level to the logic high level, and at the end of the time duration t₁₄, at the end of the time duration t₁₆, and at the end of the time duration t₁₅, the control signal 711 changes from the logic high level to the logic low level, as shown by the waveform 1761. In certain examples, the time duration t₁₄ is between the time duration t₁₃ and the time duration tis, the time duration t₁₆ is between the time duration t₁₅ and the time duration t₁₇, and the time duration t₁₅ is between the time duration t₁₇ and the time duration t₁₉. In some examples, the time duration t₁₄ and the time duration t₁₆ are equal, and the time duration t₁₆ and the time duration t₁₈ are equal.

According to some embodiments, the asymmetrical half-bridge flyback switch-mode power converter 700 undergoes three cycles (e.g., three consecutive cycles) of critical conduction mode (CRM) during the switching phase (e.g., the time duration t₁₁). For example, one cycle of these three cycles (e.g., one cycle of these three consecutive cycles) of critical conduction mode (CRM) during the switching phase (e.g., the time duration t₁₁) includes the time duration t₁₄ and the time duration t₁₅. As an example, another cycle of these three cycles (e.g., another cycle of these three consecutive cycles) of critical conduction mode (CRM) during the switching phase (e.g., the time duration t₁₁) includes the time duration t₁₆ and the time duration t₁₇. For example, yet another cycle of these three cycles (e.g., yet another cycle of these three consecutive cycles) of critical conduction mode (CRM) during the switching phase (e.g., the time duration t₁₁) includes the time duration t₁₈, the time duration t₁₉, and the time duration t₁₃.

According to certain embodiments, as shown in FIG. 7, when the asymmetrical half-bridge flyback switch-mode power converter 700 operates in the discontinuous conduction mode (DCM), the output current 793 is determined as follows:

$$\\ \begin{matrix}{I}_{out} = \frac{{N}_{ps}}{2} ( {I}_{11} + {I}_{12} ) \times \frac{{t}_{11}}{{t}_{11} + {t}_{12}} & ( Equation 7 )\end{matrix}$$

where Iₒᵤₜ represents the output current 793. Additionally, Nₚₛ represents the turns ratio that is equal to the ratio of the number of turns in the primary winding 742 to the number of turns in the secondary winding 744. Moreover, In represents the current value 1791, which is the peak value of the magnetization current 749. Also, I₁₂ represents the current value 1793, which is the valley value of the magnetization current 749. Additionally, t₁₁ represents a time duration for the switching phase, and during the switching phase, the asymmetrical half-bridge flyback switch-mode power converter 700 undergoes N cycles (e.g., N consecutive cycles) of critical conduction mode (CRM), wherein N is a positive integer. For example, N is equal to one. As an example, N is equal to two. For example, N is equal to three. As an example, N is larger than three. Moreover, t₁₂ represents a time duration for the idle phase, and during the idle phase, both the switch 722 and the switch 724 remain open.

As discussed above and further emphasized here, FIG. 7 is merely an example, which should not unduly limit the scope of the claims. One of ordinary skill in the art would recognize many variations, alternatives, and modifications. According to certain embodiments, one cycle (e.g., one period) of the discontinuous conduction mode (DCM) includes a switching phase (e.g., the time duration t₁₁) and an idle phase (e.g., the time duration t₁₂). In some examples, the asymmetrical half-bridge flyback switch-mode power converter 700 undergoes N cycles (e.g., N consecutive cycles) of critical conduction mode (CRM) during the switching phase (e.g., the time duration t₁₁), and after the demagnetization process has ended, both the switch 722 and the switch 724 remain open during the idle phase (e.g., the time duration t₁₂), wherein N is a positive integer. For example, N is equal to one. As an example, N is equal to two.

According to some embodiments, during the switching phase (e.g., the time duration t₁₁), the asymmetrical half-bridge flyback switch-mode power converter 700 undergoes N cycles (e.g., N consecutive cycles) of critical conduction mode (CRM), wherein N is a positive integer. In certain example, the N cycles (e.g., N consecutive cycles) of critical conduction mode (CRM) include N+1 time durations when the control signal 713 remains at the logic high level and the control signal 711 remains at the logic low level and also include N time durations when the control signal 711 remains at the logic high level and the control signal 713 remains at the logic low level. For example, one cycle of the N cycles (e.g., N consecutive cycles) of critical conduction mode (CRM) includes the last time duration of the N time durations, the last time duration of the N+1 time durations, and the first time duration of the N+1 time durations. As an example, if N is equal to or larger than 2, each cycle of the other N cycles (e.g., N consecutive cycles) of critical conduction mode (CRM) includes one time duration of the N time durations and one time duration of the N+1 time durations, wherein the one time duration of the N time durations is not the last time duration of the N time durations, and the one time duration of the N+1 time durations is not the first time duration of the N+1 time durations and is also not the last time duration of the N+1 time durations. In some examples, if N is equal to or larger than 2, each cycle of the N cycles (e.g., N consecutive cycles) of critical conduction mode (CRM) does not share any of the N+1 time durations with any other cycle of the N cycles (e.g., N consecutive cycles) of critical conduction mode (CRM), and each cycle of the N cycles (e.g., N consecutive cycles) of critical conduction mode (CRM) does not share any of the N time durations with any other cycle of the N cycles (e.g., N consecutive cycles) of critical conduction mode (CRM).

In certain embodiments, during the switching phase (e.g., the time duration t₁₁), the control signal 713 remains at the logic high level and the control signal 711 remains at the logic low level during the N+1 time durations (e.g., during 4 time durations as parts of the time duration t₁₁). For example, at the beginning of each time duration of the N+1 time durations (e.g., at the beginning of each time duration of the 4 time durations as parts of the time duration t₁₁), the control signal 713 changes from the logic low level to the logic high level, and at the end of each time duration of the N+1 time durations (e.g., at the end of each time duration of the 4 time durations as parts of the time duration t₁₁), the control signal 713 changes from the logic high level to the logic low level. As an example, during the first time duration of the N+1 time durations (e.g., during the time duration t₁₃ of the 4 time durations as parts of the time duration t₁₁), the magnetization current 749 decreases from zero to a valley value (e.g., the current value 1793), and during the last time duration of the N+1 time durations (e.g., during the time duration t₁₉ of the 4 time durations as parts of the time duration t₁₁), the magnetization current 749 decreases from a peak value (e.g., the current value 1791) to zero. For example, the last time duration of the N+1 time durations (e.g., during the time duration t₁₉ of the 4 time durations as parts of the time duration t₁₁) is equal to the demagnetization period of the asymmetrical half-bridge flyback switch-mode power converter 700. In some examples, during the switching phase (e.g., the time duration t₁₁), after the first time duration (e.g., the time duration t₁₃) but before the last time duration (e.g., the time duration t₁₉), there are N−1 time durations (e.g., 2 time durations that are time duration t₁₅ and time duration t₁₇) when the control signal 713 remains at the logic high level and the control signal 711 remains at the logic low level, wherein N−1 is equal to zero, equal to one, or equal to or larger than two. For example, if N is equal to one, during the switching phase, after the first time duration but before the last time duration, there is no time duration when the control signal 713 remains at the logic high level. As an example, if N is equal to two, during the switching phase, after the first time duration but before the last time duration, there is only one time duration when the control signal 713 remains at the logic high level, wherein during this one time duration the control signal 711 remains at the logic low level and the magnetization current 749 decreases from the peak value to the valley value. For example, if N is equal to three, during the switching phase (e.g., the time duration t₁₁), after the first time duration (e.g., the time duration t₁₃) but before the last time duration (e.g., the time duration t₁₉), there are 3-1 time durations (e.g., time duration t₁₅ and time duration t₁₇) when the control signal 713 remains at the logic high level, wherein during each time duration of these two time durations (e.g., during each time duration of time duration t₁₅ and time duration t₁₇), the control signal 711 remains at the logic low level and the magnetization current 749 decreases from the peak value (e.g., the current value 1791) to the valley value (e.g., the current value 1793). As an example, if N is larger than three, during the switching phase, after the first time duration but before the last time duration, there are N−1 time durations when the control signal 713 remains at the logic high level, wherein during each time duration of these N−1 time durations, the control signal 711 remains at the logic low level and the magnetization current 749 decreases from the peak value to the valley value. In certain examples, during the switching phase (e.g., the time duration t₁₁), the sum of the length of the first time duration and the length of the last time duration is equal to the length of each time duration of the N−1 time durations when the control signal 713 remains at the logic high level and the control signal 711 remains at the logic low level, wherein N is equal to or larger than two. For example, the sum of the time duration t₁₃ and the time duration t₁₉ is equal to the time duration t₁₅. As an example, the sum of the time duration t₁₃ and the time duration t₁₉ is equal to the time duration t₁₇. In some examples, during the switching phase (e.g., the time duration t₁₁), the N−1 time durations when the control signal 713 remains at the logic high level and the control signal 711 remains at the logic low level are equal in length, wherein N is equal to or larger than three. For example, the time duration t₁₅ and the time duration t₁₇ are equal in length.

In some embodiments, during the switching phase (e.g., the time duration t₁₁), the control signal 711 remains at the logic high level and the control signal 713 remains at the logic low level during the N time durations (e.g., during 3 time durations as parts of the time duration t₁₁). For example, at the beginning of each time duration of the N time durations (e.g., at the beginning of each time duration of the 3 time durations as parts of the time duration t₁₁), the control signal 711 changes from the logic low level to the logic high level, and at the end of each time duration of the N time durations (e.g., at the end of each time duration of the 3 time durations as parts of the time duration t₁₁), the control signal 711 changes from the logic high level to the logic low level. As an example, during the switching phase (e.g., the time duration t₁₁), the control signal 711 changes from the logic low level to the logic high level in a total of N times (e.g., in a total of 3 times), and the control signal 711 changes from the logic high level to the logic low level in a total of N times (e.g., in a total of 3 times). In some examples, each time duration of the N time durations when the control signal 711 remains at the logic high level and the control signal 713 remains at the logic low level is between two time durations of the N+1 time durations when the control signal 713 remains at the logic high level and the control signal 711 remains at the logic low level. For example, the time duration t₁₄ is between the time duration t₁₃ and the time duration t₁₅, the time duration t₁₆ is between the time duration t₁₅ and the time duration t₁₇, and the time duration t₁₈ is between the time duration t₁₇ and the time duration t₁₉. In certain examples, between two time durations of the N+1 time durations when the control signal 713 remains at the logic high level and the control signal 711 remains at the logic low level, there is only one time duration of the N time durations when the control signal 711 remains at the logic high level and the control signal 713 remains at the logic low level. For example, between the time duration t₁₃ and the time duration t₁₅, there is only one time duration (e.g., time duration t₁₄) when the control signal 711 remains at the logic high level and the control signal 713 remains at the logic low level. As an example, between the time duration t₁₅ and the time duration t₁₇, there is only one time duration (e.g., time duration t₁₆) when the control signal 711 remains at the logic high level and the control signal 713 remains at the logic low level. For example, between the time duration t₁₇ and the time duration t₁₉, there is only one time duration (e.g., time duration t₁₈) when the control signal 711 remains at the logic high level and the control signal 713 remains at the logic low level.

According to certain embodiments, one cycle (e.g., one period) of the discontinuous conduction mode (DCM) includes a switching phase (e.g., the time duration t₁₁) and an idle phase (e.g., the time duration t₁₂). For example, the sum of the length of the switching phase and the length of the idle phase is equal to an envelope period of the discontinuous conduction mode (DCM) as follows:

$$\\ \begin{matrix}{T}_{DCM} = {t}_{11} + {t}_{12} & ( Equation 8 A )\end{matrix}$$

wherein T_{DCM} represents the envelope period of the discontinuous conduction mode (DCM). Additionally, t₁₁ represents a time duration for the switching phase, and t₁₂ represents a time duration for the idle phase. As an example, an envelope frequency of the discontinuous conduction mode (DCM) is determined as follows:

$$\\ \begin{matrix}{f}_{DCM} = \frac{1}{{T}_{DCM}} = \frac{1}{{t}_{11} + {t}_{12}} & ( Equation 8 B )\end{matrix}$$

wherein f_{DCM} represents the envelope frequency of the discontinuous conduction mode (DCM). Additionally, T_{DCM} represents the envelope period of the discontinuous conduction mode (DCM). Moreover, t₁₁ represents a time duration for the switching phase, and t₁₂ represents a time duration for the idle phase.

In some examples, the asymmetrical half-bridge flyback switch-mode power converter 700 undergoes N cycles (e.g., N consecutive cycles) of critical conduction mode (CRM) during the switching phase (e.g., the time duration t₁₁), and after the demagnetization process has ended, both the switch 722 and the switch 724 remain open during the idle phase (e.g., the time duration t₁₂), wherein N is a positive integer. As an example, an average switching frequency of the discontinuous conduction mode (DCM) is determined as follows:

$$\\ \begin{matrix}{f}_{SW \_ AVG} = {f}_{DCM} \times N & ( Equation 9 )\end{matrix}$$

where f_{SW_AVG} represents the average switching frequency of the discontinuous conduction mode (DCM). Additionally, f_{DCM} represents the envelope frequency of the discontinuous conduction mode (DCM). Moreover, N represents the number of cycles (e.g., the number of consecutive cycles) of critical conduction mode (CRM) during the time duration t₁₁ (e.g., the switching phase).

In certain examples, the asymmetrical half-bridge flyback switch-mode power converter 700 operates in different modes. For example, the asymmetrical half-bridge flyback switch-mode power converter 700 operates in a critical conduction mode (CRM). As an example, the asymmetrical half-bridge flyback switch-mode power converter 700 operates in a discontinuous conduction mode (DCM) (e.g., as shown in FIG. 7). For example, the asymmetrical half-bridge flyback switch-mode power converter 700 operates in a burst mode.

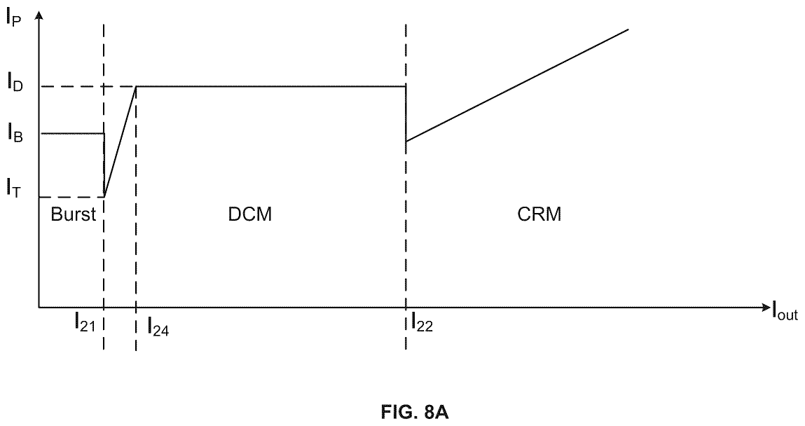

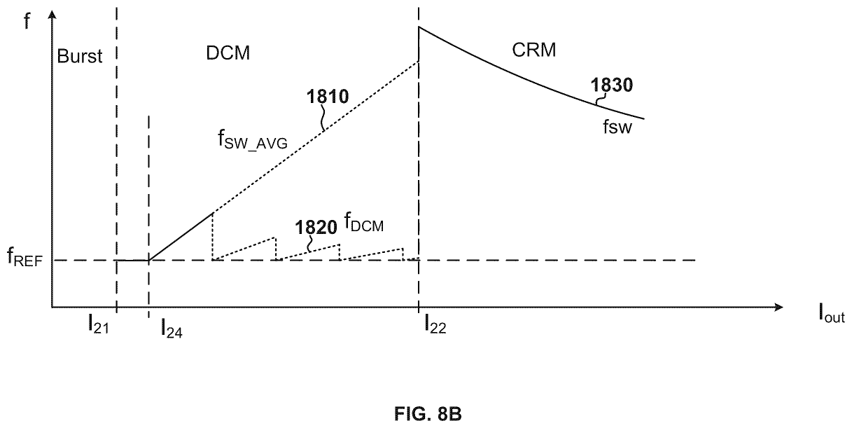

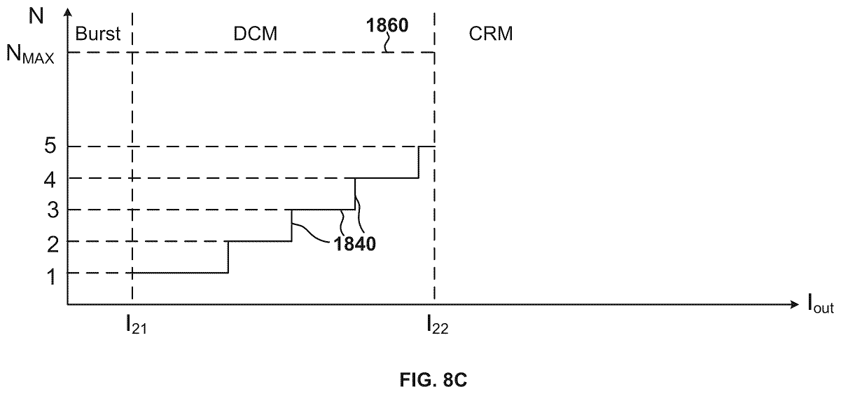

FIG. 8A is a simplified diagram showing a peak value of the magnetization current 749 as a function of the output current 793 for the asymmetrical half-bridge flyback switch-mode power converter 700 as shown in FIG. 5 and FIG. 6 according to certain embodiments of the present disclosure, FIG. 8B is a simplified diagram showing an envelope frequency of the discontinuous conduction mode (DCM) as a function of the output current 793, showing an average switching frequency of the discontinuous conduction mode (DCM) as a function of the output current 793, and showing a switching frequency of the critical conduction mode (CRM) as a function of the output current 793 for the asymmetrical half-bridge flyback switch-mode power converter 700 as shown in FIG. 5 and FIG. 6 according to some embodiments of the present disclosure, and FIG. 8C is a simplified diagram showing the number of cycles of critical conduction mode (CRM) during a switching phase of the discontinuous conduction mode (DCM) as a function of the output current 793 for the asymmetrical half-bridge flyback switch-mode power converter 700 as shown in FIG. 5 and FIG. 6 according to certain embodiments of the present disclosure. For example, a threshold current value I₂₁ as shown in FIG. 8A, FIG. 8B, and FIG. 8C has the same value. As an example, a threshold current value I₂₂ as shown in FIG. 8A, FIG. 8B, and FIG. 8C has the same value. For example, a threshold current value I₂₄ as shown in FIG. 8A and FIG. 8B has the same value. These diagrams are merely examples, which should not unduly limit the scope of the claims. One of ordinary skill in the art would recognize many variations, alternatives, and modifications.

As show in FIG. 8A, the asymmetrical half-bridge flyback switch-mode power converter 700 changes its mode of operation from a burst mode to a discontinuous conduction mode (DCM) and from the discontinuous conduction mode (DCM) to the critical conduction mode (CRM) according to some embodiments. For example, if the output current 793 (e.g., Iₒᵤₜ) is smaller than the threshold current value I₂₁, the asymmetrical half-bridge flyback switch-mode power converter 700 operates in the burst mode. As an example, if the output current 793 (e.g., Iₒᵤₜ) is larger than the threshold current value I₂₁ but is smaller than the threshold current value I₂₂, the asymmetrical half-bridge flyback switch-mode power converter 700 operates in the discontinuous conduction mode (DCM). For example, if the output current 793 (e.g., Iₒᵤₜ) is larger than the threshold current value I₂₂, the asymmetrical half-bridge flyback switch-mode power converter 700 operates in the critical conduction mode (CRM). In certain examples, Iₚ represents the peak value of the magnetization current 749. In some examples, the peak value of the magnetization current 749 (e.g., Iₚ) is I₁₁ as shown in FIG. 7.

As shown in FIG. 8B, the waveform 1810 represents the average switching frequency (e.g., f_{SW_AVG}) of the discontinuous conduction mode (DCM) as a function of the output current 793 (e.g., Iₒᵤₜ), the waveform 1820 represents the envelope frequency (e.g., f_{DCM}) of the discontinuous conduction mode (DCM) as a function of the output current 793 (e.g., Iₒᵤₜ), and the waveform 1830 represents the switching frequency (e.g., f_{SW}) of the critical conduction mode (CRM) as a function of the output current 793 (e.g., Iₒᵤₜ) according to certain embodiments. For example, f_{REF} represents a predetermined reference frequency value. As an example, the predetermined frequency value (e.g., f_{REF}) is larger than 20 KHz.

As shown in FIG. 8C, if the output current 793 (e.g., Iₒᵤₜ) becomes larger than the threshold current value I₂₂, the asymmetrical half-bridge flyback switch-mode power converter 700 changes the mode operation from the discontinuous conduction mode (DCM) to the critical conduction mode (CRM) according to some embodiments. For example, the waveform 1840 represents the number of cycles (e.g., N) of critical conduction mode (CRM) during a switching phase of the discontinuous conduction mode (DCM) as a function of the output current 793 (e.g., Iₒᵤₜ) according to some embodiments. As an example, N represents the number of cycles (e.g., the number of consecutive cycles) of critical conduction mode (CRM) during a switching phase of each cycle of the discontinuous conduction mode (DCM), wherein N is a positive integer. In certain example, the N cycles (e.g., N consecutive cycles) of critical conduction mode (CRM) include N+1 time durations when the control signal 713 remains at the logic high level and the control signal 711 remains at the logic low level and also include N time durations when the control signal 711 remains at the logic high level and the control signal 713 remains at the logic low level. For example, one cycle of the N cycles (e.g., N consecutive cycles) of critical conduction mode (CRM) includes the last time duration of the N time durations, the last time duration of the N+1 time durations, and the first time duration of the N+1 time durations. As an example, if N is equal to or larger than 2, each cycle of the other N cycles (e.g., N consecutive cycles) of critical conduction mode (CRM) includes one time duration of the N time durations and one time duration of the N+1 time durations, wherein the one time duration of the N time durations is not the last time duration of the N time durations, and the one time duration of the N+1 time durations is not the first time duration of the N+1 time durations and is also not the last time duration of the N+1 time durations. In some examples, if N is equal to or larger than 2, each cycle of the N cycles (e.g., N consecutive cycles) of critical conduction mode (CRM) does not share any of the N+1 time durations with any other cycle of the N cycles (e.g., N consecutive cycles) of critical conduction mode (CRM), and each cycle of the N cycles (e.g., N consecutive cycles) of critical conduction mode (CRM) does not share any of the N time durations with any other cycle of the N cycles (e.g., N consecutive cycles) of critical conduction mode (CRM).

In certain embodiments, during the switching phase, the control signal 713 remains at the logic high level and the control signal 711 remains at the logic low level during the N+1 time durations. For example, at the beginning of each time duration of the N+1 time durations, the control signal 713 changes from the logic low level to the logic high level, and at the end of each time duration of the N+1 time durations, the control signal 713 changes from the logic high level to the logic low level. As an example, during the first time duration of the N+1 time durations, the magnetization current 749 decreases from zero to a valley value, and during the last time duration of the N+1 time durations, the magnetization current 749 decreases from a peak value to zero. For example, the last time duration of the N+1 time durations is equal to the demagnetization period of the asymmetrical half-bridge flyback switch-mode power converter 700. In some examples, during the switching phase, after the first time duration but before the last time duration, there are N−1 time durations when the control signal 713 remains at the logic high level and the control signal 711 remains at the logic low level, wherein N−1 is equal to zero, equal to one, or equal to or larger than two. In certain examples, during the switching phase, the sum of the length of the first time duration and the length of the last time duration is equal to the length of each time duration of the N−1 time durations when the control signal 713 remains at the logic high level and the control signal 711 remains at the logic low level, wherein N is equal to or larger than two. In some examples, during the switching phase, the N−1 time durations when the control signal 713 remains at the logic high level and the control signal 711 remains at the logic low level are equal in length, wherein N is equal to or larger than three.

In some embodiments, during the switching phase, the control signal 711 remains at the logic high level and the control signal 713 remains at the logic low level during the N time durations. For example, at the beginning of each time duration of the N time durations, the control signal 711 changes from the logic low level to the logic high level, and at the end of each time duration of the N time durations, the control signal 711 changes from the logic high level to the logic low level. As an example, during the switching phase, the control signal 711 changes from the logic low level to the logic high level in a total of N times, and the control signal 711 changes from the logic high level to the logic low level in a total of N times. In some examples, each time duration of the N time durations when the control signal 711 remains at the logic high level and the control signal 713 remains at the logic low level is between two time durations of the N+1 time durations when the control signal 713 remains at the logic high level and the control signal 711 remains at the logic low level. In certain examples, between two time durations of the N+1 time durations when the control signal 713 remains at the logic high level and the control signal 711 remains at the logic low level, there is only one time duration of the N time durations when the control signal 711 remains at the logic high level and the control signal 713 remains at the logic low level.

Also as shown in FIG. 8C, when the output current 793 (e.g., Iₒᵤₜ) increases from the threshold current value I₂₁ to the threshold current value I₂₂, N increases from 1 to 5 according to certain embodiments. For example, before N reaches its maximum value 1860 (e.g., N_{MAX}), the asymmetrical half-bridge flyback switch-mode power converter 700 changes the mode operation from the discontinuous conduction mode (DCM) to the critical conduction mode (CRM) when the output current 793 (e.g., Iₒᵤₜ) becomes larger than the threshold current value I₂₂.

According to some embodiments, when the asymmetrical half-bridge flyback switch-mode power converter 700 operates in the critical conduction mode (CRM), if the output current 793 (e.g., Iₒᵤₜ) decreases, the peak value of the magnetization current 749 decreases as shown in FIG. 8A and the switching frequency (e.g., f_{SW}) increases as shown by the waveform 1830. For example, if the output current 793 (e.g., Iₒᵤₜ) becomes smaller than the threshold current value I₂₂, the asymmetrical half-bridge flyback switch-mode power converter 700 changes its mode of operation from the critical conduction mode (CRM) to the discontinuous conduction mode (DCM) in order to prevent the peak value of the magnetization current 749 from decreasing further.

According to certain embodiments, when the asymmetrical half-bridge flyback switch-mode power converter 700 changes its mode of operation from the critical conduction mode (CRM) to the discontinuous conduction mode (DCM), the peak value of the magnetization current 749 rises to a current value ID. For example, when the asymmetrical half-bridge flyback switch-mode power converter 700 operates in the discontinuous conduction mode (DCM), the peak value of the magnetization current 749 remains equal to the current value ID if the output current 793 (e.g., Iₒᵤₜ) is smaller than the threshold current value I₂₂ but is larger than the threshold current value I₂₄ as shown in FIG. 8A. As an example, when the asymmetrical half-bridge flyback switch-mode power converter 700 operates in the discontinuous conduction mode (DCM), the average switching frequency (e.g., f_{SW_AVG}) decreases with the decreasing output current 793 (e.g., Iₒᵤₜ) if the output current 793 (e.g., Iₒᵤₜ) is smaller than the threshold current value I₂₂ but is larger than the threshold current value I₂₄ as shown by the waveform 1810. For example, when the asymmetrical half-bridge flyback switch-mode power converter 700 operates in the discontinuous conduction mode (DCM), the number (e.g., N) of cycles of critical conduction mode (CRM) during a switching phase decrease with the decreasing output current 793 (e.g., Iₒᵤₜ) in order to ensure that the envelope frequency (e.g., f_{DCM}) remains larger than the predetermined reference frequency value (e.g., f_{REF}).

In some embodiments, when the asymmetrical half-bridge flyback switch-mode power converter 700 operates in the discontinuous conduction mode (DCM), after the number (e.g., N) of cycles of critical conduction mode (CRM) during a switching phase has decreased to one, if the envelope frequency (e.g., f_{DCM}) decreases to the predetermined reference frequency value (e.g., f_{REF}), the envelope frequency (e.g., f_{DCM}) remains equal to the predetermined reference frequency value (e.g., f_{REF}) when the output current 793 (e.g., Iₒᵤₜ) decreases from the threshold current value I₂₄ to the threshold current value I₂₁. For example, when the output current 793 (e.g., Iₒᵤₜ) decreases from the threshold current value I₂₄ to the threshold current value I₂₁, the asymmetrical half-bridge flyback switch-mode power converter 700 operates in the discontinuous conduction mode (DCM) with N being equal to one. As an example, when the output current 793 (e.g., Iₒᵤₜ) decreases from the threshold current value I₂₄ to the threshold current value I₂₁, the peak value of the magnetization current 749 decreases from the current value ID to a current value IT.

In certain embodiments, when the output current 793 (e.g., Iₒᵤₜ) becomes smaller than the threshold current value I₂₁, the asymmetrical half-bridge flyback switch-mode power converter 700 changes its mode of operation from the discontinuous conduction mode (DCM) to the burst mode. For example, when the asymmetrical half-bridge flyback switch-mode power converter 700 changes its mode of operation from the discontinuous conduction mode (DCM) to the burst mode, the peak value of the magnetization current 749 increases from the current value IT to a current value I_{B}. As an example, when the asymmetrical half-bridge flyback switch-mode power converter 700 operates in the discontinuous conduction mode (DCM), the peak value of the magnetization current 749 remains equal to the current value I_{B} if the output current 793 (e.g., Iₒᵤₜ) decreases as shown in FIG. 8A.

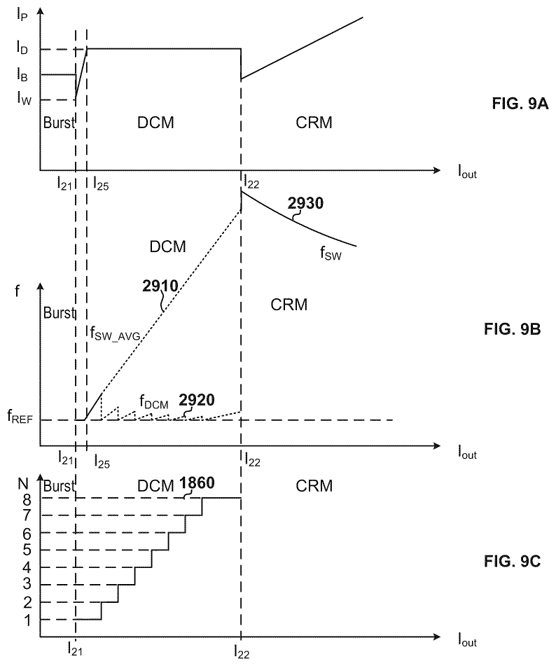

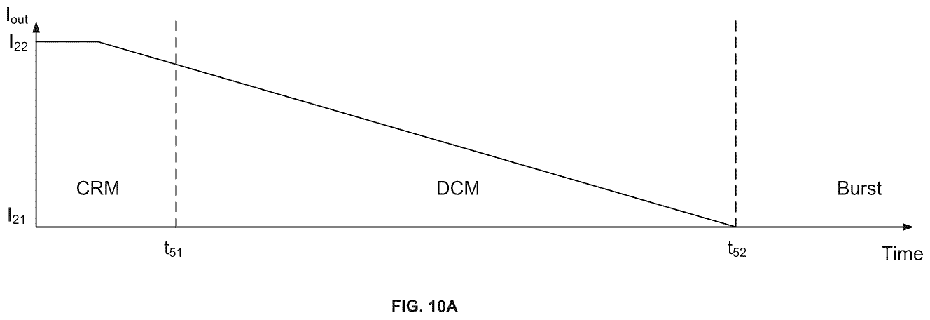

FIG. 9A is a simplified diagram showing a peak value of the magnetization current 749 as a function of the output current 793 for the asymmetrical half-bridge flyback switch-mode power converter 700 as shown in FIG. 5 and FIG. 6 according to certain embodiments of the present disclosure, FIG. 9B is a simplified diagram showing an envelope frequency of the discontinuous conduction mode (DCM) as a function of the output current 793, showing an average switching frequency of the discontinuous conduction mode (DCM) as a function of the output current 793, and showing a switching frequency of the critical conduction mode (CRM) as a function of the output current 793 for the asymmetrical half-bridge flyback switch-mode power converter 700 as shown in FIG. 5 and FIG. 6 according to some embodiments of the present disclosure, and FIG. 9C is a simplified diagram showing the number of cycles of critical conduction mode (CRM) during a switching phase of the discontinuous conduction mode (DCM) as a function of the output current 793 for the asymmetrical half-bridge flyback switch-mode power converter 700 as shown in FIG. 5 and FIG. 6 according to certain embodiments of the present disclosure. For example, the threshold current value I₂₁ as shown in FIG. 9A, FIG. 9B, and FIG. 9C is the same as the threshold current value I₂₁ as shown in FIG. 8A, FIG. 8B, and FIG. 8C. As an example, the threshold current value I₂₂ as shown in FIG. 9A, FIG. 9B, and FIG. 9C is the same as the threshold current value I₂₂ as shown in FIG. 8A, FIG. 8B, and FIG. 8C. For example, a threshold current value I₂₅ as shown in FIG. 9A and FIG. 9B has the same value. These diagrams are merely examples, which should not unduly limit the scope of the claims. One of ordinary skill in the art would recognize many variations, alternatives, and modifications.

As show in FIG. 9A, the asymmetrical half-bridge flyback switch-mode power converter 700 changes its mode of operation from a burst mode to a discontinuous conduction mode (DCM) and from the discontinuous conduction mode (DCM) to the critical conduction mode (CRM) according to some embodiments. For example, if the output current 793 (e.g., Iₒᵤₜ) is smaller than the threshold current value I₂₁, the asymmetrical half-bridge flyback switch-mode power converter 700 operates in the burst mode. As an example, if the output current 793 (e.g., Iₒᵤₜ) is larger than the threshold current value I₂₁ but is smaller than the threshold current value I₂₂, the asymmetrical half-bridge flyback switch-mode power converter 700 operates in the discontinuous conduction mode (DCM). For example, if the output current 793 (e.g., Iₒᵤₜ) is larger than the threshold current value I₂₂, the asymmetrical half-bridge flyback switch-mode power converter 700 operates in the critical conduction mode (CRM). In certain examples, Iₚ represents the peak value of the magnetization current 749. In some examples, the peak value of the magnetization current 749 (e.g., Iₚ) is I₁₁ as shown in FIG. 7.

As shown in FIG. 9B, the waveform 2910 represents the average switching frequency (e.g., f_{SW_AVG}) of the discontinuous conduction mode (DCM) as a function of the output current 793 (e.g., Iₒᵤₜ), the waveform 2920 represents the envelope frequency (e.g., f_{DCM}) of the discontinuous conduction mode (DCM) as a function of the output current 793 (e.g., Iₒᵤₜ), and the waveform 2930 represents the switching frequency (e.g., f_{SW}) of the critical conduction mode (CRM) as a function of the output current 793 (e.g., Iₒᵤₜ) according to certain embodiments. In some examples, f_{REF} represents a predetermined reference frequency value. For example, the predetermined frequency value (e.g., f_{REF}) is larger than 20 KHz. As an example, the predetermined frequency value (e.g., f_{REF}) as shown in FIG. 9B is the same as the predetermined frequency value (e.g., f_{REF}) as shown in FIG. 8B.

As shown in FIG. 9C, if the output current 793 (e.g., Iₒᵤₜ) becomes larger than the threshold current value I₂₂, the asymmetrical half-bridge flyback switch-mode power converter 700 changes the mode operation from the discontinuous conduction mode (DCM) to the critical conduction mode (CRM) according to some embodiments. For example, the waveform 2940 represents the number of cycles (e.g., N) of critical conduction mode (CRM) during a switching phase of the discontinuous conduction mode (DCM) as a function of the output current 793 (e.g., Iₒᵤₜ) according to some embodiments. As an example, N represents the number of cycles (e.g., the number of consecutive cycles) of critical conduction mode (CRM) during a switching phase of each cycle of the discontinuous conduction mode (DCM), wherein N is a positive integer. In certain example, the N cycles (e.g., N consecutive cycles) of critical conduction mode (CRM) include N+1 time durations when the control signal 713 remains at the logic high level and the control signal 711 remains at the logic low level and also include N time durations when the control signal 711 remains at the logic high level and the control signal 713 remains at the logic low level. For example, one cycle of the N cycles (e.g., N consecutive cycles) of critical conduction mode (CRM) includes the last time duration of the N time durations, the last time duration of the N+1 time durations, and the first time duration of the N+1 time durations. As an example, if N is equal to or larger than 2, each cycle of the other N cycles (e.g., N consecutive cycles) of critical conduction mode (CRM) includes one time duration of the N time durations and one time duration of the N+1 time durations, wherein the one time duration of the N time durations is not the last time duration of the N time durations, and the one time duration of the N+1 time durations is not the first time duration of the N+1 time durations and is also not the last time duration of the N+1 time durations. In some examples, if N is equal to or larger than 2, each cycle of the N cycles (e.g., N consecutive cycles) of critical conduction mode (CRM) does not share any of the N+1 time durations with any other cycle of the N cycles (e.g., N consecutive cycles) of critical conduction mode (CRM), and each cycle of the N cycles (e.g., N consecutive cycles) of critical conduction mode (CRM) does not share any of the N time durations with any other cycle of the N cycles (e.g., N consecutive cycles) of critical conduction mode (CRM).

In certain embodiments, during the switching phase, the control signal 713 remains at the logic high level and the control signal 711 remains at the logic low level during the N+1 time durations. For example, at the beginning of each time duration of the N+1 time durations, the control signal 713 changes from the logic low level to the logic high level, and at the end of each time duration of the N+1 time durations, the control signal 713 changes from the logic high level to the logic low level. As an example, during the first time duration of the N+1 time durations, the magnetization current 749 decreases from zero to a valley value, and during the last time duration of the N+1 time durations, the magnetization current 749 decreases from a peak value to zero. For example, the last time duration of the N+1 time durations is equal to the demagnetization period of the asymmetrical half-bridge flyback switch-mode power converter 700. In some examples, during the switching phase, after the first time duration but before the last time duration, there are N−1 time durations when the control signal 713 remains at the logic high level and the control signal 711 remains at the logic low level, wherein N−1 is equal to zero, equal to one, or equal to or larger than two. In certain examples, during the switching phase, the sum of the length of the first time duration and the length of the last time duration is equal to the length of each time duration of the N−1 time durations when the control signal 713 remains at the logic high level and the control signal 711 remains at the logic low level, wherein N is equal to or larger than two. In some examples, during the switching phase, the N−1 time durations when the control signal 713 remains at the logic high level and the control signal 711 remains at the logic low level are equal in length, wherein N is equal to or larger than three.

In some embodiments, during the switching phase, the control signal 711 remains at the logic high level and the control signal 713 remains at the logic low level during the N time durations. For example, at the beginning of each time duration of the N time durations, the control signal 711 changes from the logic low level to the logic high level, and at the end of each time duration of the N time durations, the control signal 711 changes from the logic high level to the logic low level. As an example, during the switching phase, the control signal 711 changes from the logic low level to the logic high level in a total of N times, and the control signal 711 changes from the logic high level to the logic low level in a total of N times. In some examples, each time duration of the N time durations when the control signal 711 remains at the logic high level and the control signal 713 remains at the logic low level is between two time durations of the N+1 time durations when the control signal 713 remains at the logic high level and the control signal 711 remains at the logic low level. In certain examples, between two time durations of the N+1 time durations when the control signal 713 remains at the logic high level and the control signal 711 remains at the logic low level, there is only one time duration of the N time durations when the control signal 711 remains at the logic high level and the control signal 713 remains at the logic low level.

Also as shown in FIG. 9C, when the output current 793 (e.g., Iₒᵤₜ) increases from the threshold current value I₂₁ to the threshold current value I₂₂, N increases from 1 to its maximum value 1860 (e.g., N_{MAX}) according to certain embodiments. For example, the maximum value 1860 (e.g., N_{MAX}) is equal to 8. As an example, the maximum value 1860 (e.g., N_{MAX}) as shown in FIG. 9C is the same as the maximum value 1860 (e.g., N_{MAX}) as shown in FIG. 8C. In some examples, after N reaches its maximum value 1860 (e.g., N_{MAX}), N remains equal to the maximum value 1860 (e.g., N_{MAX}) until the asymmetrical half-bridge flyback switch-mode power converter 700 changes the mode operation from the discontinuous conduction mode (DCM) to the critical conduction mode (CRM) when the output current 793 (e.g., Iₒᵤₜ) becomes larger than the threshold current value I₂₂.

According to some embodiments, when the asymmetrical half-bridge flyback switch-mode power converter 700 operates in the critical conduction mode (CRM), if the output current 793 (e.g., Iₒᵤₜ) decreases, the peak value of the magnetization current 749 decreases as shown in FIG. 8A and the switching frequency (e.g., f_{SW}) increases as shown by the waveform 2930. For example, if the output current 793 (e.g., Iₒᵤₜ) becomes smaller than the threshold current value I₂₂, the asymmetrical half-bridge flyback switch-mode power converter 700 changes its mode of operation from the critical conduction mode (CRM) to the discontinuous conduction mode (DCM) in order to prevent the peak value of the magnetization current 749 from decreasing further.

According to certain embodiments, when the asymmetrical half-bridge flyback switch-mode power converter 700 changes its mode of operation from the critical conduction mode (CRM) to the discontinuous conduction mode (DCM), the peak value of the magnetization current 749 rises to the current value ID. For example, the current value ID as shown in FIG. 9A is the same as the current value ID as shown in FIG. 8A. As an example, when the asymmetrical half-bridge flyback switch-mode power converter 700 operates in the discontinuous conduction mode (DCM), the peak value of the magnetization current 749 remains equal to the current value ID if the output current 793 (e.g., Iₒᵤₜ) is smaller than the threshold current value I₂₂ but is larger than the threshold current value I₂₅ as shown in FIG. 9A. In some examples, when the asymmetrical half-bridge flyback switch-mode power converter 700 operates in the discontinuous conduction mode (DCM), the average switching frequency (e.g., f_{SW_AVG}) decreases with the decreasing output current 793 (e.g., Iₒᵤₜ) if the output current 793 (e.g., Iₒᵤₜ) is smaller than the threshold current value I₂₂ but is larger than the threshold current value I₂₅ as shown by the waveform 2910. In certain examples, when the asymmetrical half-bridge flyback switch-mode power converter 700 operates in the discontinuous conduction mode (DCM), the number (e.g., N) of cycles of critical conduction mode (CRM) during a switching phase decrease with the decreasing output current 793 (e.g., Iₒᵤₜ) in order to ensure that the envelope frequency (e.g., f_{DCM}) remains larger than the predetermined reference frequency value (e.g., f_{REF}).

In some embodiments, when the asymmetrical half-bridge flyback switch-mode power converter 700 operates in the discontinuous conduction mode (DCM), after the number (e.g., N) of cycles of critical conduction mode (CRM) during a switching phase has decreased to one, if the envelope frequency (e.g., f_{DCM}) decreases to the predetermined reference frequency value (e.g., f_{REF}), the envelope frequency (e.g., f_{DCM}) remains equal to the predetermined reference frequency value (e.g., f_{REF}) when the output current 793 (e.g., Iₒᵤₜ) decreases from the threshold current value I₂₅ to the threshold current value I₂₁. For example, when the output current 793 (e.g., Iₒᵤₜ) decreases from the threshold current value 125 to the threshold current value I₂₁, the asymmetrical half-bridge flyback switch-mode power converter 700 operates in the discontinuous conduction mode (DCM) with N being equal to one. As an example, when the output current 793 (e.g., Iₒᵤₜ) decreases from the threshold current value I₂₅ to the threshold current value I₂₁, the peak value of the magnetization current 749 decreases from the current value ID to a current value I_{W}.

In certain embodiments, when the output current 793 (e.g., Iₒᵤₜ) becomes smaller than the threshold current value I₂₁, the asymmetrical half-bridge flyback switch-mode power converter 700 changes its mode of operation from the discontinuous conduction mode (DCM) to the burst mode. For example, when the asymmetrical half-bridge flyback switch-mode power converter 700 changes its mode of operation from the discontinuous conduction mode (DCM) to the burst mode, the peak value of the magnetization current 749 increases from the current value I_{W} to the current value Is. As an example, the current value I_{B} as shown in FIG. 9A is the same as the current value I_{B} as shown in FIG. 8A. In some examples, when the asymmetrical half-bridge flyback switch-mode power converter 700 operates in the discontinuous conduction mode (DCM), the peak value of the magnetization current 749 remains equal to the current value Is if the output current 793 (e.g., Iₒᵤₜ) decreases as shown in FIG. 9A.

According to some embodiments, the current value I_{W} as shown in FIG. 9A is larger than the current value IT as shown in FIG. 8A, and the threshold current value I₂₅ as shown in FIG. 9A and FIG. 9B is smaller than the threshold current value I₂₄ as shown in FIG. 8A and FIG. 8B. According to certain embodiments, the magnetizing inductance Lₘ of the magnetizing inductor 748 that correspond to FIG. 9A, FIG. 9B and FIG. 9C is lower than the magnetizing inductance Lₘ of the magnetizing inductor 748 that correspond to FIG. 8A, FIG. 8B and FIG. 8C.

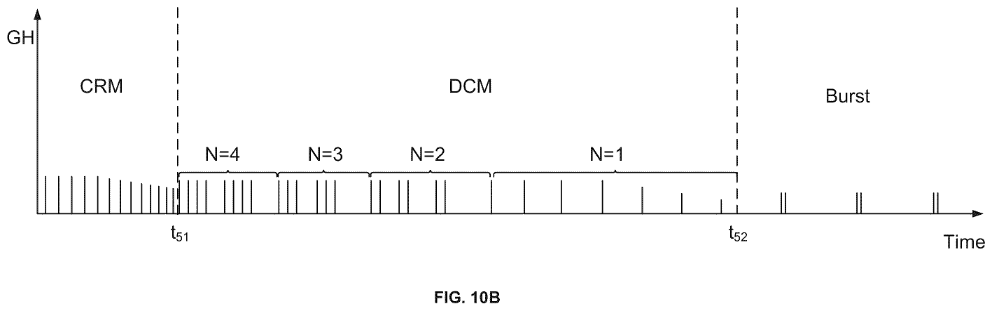

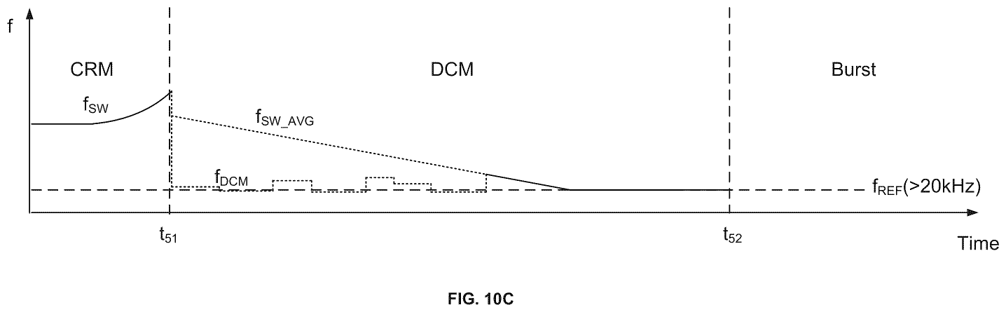

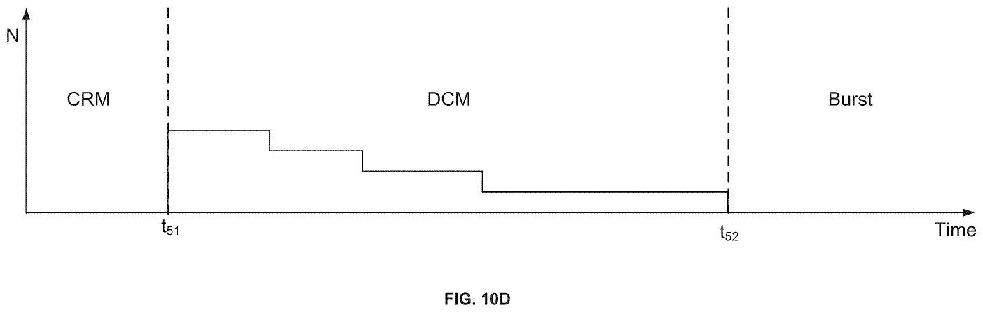

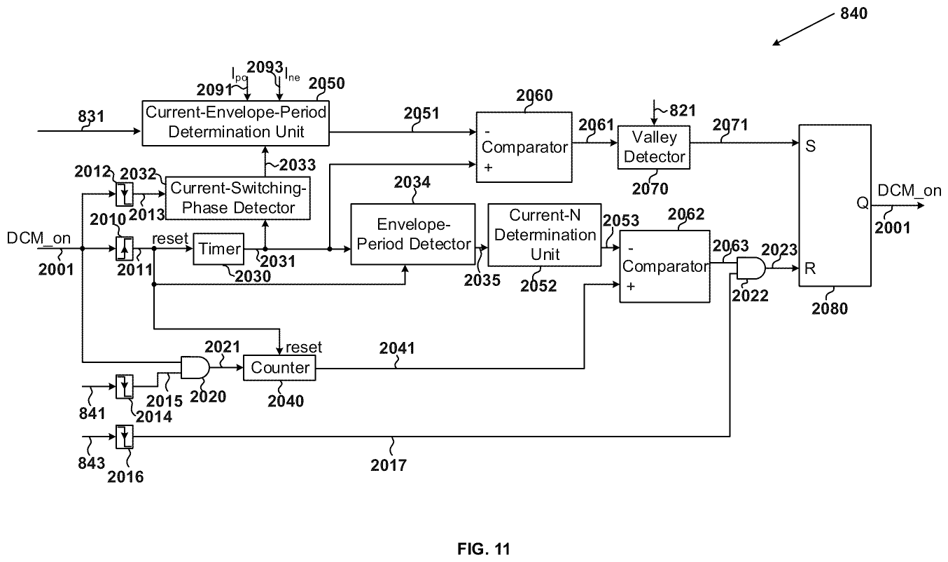

FIG. 10A is a simplified diagram showing the output current 793 as a function of time for the asymmetrical half-bridge flyback switch-mode power converter 700 as shown in FIG. 5 and FIG. 6 according to certain embodiments of the present disclosure, FIG. 10B is a simplified diagram showing the control signal 711 as a function of time and showing a peak value of the magnetization current 749 as a function of the output current 793 for the asymmetrical half-bridge flyback switch-mode power converter 700 as shown in FIG. 5 and FIG. 6 according to some embodiments of the present disclosure, FIG. 10C is a simplified diagram showing an envelope frequency of the discontinuous conduction mode (DCM) as a function of time, showing an average switching frequency of the discontinuous conduction mode (DCM) as a function of time, and showing a switching frequency of the critical conduction mode (CRM) as a function of time for the asymmetrical half-bridge flyback switch-mode power converter 700 as shown in FIG. 5 and FIG. 6 according to certain embodiments of the present disclosure, and FIG. 10D is a simplified diagram showing the number of cycles of critical conduction mode (CRM) during a switching phase of the discontinuous conduction mode (DCM) as a function of time for the asymmetrical half-bridge flyback switch-mode power converter 700 as shown in FIG. 5 and FIG. 6 according to some embodiments of the present disclosure. For example, a time t₅₁ as shown in FIG. 10A, FIG. 10B, FIG. 10C and FIG. 10D has the same value. As an example, a time t₅₂ as shown in FIG. 10A, FIG. 10B, FIG. 10C and FIG. 10D has the same value. These diagrams are merely examples, which should not unduly limit the scope of the claims. One of ordinary skill in the art would recognize many variations, alternatives, and modifications.

In some examples, as shown in FIG. 10B, each pulse represents that the control signal 711 changes from the logic low level to the logic high level at the beginning of the pulse and then changes from the logic high level back to the logic low level at the end of the pulse. In certain examples, as shown in FIG. 10B, each pulse also represents the peak value of the magnetization current 749. For example, a pulse with larger height represents a higher peak value of the magnetization current 749. As an example, a pulse with smaller height represents a lower peak value of the magnetization current 749.

In some embodiments, if the time is earlier than the time t₅₁, the asymmetrical half-bridge flyback switch-mode power converter 700 operates in the critical conduction mode (CRM) as shown in FIG. 10A, FIG. 10B, FIG. 10C, and FIG. 10D. In certain embodiments, if the time is later than the time t₅₁ but earlier than the time t₅₂, the asymmetrical half-bridge flyback switch-mode power converter 700 operates in the discontinuous conduction mode (DCM) as shown in FIG. 10A, FIG. 10B, FIG. 10C, and FIG. 10D. In some embodiments, if the time is later than the time t₅₂, the asymmetrical half-bridge flyback switch-mode power converter 700 operates in the burst mode as shown in FIG. 10A, FIG. 10B, FIG. 10C, and FIG. 10D.

According to some embodiments, as shown in FIG. 10A, when the output current 793 is large, the asymmetrical half-bridge flyback switch-mode power converter 700 operates in the critical conduction mode (CRM). For example, if the asymmetrical half-bridge flyback switch-mode power converter 700 operates in the critical conduction mode (CRM), when the output current 793 decreases as shown in FIG. 10A, the peak value of the magnetization current 749 decreases as shown in FIG. 10B and the switching frequency of the critical conduction mode (CRM) increases in FIG. 10C.

According to certain embodiments, as shown in FIG. 10A, when the output current 793 becomes smaller than the threshold current value I₂₂, the asymmetrical half-bridge flyback switch-mode power converter 700 changes its mode of operation from the critical conduction mode (CRM) to the discontinuous conduction mode (DCM). For example, as shown in FIG. 10B, for the 1^{st} and 2^{nd} cycles of the discontinuous conduction mode (DCM), each cycle includes a switching phase and an idle phase, wherein the switching phase includes N cycles (e.g., N consecutive cycles) of critical conduction mode (CRM) and N is equal to four. As an example, as shown in FIG. 10B, for the 3^{rd} and 4^{th} cycles of the discontinuous conduction mode (DCM), each cycle includes a switching phase and an idle phase, wherein the switching phase includes N cycles (e.g., N consecutive cycles) of critical conduction mode (CRM) and N is equal to three. For example, as shown in FIG. 10B, for the 5^{th}, 6^{th} and 7^{th} cycles of the discontinuous conduction mode (DCM), each cycle includes a switching phase and an idle phase, wherein the switching phase includes N cycles (e.g., N consecutive cycles) of critical conduction mode (CRM) and N is equal to two. As an example, as shown in FIG. 10B, for the 8^{th}, 9^{th}, 10^{th}, 11^{th}, 12^{th}, 13^{th} and 14^{th} cycles of the discontinuous conduction mode (DCM), each cycle includes a switching phase and an idle phase, wherein the switching phase includes N cycles (e.g., N consecutive cycles) of critical conduction mode (CRM) and N is equal to one.

In some embodiments, as shown in FIG. 10D, if the asymmetrical half-bridge flyback switch-mode power converter 700 operates in the discontinuous conduction mode (DCM), the number (e.g., N) of cycles of critical conduction mode (CRM) during a switching phase of the discontinuous conduction mode (DCM) decreases with the decreasing output current 793 (e.g., Iₒᵤₜ), so that the envelope frequency (e.g., f_{DCM}) remains larger than the predetermined reference frequency value (e.g., f_{REF}). For example, the predetermined frequency value (e.g., f_{REF}) is larger than 20 KHz.

In certain embodiments, as shown in FIG. 10D, when the asymmetrical half-bridge flyback switch-mode power converter 700 operates in the discontinuous conduction mode (DCM), after the number (e.g., N) of cycles of critical conduction mode (CRM) during a switching phase has decreased to one, if the envelope frequency (e.g., f_{DCM}) decreases to the predetermined reference frequency value (e.g., f_{REF}), the envelope frequency (e.g., f_{DCM}) then remains equal to the predetermined reference frequency value (e.g., f_{REF}) as shown in FIG. 10C but the peak value of the magnetization current 749 decreases as shown in FIG. 10B when the output current 793 (e.g., Iₒᵤₜ) decreases. As an example, if the output current 793 (e.g., Iₒᵤₜ) becomes smaller than the threshold current value I₂₁, the asymmetrical half-bridge flyback switch-mode power converter 700 changes its mode of operation from the discontinuous conduction mode (DCM) to the burst mode.

As shown in FIG. 10D, N represents the number of cycles (e.g., the number of consecutive cycles) of critical conduction mode (CRM) during a switching phase of each cycle of the discontinuous conduction mode (DCM), wherein N is a positive integer, according to some embodiments. In certain example, the N cycles (e.g., N consecutive cycles) of critical conduction mode (CRM) include N+1 time durations when the control signal 713 remains at the logic high level and the control signal 711 remains at the logic low level and also include N time durations when the control signal 711 remains at the logic high level and the control signal 713 remains at the logic low level. For example, one cycle of the N cycles (e.g., N consecutive cycles) of critical conduction mode (CRM) includes the last time duration of the N time durations, the last time duration of the N+1 time durations, and the first time duration of the N+1 time durations. As an example, if N is equal to or larger than 2, each cycle of the other N cycles (e.g., N consecutive cycles) of critical conduction mode (CRM) includes one time duration of the N time durations and one time duration of the N+1 time durations, wherein the one time duration of the N time durations is not the last time duration of the N time durations, and the one time duration of the N+1 time durations is not the first time duration of the N+1 time durations and is also not the last time duration of the N+1 time durations. In some examples, if N is equal to or larger than 2, each cycle of the N cycles (e.g., N consecutive cycles) of critical conduction mode (CRM) does not share any of the N+1 time durations with any other cycle of the N cycles (e.g., N consecutive cycles) of critical conduction mode (CRM), and each cycle of the N cycles (e.g., N consecutive cycles) of critical conduction mode (CRM) does not share any of the N time durations with any other cycle of the N cycles (e.g., N consecutive cycles) of critical conduction mode (CRM).

In certain embodiments, during the switching phase, the control signal 713 remains at the logic high level and the control signal 711 remains at the logic low level during the N+1 time durations. For example, at the beginning of each time duration of the N+1 time durations, the control signal 713 changes from the logic low level to the logic high level, and at the end of each time duration of the N+1 time durations, the control signal 713 changes from the logic high level to the logic low level. As an example, during the first time duration of the N+1 time durations, the magnetization current 749 decreases from zero to a valley value, and during the last time duration of the N+1 time durations, the magnetization current 749 decreases from a peak value to zero. For example, the last time duration of the N+1 time durations is equal to the demagnetization period of the asymmetrical half-bridge flyback switch-mode power converter 700. In some examples, during the switching phase, after the first time duration but before the last time duration, there are N−1 time durations when the control signal 713 remains at the logic high level and the control signal 711 remains at the logic low level, wherein N−1 is equal to zero, equal to one, or equal to or larger than two. In certain examples, during the switching phase, the sum of the length of the first time duration and the length of the last time duration is equal to the length of each time duration of the N−1 time durations when the control signal 713 remains at the logic high level and the control signal 711 remains at the logic low level, wherein N is equal to or larger than two. In some examples, during the switching phase, the N−1 time durations when the control signal 713 remains at the logic high level and the control signal 711 remains at the logic low level are equal in length, wherein N is equal to or larger than three.

In some embodiments, during the switching phase, the control signal 711 remains at the logic high level and the control signal 713 remains at the logic low level during the N time durations. For example, at the beginning of each time duration of the N time durations, the control signal 711 changes from the logic low level to the logic high level, and at the end of each time duration of the N time durations, the control signal 711 changes from the logic high level to the logic low level. As an example, during the switching phase, the control signal 711 changes from the logic low level to the logic high level in a total of N times, and the control signal 711 changes from the logic high level to the logic low level in a total of N times. In some examples, each time duration of the N time durations when the control signal 711 remains at the logic high level and the control signal 713 remains at the logic low level is between two time durations of the N+1 time durations when the control signal 713 remains at the logic high level and the control signal 711 remains at the logic low level. In certain examples, between two time durations of the N+1 time durations when the control signal 713 remains at the logic high level and the control signal 711 remains at the logic low level, there is only one time duration of the N time durations when the control signal 711 remains at the logic high level and the control signal 713 remains at the logic low level.

FIG. 11 is a simplified diagram showing certain components of the logic controller 840 as part of the controller chip 710 of the asymmetrical half-bridge flyback switch-mode power converter 700 as shown in FIG. 5 and FIG. 6 according to certain embodiments of the present disclosure. This diagram is merely an example, which should not unduly limit the scope of the claims. One of ordinary skill in the art would recognize many variations, alternatives, and modifications. The logic controller 840 includes a rising-edge detector 2010, falling-edge detectors 2012, 2014 and 2016, AND gates 2020 and 2022, a timer 2030, a current-switching-phase detector 2032, an envelope-period detector 2034, a counter 2040, a current-envelope-period determination unit 2050, a current-N determination unit 2052, comparators 2060 and 2062, a valley detector 2070, and a flip-flop 2080. For example, the current-envelope-period determination unit 2050 is implemented using one or more software components, one or more hardware components, and/or one or more combinations of software and hardware components, and/or the current-envelope-period determination unit 2050 is implemented in one or more circuits, such as one or more analog circuits and/or one or more digital circuits. As an example, the current-N determination unit 2052 is implemented using one or more software components, one or more hardware components, and/or one or more combinations of software and hardware components, and/or the current-N determination unit 2052 is implemented in one or more circuits, such as one or more analog circuits and/or one or more digital circuits. Although the above has been shown using a selected group of components for the logic controller, there can be many alternatives, modifications, and variations. For example, some of the components may be expanded and/or combined. Other components may be inserted to those noted above. Depending upon the embodiment, the arrangement of components may be interchanged with others replaced. Further details of these components are found throughout the present specification.

As shown in FIG. 11, the logic controller 840 generates the signal 2001 according to some embodiments. For example, the signal 2001 is an internal signal of the logic controller 840. In certain examples, the waveform 1710 of FIG. 7 represents the signal 2001 as a function of time. For example, during the switching phase of the discontinuous conduction mode (DCM), the signal 2001 is at the logic high level. As an example, during the idle phase of the discontinuous conduction mode (DCM), the signal 2001 is at the logic low level. In some examples, the logic controller 840 uses at least the signal 821, the signal 831, the signal 841 and the signal 843 to generate the signal 2001 as shown in FIG. 6.

In certain embodiments, the signal 2001 is received by the rising-edge detector 2010, which generates a signal 2011. For example, if the signal 2001 changes from the logic low level to the logic high level, the rising-edge detector 2010 generates a pulse of the signal 2011. As an example, at the end of the idle phase of a previous cycle of the discontinuous conduction mode (DCM) and the start of the switching phase of a current cycle of the discontinuous conduction mode (DCM), the rising-edge detector 2010 generates the pulse of the signal 2011. In some examples, each cycle of the discontinuous conduction mode (DCM) includes its switching phase and its idle phase that follows its switching phase. For example, the end of the idle phase of the previous cycle of the discontinuous conduction mode (DCM) is the end of the previous cycle, and the start of the switching phase of the current cycle of the discontinuous conduction mode (DCM) is the start of the current cycle. As an example, the previous cycle of the discontinuous conduction mode (DCM) ends and the current cycle of the discontinuous conduction mode (DCM) starts at the same time. In some examples, the signal 2011 is received by the timer 2030. For example, a pulse of the signal 2011 resets the timer 2030 to zero. As an example, after the reset, the timer 2030 measures the time duration since the reset of the timer 2030. In certain examples, the pulse of the signal 2011 resets the timer 2030 to zero at the end of the previous cycle and the start of the current cycle. For example, after the timer 2030 is reset to zero, the timer 2030 measures the time duration since the start of the current cycle. In some examples, the timer 2030 generates a signal 2031 that represents the measured time duration. For example, the signal 2031 is received by the envelope-period detector 2034. As an example, the signal 2031 is received by the current-switching-phase detector 2032.

In some embodiments, before the end of the previous cycle of the discontinuous conduction mode (DCM) and the start of the current cycle of the discontinuous conduction mode (DCM), the envelope-period detector 2034 receives the signal 2031 that represents the measured time duration since the start of the previous cycle. For example, at the end of the previous cycle and the start of the current cycle, the envelope-period detector 2034 receives a pulse of the signal 2011. As an example, in response to the pulse of the signal 2011, the envelope-period detector 2034 determines the envelope period of the previous cycle of the discontinuous conduction mode (DCM) based at least in part on the signal 2031 that represents the measured time duration since the start of the previous cycle, wherein the pulse of the signal 2011 indicates the end of the previous cycle of the discontinuous conduction mode (DCM) and the start of the current cycle of the discontinuous conduction mode (DCM). In certain examples, the envelope-period detector 2034 generates a signal 2035 that represents the detected envelope period of the previous cycle of the discontinuous conduction mode (DCM). For example, the signal 2035 (e.g., an input signal) is received by the current-N determination unit 2052.

According to certain embodiments, the current-N determination unit 2052 receives the signal 2035 that represents the detected envelope period of the previous cycle of the discontinuous conduction mode (DCM), and determines the number (e.g., N) of cycles of critical conduction mode (CRM) during the switching phase of the current cycle of the discontinuous conduction mode (DCM). For example, the current-N determination unit 2052 determines N for the switching phase of the current cycle of the discontinuous conduction mode (DCM) based at least in part on the signal 2035 that represents the detected envelope period of the previous cycle of the discontinuous conduction mode (DCM). As an example, the current-N determination unit 2052 generates a signal 2053 that represents the determined N for the switching phase of the current cycle of the discontinuous conduction mode (DCM).

According to some embodiments, the determined N for the switching phase of the current cycle of the discontinuous conduction mode (DCM) represents the number of cycles of critical conduction mode (CRM) during the switching phase of the current cycle of the discontinuous conduction mode (DCM), wherein N is a positive integer. In certain example, the N cycles (e.g., N consecutive cycles) of critical conduction mode (CRM) include N+1 time durations when the control signal 713 remains at the logic high level and the control signal 711 remains at the logic low level and also include N time durations when the control signal 711 remains at the logic high level and the control signal 713 remains at the logic low level. For example, one cycle of the N cycles (e.g., N consecutive cycles) of critical conduction mode (CRM) includes the last time duration of the N time durations, the last time duration of the N+1 time durations, and the first time duration of the N+1 time durations. As an example, if N is equal to or larger than 2, each cycle of the other N cycles (e.g., N consecutive cycles) of critical conduction mode (CRM) includes one time duration of the N time durations and one time duration of the N+1 time durations, wherein the one time duration of the N time durations is not the last time duration of the N time durations, and the one time duration of the N+1 time durations is not the first time duration of the N+1 time durations and is also not the last time duration of the N+1 time durations. In some examples, if N is equal to or larger than 2, each cycle of the N cycles (e.g., N consecutive cycles) of critical conduction mode (CRM) does not share any of the N+1 time durations with any other cycle of the N cycles (e.g., N consecutive cycles) of critical conduction mode (CRM), and each cycle of the N cycles (e.g., N consecutive cycles) of critical conduction mode (CRM) does not share any of the N time durations with any other cycle of the N cycles (e.g., N consecutive cycles) of critical conduction mode (CRM).

In certain embodiments, during the switching phase of the current cycle of the discontinuous conduction mode (DCM), the control signal 713 remains at the logic high level and the control signal 711 remains at the logic low level during the N+1 time durations, wherein N is determined by the current-N determination unit 2052 and represented by the signal 2053. For example, at the beginning of each time duration of the N+1 time durations, the control signal 713 changes from the logic low level to the logic high level, and at the end of each time duration of the N+1 time durations, the control signal 713 changes from the logic high level to the logic low level. As an example, during the first time duration of the N+1 time durations, the magnetization current 749 decreases from zero to a valley value, and during the last time duration of the N+1 time durations, the magnetization current 749 decreases from a peak value to zero. For example, the last time duration of the N+1 time durations is equal to the demagnetization period of the asymmetrical half-bridge flyback switch-mode power converter 700. In some examples, during the switching phase of the current cycle of the discontinuous conduction mode (DCM), after the first time duration but before the last time duration, there are N−1 time durations when the control signal 713 remains at the logic high level and the control signal 711 remains at the logic low level, wherein N−1 is equal to zero, equal to one, or equal to or larger than two. In certain examples, during the switching phase of the current cycle of the discontinuous conduction mode (DCM), the sum of the length of the first time duration and the length of the last time duration is equal to the length of each time duration of the N−1 time durations when the control signal 713 remains at the logic high level and the control signal 711 remains at the logic low level, wherein N is equal to or larger than two. In some examples, during the switching phase of the current cycle of the discontinuous conduction mode (DCM), the N−1 time durations when the control signal 713 remains at the logic high level and the control signal 711 remains at the logic low level are equal in length, wherein N is equal to or larger than three.

In some embodiments, during the switching phase of the current cycle of the discontinuous conduction mode (DCM), the control signal 711 remains at the logic high level and the control signal 713 remains at the logic low level during the N time durations, wherein N is determined by the current-N determination unit 2052 and represented by the signal 2053. For example, at the beginning of each time duration of the N time durations, the control signal 711 changes from the logic low level to the logic high level, and at the end of each time duration of the N time durations, the control signal 711 changes from the logic high level to the logic low level. As an example, during the switching phase of the current cycle of the discontinuous conduction mode (DCM), the control signal 711 changes from the logic low level to the logic high level in a total of N times, and the control signal 711 changes from the logic high level to the logic low level in a total of N times, wherein N is determined by the current-N determination unit 2052 and represented by the signal 2053. In some examples, each time duration of the N time durations when the control signal 711 remains at the logic high level and the control signal 713 remains at the logic low level is between two time durations of the N+1 time durations when the control signal 713 remains at the logic high level and the control signal 711 remains at the logic low level. In certain examples, between two time durations of the N+1 time durations when the control signal 713 remains at the logic high level and the control signal 711 remains at the logic low level, there is only one time duration of the N time durations when the control signal 711 remains at the logic high level and the control signal 713 remains at the logic low level.

According to certain embodiments, the signal 841 is received by the falling-edge detector 2014, which generates a signal 2015. For example, if the signal 841 changes from the logic high level to the logic low level, the falling-edge detector 2014 generates a pulse of the signal 2015. As an example, if the control signal 711 changes from the logic high level to the logic low level, the falling-edge detector 2014 generates the pulse of the signal 2015. In certain examples, the signal 2015 is received by the AND gate 2020, which also receives the signal 2001 and generates a signal 2021. For example, if the signal 2001 is at the logic high level, in response to a pulse of the signal 2015, the AND gate 2020 also generates a pulse of the signal 2021. As an example, during the switching phase of the discontinuous conduction mode (DCM), in response to a pulse of the signal 2015, the AND gate 2020 also generates a pulse of the signal 2021. In certain examples, the signal 2021 is received by the counter 2040.

In certain embodiments, the signal 2011 is received by the counter 2040. For example, the pulse signal 2011 resets the counter 2040 to zero at the end of the previous cycle and the start of the current cycle. As an example, after the counter 2040 is reset to zero, the counter 2040 counts the number of pulses of the signal 2021 since the reset of the counter 2040. In certain examples, the counter 2040 generates a signal 2041 that represents the number of counted pulses. For example, the signal 2041 represents the number of counted pulses of the signal 2011 since the start of the current cycle of the discontinuous conduction mode (DCM). As an example, the signal 2041 represents the number of times (e.g., m) that the control signal 711 changes from the logic high level to the logic low level since the start of the current cycle of the discontinuous conduction mode (DCM), wherein m is a positive integer. In some examples, each cycle of the discontinuous conduction mode (DCM) includes its switching phase and its idle phase that follows its switching phase, and the start of the cycle of the discontinuous conduction mode (DCM) is the start of the switching phase of the cycle of the discontinuous conduction mode (DCM). For example, the signal 2041 represents the number of counted pulses of the signal 2011 since the start of the switching phase of the current cycle of the discontinuous conduction mode (DCM). As an example, the signal 2041 represents the number of times (e.g., m) that the control signal 711 changes from the logic high level to the logic low level since the start of the switching phase of the current cycle of the discontinuous conduction mode (DCM), wherein m is a positive integer.

In some embodiments, the signal 2053 and the signal 2041 are received by the comparator 2062, which generates a comparison signal 2063. For example, the signal 2053 represents the determined N for the switching phase of the current cycle of the discontinuous conduction mode (DCM). As an example, the signal 2041 represents the counted m since the start of the switching phase of the current cycle of the discontinuous conduction mode (DCM), wherein the counted m is the number of times that the control signal 711 changes from the logic high level to the logic low level since the start of the switching phase of the current cycle of the discontinuous conduction mode (DCM). In certain examples, if the counted m becomes equal to or larger than the determined N, the comparison signal 2063 changes from the logic low level to the logic high level. For example, if the counted m is smaller than the determined N, the comparison signal 2063 is at the logic low level. As an example, if the counted m is larger than the determined N, the comparison signal 2063 is at the logic high level. In some examples, the comparison signal 2063 is received by the AND gate 2022.

According to certain embodiments, the signal 843 is received by the falling-edge detector 2016, which generates a signal 2017. For example, if the signal 843 changes from the logic high level to the logic low level, the falling-edge detector 2016 generates a pulse of the signal 2017. As an example, if the control signal 713 changes from the logic high level to the logic low level, the falling-edge detector 2016 generates the pulse of the signal 2017. In some examples, the signal 2017 is received by the AND gate 2022, which also receives the comparison signal 2063 and generates a signal 2023. For example, if the comparison signal 2063 is at the logic high level, in response to a pulse of the signal 2017, the AND gate 2022 also generates a pulse of the signal 2023. As an example, during the switching phase of the current cycle of the discontinuous conduction mode (DCM), after the counted m becomes equal to the determined N, in response to a pulse of the signal 2017, the AND gate 2022 also generates a pulse of the signal 2023. In certain examples, the signal 2023 is received by the flip-flop 2080, which generates the signal 2001 (e.g., a phase control signal). For example, in response to a pulse of the signal 2023, the flip-flop 2080 changes the signal 2001 from the logic high level to the logic low level, indicating the end of the switching phase of the current cycle of the discontinuous conduction mode (DCM) and the start of the idle phase of the current cycle of the discontinuous conduction mode (DCM).

According to some embodiments, the signal 2001 is received by the falling-edge detector 2012, which generates a signal 2013. For example, if the signal 2001 changes from the logic high level to the logic low level, the falling-edge detector 2012 generates a pulse of the signal 2013. As an example, at the end of the switching phase of the current cycle of the discontinuous conduction mode (DCM) and the start of the idle phase of the current cycle of the discontinuous conduction mode (DCM), the falling-edge detector 2012 generates the pulse of the signal 2013.

In certain embodiments, the current-switching-phase detector 2032 receives the signal 2013 and the signal 2031 and generates a signal 2033. In some examples, after the start of the current cycle of the discontinuous conduction mode (DCM), the current-switching-phase detector 2032 receives the signal 2031 that represents the measured time duration since the start of the current cycle. For example, the start of the current cycle of the discontinuous conduction mode (DCM) is the start of the switching phase of the current cycle of the discontinuous conduction mode (DCM). As an example, the signal 2031 represents the measured time duration since the start of the switching phase of the current cycle. In certain examples, in response to the pulse of the signal 2013, the current-switching-phase detector 2032 detects the time duration for the switching phase of the current cycle of the discontinuous conduction mode (DCM) based at least in part on the signal 2031 that represents the measured time duration since the start of the switching phase of the current cycle. In certain examples, the current-switching-phase detector 2032 generates the signal 2033 that represents the detected time duration for the switching phase of the current cycle of the discontinuous conduction mode (DCM). For example, the signal 2033 is received by the current-envelope-period determination unit 2050.

In some embodiments, the current-envelope-period determination unit 2050 receives the signal 2033 and the signal 831 and determines an envelope period of the current cycle of the discontinuous conduction mode (DCM) based at least in part on the signal 2033 and the signal 831. For example, the signal 831 is used to determine the output current 793. As an example, the current-envelope-period determination unit 2050 generates a signal 2051 that represents the determined envelope period of the current cycle of the discontinuous conduction mode (DCM). In certain examples, the current-envelope-period determination unit 2050 also receives signals 2091 and 2093, wherein the signal 2091 represents the peak value of the magnetization current 749 and the signal 2093 represents the valley value of the magnetization current 749. For examples, the peak value of the magnetization current 739 is determined based at least in part on the determined output current 793. As an example, the valley value of the magnetization current 749 is determined to achieve zero-voltage switching for the switch 722. In some examples, the envelope period of the current cycle of the discontinuous conduction mode (DCM) is determined as follows:

$$\\ \begin{matrix}{T}_{DCM} = \frac{{N}_{ps}}{2} \times \frac{{I}_{po} + {I}_{ne}}{{I}_{out}} \times {t}_{SP} & ( Equation 10 )\end{matrix}$$

where T_{DCM} represents the envelope period of the current cycle of the discontinuous conduction mode (DCM). Additionally, Nₚₛ represents the turns ratio that is equal to the ratio of the number of turns in the primary winding 742 to the number of turns in the secondary winding 744. Moreover, Iₚₒ represents the peak value of the magnetization current 749, and Iₙₑ represents the valley value of the magnetization current 749. Also, Iₒᵤₜ represents the output current 793. Additionally, t_{SP} represents the detected time duration for the switching phase of the current cycle of the discontinuous conduction mode (DCM). For example, the envelope period (e.g., T_{DCM}) of the current cycle of the discontinuous conduction mode (DCM) is equal to the sum of the time duration (e.g., t_{SP}) for the switching phase of the current cycle and the time duration for the idle phase of the current cycle. As an example, the peak value Iₚₒ of the magnetization current 749 is equal to the current value 1791, and the the valley value Iₙₑ of the magnetization current 749 is equal to the current value 1793 as shown in FIG. 7.

According to certain embodiments, the signal 2051 and the signal 2031 are received by the comparator 2060, which generates a comparison signal 2061. For example, the signal 2051 represents the determined envelope period of the current cycle of the discontinuous conduction mode (DCM). As an example, the signal 2031 that represents the measured time duration since the start of the current cycle of the discontinuous conduction mode (DCM). In some examples, if the measured time duration since the start of the current cycle becomes equal to or larger than the determined envelope period of the current cycle, the comparison signal 2061 changes from the logic low level to the logic high level. For example, if the measured time duration since the start of the current cycle is smaller than the determined envelope period of the current cycle, the comparison signal 2061 is at the logic low level. As an example, if the measured time duration since the start of the current cycle is equal to or larger than the determined envelope period of the current cycle, the comparison signal 2061 is at the logic high level. In certain examples, the comparison signal 2061 is received by the valley detector 2070, which also receives the sampled signal 821.

According to some embodiments, the valley detector 2070 receives the comparison signal 2061 and the sampled signal 821 and generates a detection signal 2071. For example, the sampled signal 821 is used to detect a resonance valley of the voltage 621 (e.g., V_{HB}). As an example, after the comparison signal 2061 changes from the logic low level to the logic high level, if the valley detector 2070 detects a resonance valley of the voltage 621 (e.g., V_{HB}), the valley detector 2070 generates a pulse of the detection signal 2071. In certain examples, the detection signal 2071 is received by the flip flop 2080, which generates the signal 2001. For example, in response to a pulse of the detection signal 2071, the flip flop 2080 changes the signal 2001 from the logic low level to the logic high level, indicating the end of the idle phase of the current cycle of the discontinuous conduction mode (DCM) and the start of the switching phase of the next cycle of the discontinuous conduction mode (DCM). As an example, the end of the idle phase of the current cycle of the discontinuous conduction mode (DCM) is the end of the current cycle of the discontinuous conduction mode (DCM), and the start of the switching phase of the next cycle of the discontinuous conduction mode (DCM) is the start of the next cycle of the discontinuous conduction mode (DCM). In some examples, in response to a pulse of the detection signal 2071, the flip flop 2080 changes the signal 2001 from the logic low level to the logic high level, indicating the end of the current cycle of the discontinuous conduction mode (DCM) and the start of the next cycle of the discontinuous conduction mode (DCM).

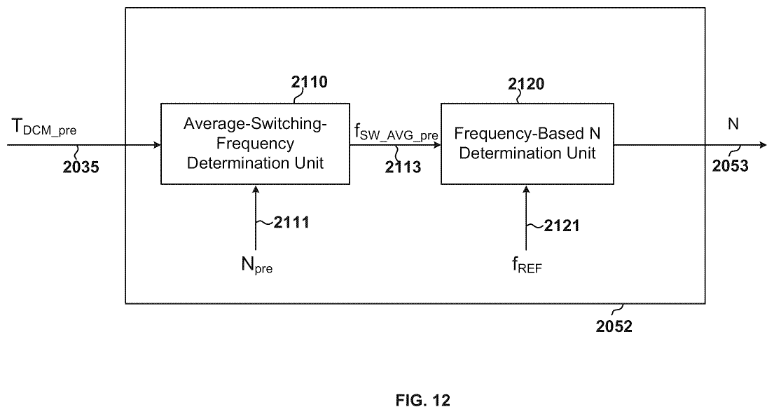

FIG. 12 is a simplified diagram showing the current-N determination unit 2052 of the logic controller 840 as part of the controller chip 710 of the asymmetrical half-bridge flyback switch-mode power converter 700 as shown in FIG. 5, FIG. 6 and FIG. 11 according to some embodiments of the present disclosure. This diagram is merely an example, which should not unduly limit the scope of the claims. One of ordinary skill in the art would recognize many variations, alternatives, and modifications. The current-N determination unit 2052 includes an average-switching-frequency determination unit 2110 and a frequency-based N determination unit 2120. For example, the average-switching-frequency determination unit 2110 is implemented using one or more software components, one or more hardware components, and/or one or more combinations of software and hardware components, and/or the average-switching-frequency determination unit 2110 is implemented in one or more circuits, such as one or more analog circuits and/or one or more digital circuits. As an example, the frequency-based N determination unit 2120 is implemented using one or more software components, one or more hardware components, and/or one or more combinations of software and hardware components, and/or the frequency-based N determination unit 2120 is implemented in one or more circuits, such as one or more analog circuits and/or one or more digital circuits. Although the above has been shown using a selected group of components for the current-N determination unit, there can be many alternatives, modifications, and variations. For example, some of the components may be expanded and/or combined. Other components may be inserted to those noted above. Depending upon the embodiment, the arrangement of components may be interchanged with others replaced. Further details of these components are found throughout the present specification.

According to certain embodiments, the current-N determination unit 2052 receives the signal 2035 that represents the detected envelope period of the previous cycle of the discontinuous conduction mode (DCM), and generates the signal 2053 that represents the determined N for the switching phase of the current cycle of the discontinuous conduction mode (DCM). In some examples, the average-switching-frequency determination unit 2110 receives the signal 2035 that represents the detected envelope period of the previous cycle of the discontinuous conduction mode (DCM) and generates a signal 2113 that represents the average switching frequency of the previous cycle of the discontinuous conduction mode (DCM). In certain examples, the frequency-based N determination unit 2120 receives the signal 2113 that represents the average switching frequency of the previous cycle of the discontinuous conduction mode (DCM) and generates the signal 2053 that represents the determined N for the switching phase of the current cycle of the discontinuous conduction mode (DCM).

According to some embodiments, the average-switching-frequency determination unit 2110 receives the signal 2035 (e.g., an input signal) that represents the detected envelope period of the previous cycle of the discontinuous conduction mode (DCM), and the average-switching-frequency determination unit 2110 also receives a signal 2111 (e.g., an input signal) that represents the number of cycles of critical conduction mode (CRM) during the switching phase of the previous cycle of the discontinuous conduction mode (DCM). In certain examples, based at least in part on the signal 2035 and the signal 2111, the average-switching-frequency determination unit 2110 generates the signal 2113 that represents the average switching frequency of the previous cycle of the discontinuous conduction mode (DCM). For example, the average-switching-frequency determination unit 2110 determines the average switching frequency of the previous cycle of the discontinuous conduction mode (DCM) as follows:

$$\\ \begin{matrix}{f}_{SW \_ AVG \_ pre} = \frac{{N}_{pre}}{{T}_{DCM \_ pre}} & ( Equation 11 )\end{matrix}$$

where f_{SW_AVG_pre} represents the average switching frequency of the previous cycle of the discontinuous conduction mode (DCM). Additionally, Nₚᵣₑ represents the number of cycles (e.g., the number of consecutive cycles) of critical conduction mode (CRM) during the switching phase of the previous cycle of the discontinuous conduction mode (DCM), wherein Nₚᵣₑ is a positive integer. For example, Nₚᵣₑ is equal to one. As an example, Nₚᵣₑ is equal to two. For example, Nₚᵣₑ is equal to three. As an example, Nₚᵣₑ is larger than three. Moreover, T_{DCM_pre} represents the detected envelope period of the previous cycle of the discontinuous conduction mode (DCM).

According to certain embodiments, during the switching phase, the asymmetrical half-bridge flyback switch-mode power converter 700 undergoes Nₚᵣₑ cycles (e.g., Nₚre consecutive cycles) of critical conduction mode (CRM) during the switching phase of the previous cycle of the discontinuous conduction mode (DCM), wherein Nₚᵣₑ is a positive integer. In certain example, the Nₚᵣₑ cycles (e.g., Nₚᵣₑ consecutive cycles) of critical conduction mode (CRM) include Nₚᵣₑ+1 time durations when the control signal 713 remains at the logic high level and the control signal 711 remains at the logic low level and also include Nₚᵣₑ time durations when the control signal 711 remains at the logic high level and the control signal 713 remains at the logic low level. For example, one cycle of the Nₚᵣₑ cycles (e.g., Nₚᵣₑ consecutive cycles) of critical conduction mode (CRM) includes the last time duration of the Nₚᵣₑ time durations, the last time duration of the Nₚᵣₑ+1 time durations, and the first time duration of the Nₚᵣₑ+1 time durations. As an example, if Nₚᵣₑ is equal to or larger than 2, each cycle of the other Nₚᵣₑ cycles (e.g., Nₚᵣₑ consecutive cycles) of critical conduction mode (CRM) includes one time duration of the Nₚᵣₑ time durations and one time duration of the Nₚᵣₑ+1 time durations, wherein the one time duration of the Nₚᵣₑ time durations is not the last time duration of the Nₚᵣₑ time durations, and the one time duration of the Nₚᵣₑ+1 time durations is not the first time duration of the Nₚᵣₑ+1 time durations and is also not the last time duration of the Nₚᵣₑ+1 time durations. In some examples, if Nₚᵣₑ is equal to or larger than 2, each cycle of the Nₚᵣₑ cycles (e.g., Nₚᵣₑ consecutive cycles) of critical conduction mode (CRM) does not share any of the Nₚᵣₑ+1 time durations with any other cycle of the Nₚre cycles (e.g., Nₚᵣₑ consecutive cycles) of critical conduction mode (CRM), and each cycle of the Nₚᵣₑ cycles (e.g., Nₚᵣₑ consecutive cycles) of critical conduction mode (CRM) does not share any of the Nₚᵣₑ time durations with any other cycle of the Nₚᵣₑ cycles (e.g., Nₚre consecutive cycles) of critical conduction mode (CRM).

In some embodiments, during the switching phase of the previous cycle of the discontinuous conduction mode (DCM), the control signal 713 remains at the logic high level and the control signal 711 remains at the logic low level during the Nₚᵣₑ+1 time durations, wherein Nₚᵣₑ is represented by the signal 2111. For example, at the beginning of each time duration of the Nₚᵣₑ+1 time durations, the control signal 713 changes from the logic low level to the logic high level, and at the end of each time duration of the Nₚᵣₑ+1 time durations, the control signal 713 changes from the logic high level to the logic low level. As an example, during the first time duration of the Nₚᵣₑ+1 time durations, the magnetization current 749 decreases from zero to a valley value, and during the last time duration of the Nₚᵣₑ+1 time durations, the magnetization current 749 decreases from a peak value to zero. For example, the last time duration of the Nₚᵣₑ+1 time durations is equal to the demagnetization period of the asymmetrical half-bridge flyback switch-mode power converter 700. In some examples, during the switching phase of the previous cycle of the discontinuous conduction mode (DCM), after the first time duration but before the last time duration, there are Nₚᵣₑ−1 time durations when the control signal 713 remains at the logic high level and the control signal 711 remains at the logic low level, wherein Nₚᵣₑ−1 is equal to zero, equal to one, or equal to or larger than two. In certain examples, during the switching phase of the previous cycle of the discontinuous conduction mode (DCM), the sum of the length of the first time duration and the length of the last time duration is equal to the length of each time duration of the Nₚᵣₑ−1 time durations when the control signal 713 remains at the logic high level and the control signal 711 remains at the logic low level, wherein Nₚᵣₑ is equal to or larger than two. In some examples, during the switching phase of the previous cycle of the discontinuous conduction mode (DCM), the Nₚᵣₑ−1 time durations when the control signal 713 remains at the logic high level and the control signal 711 remains at the logic low level are equal in length, wherein Nₚᵣₑ is equal to or larger than three.

In certain embodiments, during the switching phase of the previous cycle of the discontinuous conduction mode (DCM), the control signal 711 remains at the logic high level and the control signal 713 remains at the logic low level during the Nₚᵣₑ time durations, wherein Nₚᵣₑ is represented by the signal 2111. For example, at the beginning of each time duration of the Nₚᵣₑ time durations, the control signal 711 changes from the logic low level to the logic high level, and at the end of each time duration of the Nₚᵣₑ time durations, the control signal 711 changes from the logic high level to the logic low level. As an example, during the switching phase of the previous cycle of the discontinuous conduction mode (DCM), the control signal 711 changes from the logic low level to the logic high level in a total of Nₚᵣₑ times, and the control signal 711 changes from the logic high level to the logic low level in a total of Nₚᵣₑ times, wherein Nₚᵣₑ is represented by the signal 2111. In some examples, each time duration of the Nₚᵣₑ time durations when the control signal 711 remains at the logic high level and the control signal 713 remains at the logic low level is between two time durations of the Nₚᵣₑ+1 time durations when the control signal 713 remains at the logic high level and the control signal 711 remains at the logic low level. In certain examples, between two time durations of the Nₚᵣₑ+1 time durations when the control signal 713 remains at the logic high level and the control signal 711 remains at the logic low level, there is only one time duration of the Nₚᵣₑ time durations when the control signal 711 remains at the logic high level and the control signal 713 remains at the logic low level.

In some embodiments, the frequency-based N determination unit 2120 receives the signal 2113 that represents the average switching frequency of the previous cycle of the discontinuous conduction mode (DCM), and the frequency-based N determination unit 2120 also receives a signal 2121 that represents a predetermined reference frequency value. For example, the frequency-based N determination unit 2120 generates the signal 2053 that represents the determined N for the switching phase of the current cycle of the discontinuous conduction mode (DCM) based at least in part on the signal 2113 and the signal 2121. As an example, the average-switching-frequency determination unit 2110 determines a ratio related to the average switching frequency of the previous cycle as follows:

$$\\ \begin{matrix}{R}_{N} = \frac{{f}_{SW \_ AVG \_ pre}}{{f}_{REF}} & ( Equation 12 )\end{matrix}$$

where R_{N} represents the ratio related to the average switching frequency of the previous cycle of the discontinuous conduction mode (DCM). Additionally, f_{SW_AVG_pre} represents the average switching frequency of the previous cycle of the discontinuous conduction mode (DCM). Moreover, f_{REF} represents the predetermined reference frequency value.

In certain embodiments, the frequency-based N determination unit 2120 uses the ratio (e.g., R_{N}) related to the average switching frequency of the previous cycle of the discontinuous conduction mode (DCM) to determine N for the switching phase of the current cycle of the discontinuous conduction mode (DCM). In certain examples, if the ratio (e.g., R_{N}) is an integer, the frequency-based N determination unit 2120 determines N for the switching phase of the current cycle of the discontinuous conduction mode (DCM) to be equal to the ratio (e.g., R_{N}). In some examples, if the ratio (e.g., R_{N}) is not an integer, the frequency-based N determination unit 2120 rounds down the ratio (e.g., R_{N}) to the next integer and determines N for the switching phase of the current cycle of the discontinuous conduction mode (DCM) to be equal to the next integer. For example, if the ratio (e.g., R_{N}) is equal to 2.2, N for the switching phase of the current cycle of the discontinuous conduction mode (DCM) is equal to 2. As an example, if the ratio (e.g., R_{N}) is equal to 2.9, N for the switching phase of the current cycle of the discontinuous conduction mode (DCM) is equal to 2.

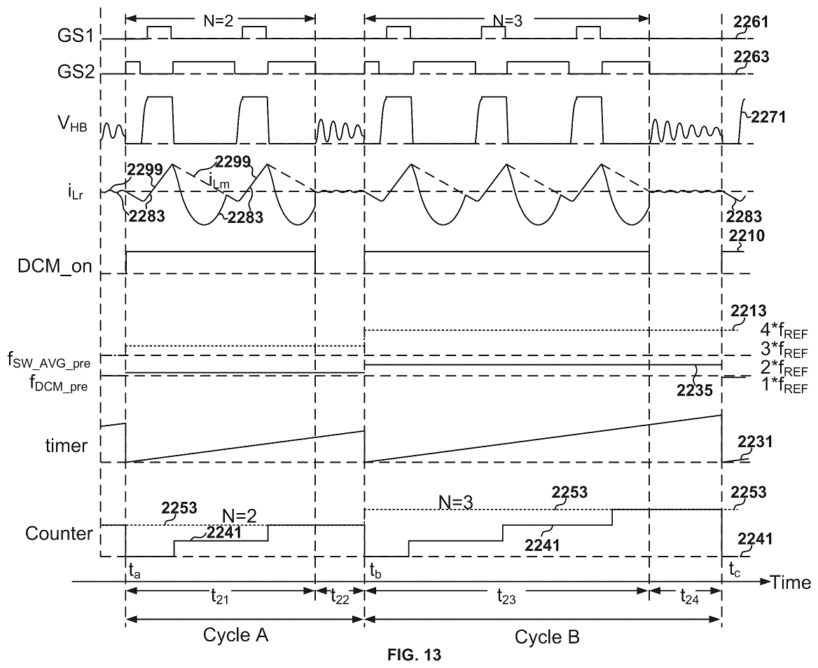

FIG. 13 shows simplified timing diagrams for the asymmetrical half-bridge flyback switch-mode power converter 700 as shown in FIG. 5, FIG. 6, FIG. 11 and FIG. 12 in a discontinuous conduction mode (DCM) according to some embodiments of the present disclosure. Theses diagrams are merely examples, which should not unduly limit the scope of the claims. One of ordinary skill in the art would recognize many variations, alternatives, and modifications. The waveform 2261 represents the control signal 711 as a function of time, the waveform 2263 represents the control signal 713 as a function of time, the waveform 2271 represents the voltage 621 as a function of time, the waveform 2283 represents the current 733 as a function of time, the waveform 2299 represents the magnetization current 749 as a function of time, the waveform 2210 represents the signal 2001 as a function of time, the waveform 2213 represents the average switching frequency of the previous cycle of the discontinuous conduction mode (DCM) as a function of time, the waveform 2235 represents the envelope frequency of the previous cycle of the discontinuous conduction mode (DCM) as a function of time, the waveform 2231 represents the measured time duration since the start of the current cycle of the discontinuous conduction mode (DCM) as a function of time, the waveform 2253 represents the determined N for the switching phase of the current cycle of the discontinuous conduction mode (DCM) as a function of time, and the waveform 2241 represents the number of times that the control signal 711 changes from the logic high level to the logic low level since the start of the current cycle of the discontinuous conduction mode (DCM) as a function of time.

In certain examples, the waveform 2213 represents the average switching frequency of the previous cycle of the discontinuous conduction mode (DCM) as a function of time. For example, the average switching frequency of the previous cycle of the discontinuous conduction mode (DCM) is represented by the signal 2113. In some examples, the waveform 2235 represents the envelope frequency of the previous cycle of the discontinuous conduction mode (DCM) as a function of time. For example, the envelope frequency of the previous cycle of the discontinuous conduction mode (DCM) equals one over the envelope period of the previous cycle of the discontinuous conduction mode (DCM). As an example, the envelope period of the previous cycle of the discontinuous conduction mode (DCM) is represented by the signal 2035. In certain examples, the waveform 2231 represents the measured time duration since the start of the current cycle of the discontinuous conduction mode (DCM) as a function of time. For example, the measured time duration since the start of the current cycle of the discontinuous conduction mode (DCM) is represented by the signal 2031. In some examples, the waveform 2253 represents the determined N for the switching phase of the current cycle of the discontinuous conduction mode (DCM) as a function of time. For example, the determined N for the switching phase of the current cycle of the discontinuous conduction mode (DCM) is represented by the signal 2053. In certain examples, the waveform 2241 represents the number of times that the control signal 711 changes from the logic high level to the logic low level since the start of the current cycle of the discontinuous conduction mode (DCM) as a function of time. For example, the number of times that the control signal 711 changes from the logic high level to the logic low level since the start of the current cycle of the discontinuous conduction mode (DCM) is represented by the signal 2041.

According to certain embodiments, cycle A of the discontinuous conduction mode (DCM) starts from time tₐ to time t_{b}, and cycle B of the discontinuous conduction mode (DCM) starts from time t_{b} to time t_{c}. For example, if cycle A is the current cycle of the discontinuous conduction mode (DCM), cycle B is the next cycle of the discontinuous conduction mode (DCM). As an example, if cycle B is the current cycle of the discontinuous conduction mode (DCM), cycle A is the previous cycle of the discontinuous conduction mode (DCM). In some examples, cycle A of the discontinuous conduction mode (DCM) includes a switching phase t₂₃ and an idle phase t₂₄. In certain examples, cycle B of the discontinuous conduction mode (DCM) includes a switching phase t₂₁ and an idle phase t₂₂.

In some embodiments, if cycle A is the current cycle of the discontinuous conduction mode (DCM), at time tₐ, the envelope period of the previous cycle of the discontinuous conduction mode (DCM) is detected and represented by the signal 2035. For example, using the envelope period of the previous cycle of the discontinuous conduction mode (DCM) that is detected at time tₐ, the average-switching-frequency determination unit 2110 determines the average switching frequency of the previous cycle of the discontinuous conduction mode (DCM). As an example, the average-switching-frequency determination unit 2110 determines a ratio of the average switching frequency of the previous cycle to the predetermined reference frequency value. In certain examples, the ratio of the average switching frequency of the previous cycle to the predetermined reference frequency value is larger than two but less than three, the frequency-based N determination unit 2120 determines N for the switching phase of the current cycle to be equal to two. In some examples, the determined N for the switching phase of cycle A is equal to two. For example, the envelope frequency of cycle A of the discontinuous conduction mode (DCM) is low but larger than the predetermined reference frequency value.

In certain embodiments, if cycle B is the current cycle of the discontinuous conduction mode (DCM), at time t_{b}, the envelope period of the previous cycle (e.g., cycle A) of the discontinuous conduction mode (DCM) is detected and represented by the signal 2035. For example, using the envelope period of the previous cycle (e.g., cycle A) of the discontinuous conduction mode (DCM) that is detected at time t_{b}, the average-switching-frequency determination unit 2110 determines the average switching frequency of the previous cycle (e.g., cycle A) of the discontinuous conduction mode (DCM). As an example, the average-switching-frequency determination unit 2110 determines a ratio of the average switching frequency of the previous cycle (e.g., cycle A) to the predetermined reference frequency value. In certain examples, the ratio of the average switching frequency of the previous cycle (e.g., cycle A) to the predetermined reference frequency value is larger than three but less than four, the frequency-based N determination unit 2120 determines N for the switching phase of cycle B to be equal to three. For example, the envelope frequency of cycle B of the discontinuous conduction mode (DCM) is low but larger than the predetermined reference frequency value.

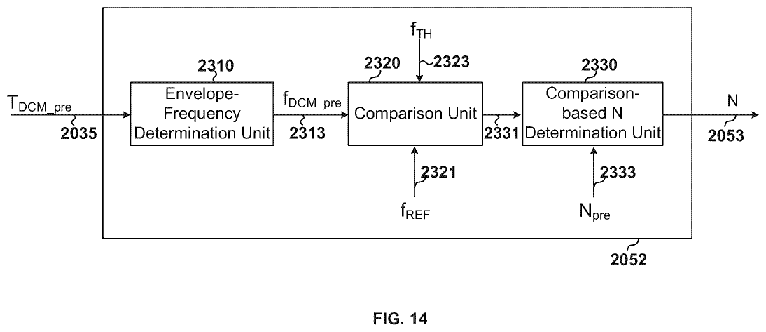

FIG. 14 is a simplified diagram showing the current-N determination unit 2052 of the logic controller 840 as part of the controller chip 710 of the asymmetrical half-bridge flyback switch-mode power converter 700 as shown in FIG. 5, FIG. 6 and FIG. 11 according to some embodiments of the present disclosure. This diagram is merely an example, which should not unduly limit the scope of the claims. One of ordinary skill in the art would recognize many variations, alternatives, and modifications. The current-N determination unit 2052 includes an envelope-frequency determination unit 2310, a comparison unit 2320, and a comparison-based N determination unit 2330. For example, the envelope-frequency determination unit 2310 is implemented using one or more software components, one or more hardware components, and/or one or more combinations of software and hardware components, and/or the envelope-frequency determination unit 2310 is implemented in one or more circuits, such as one or more analog circuits and/or one or more digital circuits. As an example, the comparison unit 2320 is implemented using one or more software components, one or more hardware components, and/or one or more combinations of software and hardware components, and/or the comparison unit 2320 is implemented in one or more circuits, such as one or more analog circuits and/or one or more digital circuits. For example, the comparison-based N determination unit 2330 is implemented using one or more software components, one or more hardware components, and/or one or more combinations of software and hardware components, and/or the comparison-based N determination unit 2330 is implemented in one or more circuits, such as one or more analog circuits and/or one or more digital circuits. Although the above has been shown using a selected group of components for the current-N determination unit, there can be many alternatives, modifications, and variations. For example, some of the components may be expanded and/or combined. Other components may be inserted to those noted above. Depending upon the embodiment, the arrangement of components may be interchanged with others replaced. Further details of these components are found throughout the present specification.

According to certain embodiments, the current-N determination unit 2052 receives the signal 2035 that represents the detected envelope period of the previous cycle of the discontinuous conduction mode (DCM), and generates the signal 2053 that represents the determined N for the switching phase of the current cycle of the discontinuous conduction mode (DCM). In some examples, the envelope-frequency determination unit 2310 receives the signal 2035 (e.g., an input signal) that represents the detected envelope period of the previous cycle of the discontinuous conduction mode (DCM) and generates a signal 2313 that represents the envelope frequency of the previous cycle of the discontinuous conduction mode (DCM). In certain examples, the comparison unit 2320 receives the signal 2313 that represents the envelope frequency of the previous cycle of the discontinuous conduction mode (DCM) and generates a signal 2331 that represents a comparison result. In some examples, the comparison-based N determination unit 2330 receives the signal 2331 that represents a comparison result and generates the signal 2053 that represents the determined N for the switching phase of the current cycle of the discontinuous conduction mode (DCM).

According to some embodiments, the envelope-frequency determination unit 2310 receives the signal 2035 that represents the detected envelope period of the previous cycle of the discontinuous conduction mode (DCM). For example, the envelope-frequency determination unit 2310 generates the signal 2313 that represents the envelope frequency of the previous cycle of the discontinuous conduction mode (DCM) based at least in part on the signal 2035. As an example, the envelope-frequency determination unit 2310 determines the envelope frequency of the previous cycle of the discontinuous conduction mode (DCM) as follows:

$$\\ \begin{matrix}{f}_{DCM \_ pre} = \frac{1}{{T}_{DCM \_ pre}} & ( Equation 13 )\end{matrix}$$

where f_{DCM_pre} represents the envelope frequency of the previous cycle of the discontinuous conduction mode (DCM). Additionally, T_{DCM_pre} represents the detected envelope period of the previous cycle of the discontinuous conduction mode (DCM). For example,

In certain embodiments, the comparison unit 2320 receives the signal 2313 that represents the envelope frequency of the previous cycle of the discontinuous conduction mode (DCM), and the comparison unit 2320 also receives a signal 2321 that represents a predetermined reference frequency value and receives a signal 2323 that represents a predetermined threshold frequency value, wherein the predetermined threshold frequency value is larger than the predetermined reference frequency value. For example, the comparison unit 2320 compares the envelope frequency of the previous cycle of the discontinuous conduction mode (DCM) with the predetermined reference frequency value and/or compares the envelope frequency of the previous cycle of the discontinuous conduction mode (DCM) with the predetermined threshold frequency value. As an example, the comparison unit 2320 determines whether or not the envelope frequency of the previous cycle of the discontinuous conduction mode (DCM) is smaller than the predetermined reference frequency value, and/or whether or not the envelope frequency of the previous cycle of the discontinuous conduction mode (DCM) is larger than the predetermined threshold frequency value. In some examples, the comparison unit 2320 generates the signal 2331 that represents the comparison result based at least in part on the signal 2313, the signal 2321, and/or the signal 2323. For example, the signal 2331 indicates that the envelope frequency of the previous cycle of the discontinuous conduction mode (DCM) is smaller than the predetermined reference frequency value. As an example, the signal 2331 indicates that the envelope frequency of the previous cycle of the discontinuous conduction mode (DCM) is larger than the predetermined threshold frequency value. For example, the signal 2331 indicates that the envelope frequency of the previous cycle of the discontinuous conduction mode (DCM) is not smaller than the predetermined reference frequency value, and also indicates that the envelope frequency of the previous cycle of the discontinuous conduction mode (DCM) is not larger than the predetermined threshold frequency value.

According to some embodiments, the comparison-based N determination unit 2330 receives the signal 2331 that represents the comparison result, and the comparison-based N determination unit 2330 also receives a signal 2333 (e.g., an input signal) that represents the number (e.g., Nₚre) of cycles of critical conduction mode (CRM) during the switching phase of the previous cycle of the discontinuous conduction mode (DCM). In certain examples, Nₚᵣₑ represents the number of cycles (e.g., the number of consecutive cycles) of critical conduction mode (CRM) during the switching phase of the previous cycle of the discontinuous conduction mode (DCM), wherein Nₚᵣₑ is a positive integer. For example, Nₚᵣₑ is equal to one. As an example, Nₚᵣₑ is equal to two. For example, Nₚᵣₑ is equal to three. As an example, Nₚᵣₑ is larger than three. In some examples, the comparison-based N determination unit 2330 generates the signal 2053 that represents the determined N for the switching phase of the current cycle of the discontinuous conduction mode (DCM) based at least in part on the signal 2331 and the signal 2333.

According to certain embodiments, during the switching phase, the asymmetrical half-bridge flyback switch-mode power converter 700 undergoes Nₚᵣₑ cycles (e.g., Nₚre consecutive cycles) of critical conduction mode (CRM) during the switching phase of the previous cycle of the discontinuous conduction mode (DCM), wherein Nₚᵣₑ is a positive integer. In certain example, the Nₚᵣₑ cycles (e.g., Nₚᵣₑ consecutive cycles) of critical conduction mode (CRM) include Nₚᵣₑ+1 time durations when the control signal 713 remains at the logic high level and the control signal 711 remains at the logic low level and also include Nₚᵣₑ time durations when the control signal 711 remains at the logic high level and the control signal 713 remains at the logic low level. For example, one cycle of the Nₚᵣₑ cycles (e.g., Nₚᵣₑ consecutive cycles) of critical conduction mode (CRM) includes the last time duration of the Nₚᵣₑ time durations, the last time duration of the Nₚᵣₑ+1 time durations, and the first time duration of the Nₚᵣₑ+1 time durations. As an example, if Nₚᵣₑ is equal to or larger than 2, each cycle of the other Nₚᵣₑ cycles (e.g., Nₚᵣₑ consecutive cycles) of critical conduction mode (CRM) includes one time duration of the Nₚᵣₑ time durations and one time duration of the Nₚᵣₑ+1 time durations, wherein the one time duration of the Nₚᵣₑ time durations is not the last time duration of the Nₚᵣₑ time durations, and the one time duration of the Nₚᵣₑ+1 time durations is not the first time duration of the Nₚᵣₑ+1 time durations and is also not the last time duration of the Nₚᵣₑ+1 time durations. In some examples, if Nₚᵣₑ is equal to or larger than 2, each cycle of the Nₚᵣₑ cycles (e.g., Nₚᵣₑ consecutive cycles) of critical conduction mode (CRM) does not share any of the Nₚᵣₑ+1 time durations with any other cycle of the Nₚre cycles (e.g., Nₚᵣₑ consecutive cycles) of critical conduction mode (CRM), and each cycle of the Nₚᵣₑ cycles (e.g., Nₚᵣₑ consecutive cycles) of critical conduction mode (CRM) does not share any of the Nₚᵣₑ time durations with any other cycle of the Nₚᵣₑ cycles (e.g., Nₚre consecutive cycles) of critical conduction mode (CRM).

In some embodiments, during the switching phase of the previous cycle of the discontinuous conduction mode (DCM), the control signal 713 remains at the logic high level and the control signal 711 remains at the logic low level during the Nₚᵣₑ+1 time durations, wherein Nₚᵣₑ is represented by the signal 2333. For example, at the beginning of each time duration of the Nₚᵣₑ+1 time durations, the control signal 713 changes from the logic low level to the logic high level, and at the end of each time duration of the Nₚᵣₑ+1 time durations, the control signal 713 changes from the logic high level to the logic low level. As an example, during the first time duration of the Nₚᵣₑ+1 time durations, the magnetization current 749 decreases from zero to a valley value, and during the last time duration of the Nₚᵣₑ+1 time durations, the magnetization current 749 decreases from a peak value to zero. For example, the last time duration of the Nₚᵣₑ+1 time durations is equal to the demagnetization period of the asymmetrical half-bridge flyback switch-mode power converter 700. In some examples, during the switching phase of the previous cycle of the discontinuous conduction mode (DCM), after the first time duration but before the last time duration, there are Nₚᵣₑ−1 time durations when the control signal 713 remains at the logic high level and the control signal 711 remains at the logic low level, wherein Nₚᵣₑ−1 is equal to zero, equal to one, or equal to or larger than two. In certain examples, during the switching phase of the previous cycle of the discontinuous conduction mode (DCM), the sum of the length of the first time duration and the length of the last time duration is equal to the length of each time duration of the Nₚᵣₑ−1 time durations when the control signal 713 remains at the logic high level and the control signal 711 remains at the logic low level, wherein Nₚᵣₑ is equal to or larger than two. In some examples, during the switching phase of the previous cycle of the discontinuous conduction mode (DCM), the Nₚᵣₑ−1 time durations when the control signal 713 remains at the logic high level and the control signal 711 remains at the logic low level are equal in length, wherein Nₚᵣₑ is equal to or larger than three.

In certain embodiments, during the switching phase of the previous cycle of the discontinuous conduction mode (DCM), the control signal 711 remains at the logic high level and the control signal 713 remains at the logic low level during the Nₚᵣₑ time durations, wherein Nₚᵣₑ is represented by the signal 2333. For example, at the beginning of each time duration of the Nₚᵣₑ time durations, the control signal 711 changes from the logic low level to the logic high level, and at the end of each time duration of the Nₚᵣₑ time durations, the control signal 711 changes from the logic high level to the logic low level. As an example, during the switching phase of the previous cycle of the discontinuous conduction mode (DCM), the control signal 711 changes from the logic low level to the logic high level in a total of Nₚᵣₑ times, and the control signal 711 changes from the logic high level to the logic low level in a total of Nₚᵣₑ times, wherein Nₚᵣₑ is represented by the signal 2333. In some examples, each time duration of the Nₚᵣₑ time durations when the control signal 711 remains at the logic high level and the control signal 713 remains at the logic low level is between two time durations of the Nₚᵣₑ+1 time durations when the control signal 713 remains at the logic high level and the control signal 711 remains at the logic low level. In certain examples, between two time durations of the Nₚᵣₑ+1 time durations when the control signal 713 remains at the logic high level and the control signal 711 remains at the logic low level, there is only one time duration of the Nₚᵣₑ time durations when the control signal 711 remains at the logic high level and the control signal 713 remains at the logic low level.

In certain embodiments, if the signal 2331 indicates that the envelope frequency of the previous cycle of the discontinuous conduction mode (DCM) is smaller than the predetermined reference frequency value, the comparison-based N determination unit 2330 determines that N for the switching phase of the current cycle of the discontinuous conduction mode (DCM) is equal to the number of cycles of critical conduction mode (CRM) during the switching phase of the previous cycle of the discontinuous conduction mode (DCM) minus one, as follows:

$$\\ \begin{matrix}N = {N}_{pre} - 1 & ( Equation 14 A )\end{matrix}$$

wherein N represents the number of cycles (e.g., the number of consecutive cycles) of critical conduction mode (CRM) during the switching phase of the current cycle of the discontinuous conduction mode (DCM). Additionally, Nₚᵣₑ represents the number of cycles (e.g., the number of consecutive cycles) of critical conduction mode (CRM) during the switching phase of the previous cycle of the discontinuous conduction mode (DCM). For example, if the signal 2331 indicates that the envelope frequency of the previous cycle of the discontinuous conduction mode (DCM) is smaller than the predetermined reference frequency value, the envelope frequency of the previous cycle of the discontinuous conduction mode (DCM) is smaller than the predetermined reference frequency value and also smaller than the predetermined threshold frequency value. As an example, if the envelope frequency of the previous cycle of the discontinuous conduction mode (DCM) is smaller than the predetermined reference frequency value and also smaller than the predetermined threshold frequency value, the comparison-based N determination unit 2330 determines N for the switching phase of the current cycle of the discontinuous conduction mode (DCM) according to Equation 14A.

In some embodiments, if the signal 2331 indicates that the envelope frequency of the previous cycle of the discontinuous conduction mode (DCM) is larger than the predetermined threshold frequency value, the comparison-based N determination unit 2330 determines that N for the switching phase of the current cycle of the discontinuous conduction mode (DCM) is equal to the number of cycles of critical conduction mode (CRM) during the switching phase of the previous cycle of the discontinuous conduction mode (DCM) plus one, as follows:

$$\\ \begin{matrix}N = {N}_{pre} + 1 & ( Equation 14 B )\end{matrix}$$

wherein N represents the number of cycles (e.g., the number of consecutive cycles) of critical conduction mode (CRM) during the switching phase of the current cycle of the discontinuous conduction mode (DCM). Additionally, Nₚᵣₑ represents the number of cycles (e.g., the number of consecutive cycles) of critical conduction mode (CRM) during the switching phase of the previous cycle of the discontinuous conduction mode (DCM). For example, if the signal 2331 indicates that if the signal 2331 indicates that the envelope frequency of the previous cycle of the discontinuous conduction mode (DCM) is larger than the predetermined threshold frequency value, the envelope frequency of the previous cycle of the discontinuous conduction mode (DCM) is larger than the predetermined threshold frequency value and also larger than the predetermined reference frequency value. As an example, if the envelope frequency of the previous cycle of the discontinuous conduction mode (DCM) is larger than the predetermined threshold frequency value and also larger than the predetermined reference frequency value, the comparison-based N determination unit 2330 determines N for the switching phase of the current cycle of the discontinuous conduction mode (DCM) according to Equation 14B.

In certain embodiments, if the signal 2331 indicates that the envelope frequency of the previous cycle of the discontinuous conduction mode (DCM) is not smaller than the predetermined reference frequency value, and also indicates that the envelope frequency of the previous cycle of the discontinuous conduction mode (DCM) is not larger than the predetermined threshold frequency value, the comparison-based N determination unit 2330 determines that N for the switching phase of the current cycle of the discontinuous conduction mode (DCM) is equal to the number of cycles of critical conduction mode (CRM) during the switching phase of the previous cycle of the discontinuous conduction mode (DCM) as follows:

$$\\ \begin{matrix}N = {N}_{pre} & ( Equation 14 C )\end{matrix}$$

wherein N represents the number of cycles (e.g., the number of consecutive cycles) of critical conduction mode (CRM) during the switching phase of the current cycle of the discontinuous conduction mode (DCM). Additionally, Nₚᵣₑ represents the number of cycles (e.g., the number of consecutive cycles) of critical conduction mode (CRM) during the switching phase of the previous cycle of the discontinuous conduction mode (DCM). For example, if the signal 2331 indicates that the envelope frequency of the previous cycle of the discontinuous conduction mode (DCM) is not smaller than the predetermined reference frequency value, and also indicates that the envelope frequency of the previous cycle of the discontinuous conduction mode (DCM) is not larger than the predetermined threshold frequency value, the envelope frequency of the previous cycle of the discontinuous conduction mode (DCM) is larger than or equal to the predetermined reference frequency value, and also indicates that the envelope frequency of the previous cycle of the discontinuous conduction mode (DCM) is smaller than or equal to the predetermined threshold frequency value. As an example, if the envelope frequency of the previous cycle of the discontinuous conduction mode (DCM) is larger than or equal to the predetermined reference frequency value, and also indicates that the envelope frequency of the previous cycle of the discontinuous conduction mode (DCM) is smaller than or equal to the predetermined threshold frequency value, the comparison-based N determination unit 2330 determines N for the switching phase of the current cycle of the discontinuous conduction mode (DCM) according to Equation 14C.

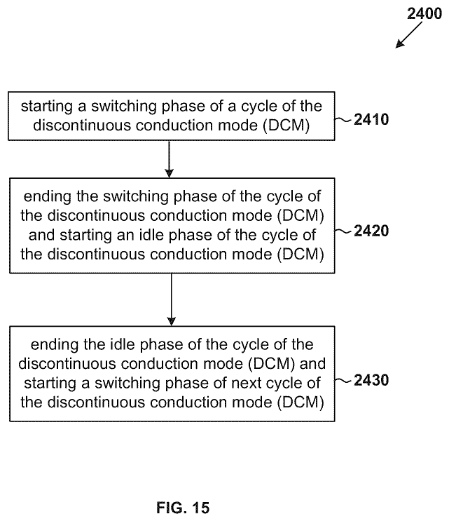

FIG. 15 is a simplified diagram showing a method for the logic controller 840 of the controller chip 710 as part of the asymmetrical half-bridge flyback switch-mode power converter 700 as shown in FIG. 5 and FIG. 6 according to certain embodiments of the present disclosure. This diagram is merely an example, which should not unduly limit the scope of the claims. One of ordinary skill in the art would recognize many variations, alternatives, and modifications. The method 2400 includes a process 2410 for starting a switching phase of a cycle (e.g., a period) of the discontinuous conduction mode (DCM), a process 2420 for ending the switching phase of the cycle (e.g., the period) of the discontinuous conduction mode (DCM) and starting an idle phase of the cycle (e.g., the period) of the discontinuous conduction mode (DCM), and a process 2430 for ending the idle phase of the cycle (e.g., the period) of the discontinuous conduction mode (DCM) and starting a switching phase of next cycle (e.g., next period) of the discontinuous conduction mode (DCM). Although the above has been shown using a selected group of processes for the method, there can be many alternatives, modifications, and variations. For example, some of the processes may be expanded and/or combined. Other processes may be inserted to those noted above. Depending upon the embodiment, the sequence of processes may be interchanged with others replaced. Further details of these processes are found throughout the present specification.

At the process 2410, the logic controller 840 sets the asymmetrical half-bridge flyback switch-mode power converter 700 to start a switching phase of a cycle (e.g., a period) of the discontinuous conduction mode (DCM) according to some embodiments. For example, the logic controller 840 changes the signal 2001 from the logic low level to the logic high level (e.g., as shown in FIG. 11). As an example, when the signal 2001 changes from the logic low level to the logic high level, the switching phase of the cycle of the discontinuous conduction mode (DCM) starts (e.g., as shown in FIG. 7).

In certain examples, every cycle (e.g., every period) of the discontinuous conduction mode (DCM) includes its switching phase (e.g., the time duration t₁₁) and its idle phase (e.g., the time duration t₁₂) that follows its switching phase (e.g., the time duration t₁₁), wherein during the switching phase (e.g., the time duration t₁₁), the asymmetrical half-bridge flyback switch-mode power converter 700 undergoes N cycles (e.g., N consecutive cycles) of critical conduction mode (CRM) with N being a positive integer. For example, the beginning of the switching phase of the cycle of the discontinuous conduction mode (DCM) is the beginning of the cycle of the discontinuous conduction mode (DCM). As an example, during the switching phase (e.g., the time duration t₁₁), the control signal 713 remains at the logic high level and the control signal 711 remains at the logic low level during N+1 time durations (e.g., during 4 time durations as parts of the time duration t₁₁). For example, during the switching phase (e.g., the time duration t₁₁), the control signal 711 remains at the logic high level and the control signal 713 remains at the logic low level during N time durations (e.g., during 3 time durations as parts of the time duration t₁₁). In some examples, each time duration of the N time durations when the control signal 711 remains at the logic high level and the control signal 713 remains at the logic low level is between two time durations of the N+1 time durations when the control signal 713 remains at the logic high level and the control signal 711 remains at the logic low level, and between two time durations of the N+1 time durations when the control signal 713 remains at the logic high level and the control signal 711 remains at the logic low level, there is only one time duration of the N time durations when the control signal 711 remains at the logic high level and the control signal 713 remains at the logic low level.

In certain examples, at the beginning of each time duration of the N+1 time durations (e.g., at the beginning of each time duration of the 4 time durations as parts of the time duration t₁₁), the control signal 713 changes from the logic low level to the logic high level. For example, at the beginning of the first time duration (e.g., time duration t₁₃) of the N+1 time durations, the control signal 713 changes from the logic low level to the logic high level. As an example, the beginning of the first time duration (e.g., time duration t₁₃) of the N+1 time durations is the beginning of the switching phase of the cycle of the discontinuous conduction mode (DCM) and is also the beginning of the cycle of the discontinuous conduction mode (DCM). In some examples, during the first time duration of the N+1 time durations (e.g., during the time duration t₁₃ of the 4 time durations as parts of the time duration t₁₁), the magnetization current 749 decreases from zero to a valley value (e.g., the current value 1793). For example, the magnetization current 749 decreases from zero to the valley value (e.g., the current value 1793) in order to achieve zero-voltage switching for the switch 722.

At the process 2420, the logic controller 840 sets the asymmetrical half-bridge flyback switch-mode power converter 700 to end the switching phase of the cycle of the discontinuous conduction mode (DCM) and to start the idle phase of the cycle of the discontinuous conduction mode (DCM) according to certain embodiments. For example, the logic controller 840 changes the signal 2001 from the logic high level to the logic low level (e.g., as shown in FIG. 11). As an example, when the signal 2001 changes from the high level to the logic low level, the switching phase (e.g., the time duration t₁₁) of the cycle of the discontinuous conduction mode (DCM) ends and the idle phase (e.g., the time duration t₁₂) of the cycle of the discontinuous conduction mode (DCM) starts (e.g., as shown in FIG. 7). In some examples, during the switching phase (e.g., the time duration t₁₁), the control signal 713 remains at the logic high level and the control signal 711 remains at the logic low level during the N+1 time durations (e.g., during the 4 time durations as parts of the time duration t₁₁), and during the idle phase (e.g., the time duration t₁₂), both the control signal 713 and the control signal 711 remains at the logic low level. For example, during the last time duration (e.g., time duration t₁₉) of the N+1 time durations, the magnetization current 749 decreases from a peak value to zero, and the last time duration (e.g., time duration t₁₉) of the N+1 time durations is equal to the demagnetization period of the asymmetrical half-bridge flyback switch-mode power converter 700. As an example, the end of the last time duration (e.g., time duration t₁₉) of the N+1 time durations is the end of the switching phase of the cycle of the discontinuous conduction mode (DCM) and is also the beginning of the idle phase of the cycle of the discontinuous conduction mode (DCM). In certain examples, at the end of each time duration of the N+1 time durations (e.g., at the end of each time duration of the 4 time durations as parts of the time duration t₁₁), the control signal 713 changes from the logic high level to the logic low level. For example, at the end of the last time duration (e.g., time duration t₁₉) of the N+1 time durations, the control signal 713 changes from the logic high level to the logic low level. As an example, the end of the last time duration (e.g., time duration t₁₉) of the N+1 time durations is the end of the switching phase of the cycle of the discontinuous conduction mode (DCM) and is also the beginning of the idle phase of the cycle of the discontinuous conduction mode (DCM).

At the process 2430, the logic controller 840 sets the asymmetrical half-bridge flyback switch-mode power converter 700 to end the idle phase of the cycle of the discontinuous conduction mode (DCM) and to start a switching phase of next cycle of the discontinuous conduction mode (DCM) according to some embodiments. For example, the end of the idle phase of the cycle of the discontinuous conduction mode (DCM) is the end of the cycle of the discontinuous conduction mode (DCM). As an example, the beginning of the switching phase of the next cycle of the discontinuous conduction mode (DCM) is the beginning of the next cycle of the discontinuous conduction mode (DCM). In certain examples, the logic controller 840 changes the signal 2001 from the logic low level to the logic high level (e.g., as shown in FIG. 11). For example, when the signal 2001 changes from the logic low level to the logic high level, the idle phase of the cycle of the discontinuous conduction mode (DCM) ends and the switching phase of the next cycle of the discontinuous conduction mode (DCM) starts (e.g., as shown in FIG. 7).

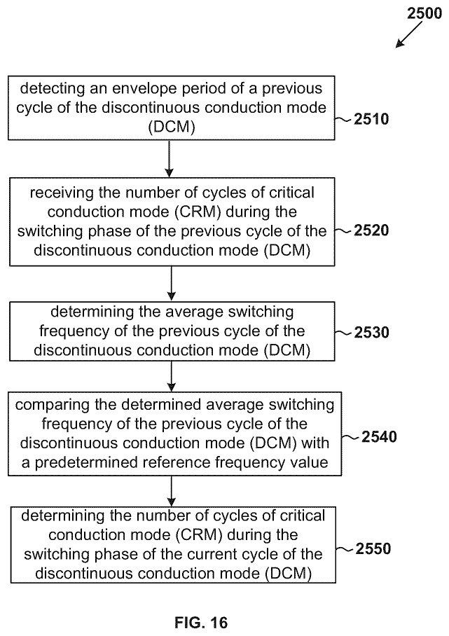

FIG. 16 is a simplified diagram showing a method for determining the number of cycles of critical conduction mode (CRM) for a switching phase of a current cycle of the discontinuous conduction mode (DCM) according to some embodiments of the present disclosure. This diagram is merely an example, which should not unduly limit the scope of the claims. One of ordinary skill in the art would recognize many variations, alternatives, and modifications. The method 2500 includes a process 2510 for detecting an envelope period of a previous cycle of the discontinuous conduction mode (DCM), a process 2520 for receiving the number of cycles of critical conduction mode (CRM) during the switching phase of the previous cycle of the discontinuous conduction mode (DCM), a process 2530 for determining the average switching frequency of the previous cycle of the discontinuous conduction mode (DCM), a process 2540 for comparing the determined average switching frequency of the previous cycle of the discontinuous conduction mode (DCM) with a predetermined reference frequency value, and a process 2550 for determining the number of cycles of critical conduction mode (CRM) during the switching phase of the current cycle of the discontinuous conduction mode (DCM). For example, the method 2500 is implemented by at least the logic controller 840 that includes the current-N determination unit 2052 as part of the controller chip 710 of the asymmetrical half-bridge flyback switch-mode power converter 700 as shown by at least FIG. 11 and/or FIG. 12. As an example, N is represented by the signal 2053 that is generated by the current-N determination unit 2052. Although the above has been shown using a selected group of processes for the method, there can be many alternatives, modifications, and variations. For example, some of the processes may be expanded and/or combined. Other processes may be inserted to those noted above. Depending upon the embodiment, the sequence of processes may be interchanged with others replaced. Further details of these processes are found throughout the present specification.

At the process 2510, an envelope period of a previous cycle of the discontinuous conduction mode (DCM) is detected according to certain embodiments. For example, the previous cycle of the discontinuous conduction mode (DCM) includes a switching phase and an idle phase that follows the switching phase. As an example, the envelope period of the previous cycle of the discontinuous conduction mode (DCM) is equal to the sum of the length of the switching phase of the previous cycle of the discontinuous conduction mode (DCM) and the length of the idle phase of the previous cycle of the discontinuous conduction mode (DCM). In some examples, the process 2510 is performed by at least the envelope-period detector 2034. In certain examples, the detected envelope period of the previous cycle of the discontinuous conduction mode (DCM) is represented by the signal 2035.

At the process 2520, the number of cycles of critical conduction mode (CRM) during the switching phase of the previous cycle of the discontinuous conduction mode (DCM) is received according to some embodiments. For example, the number of cycles of critical conduction mode (CRM) during the switching phase of the previous cycle of the discontinuous conduction mode (DCM) is represented by the signal 2111. As an example, the signal 2111 is received by the average-switching-frequency determination unit 2110.

At the process 2530, an average switching frequency of the previous cycle of the discontinuous conduction mode (DCM) is determined based at least in part on the detected envelope period of the previous cycle of the discontinuous conduction mode (DCM) and the number of cycles of critical conduction mode (CRM) during the switching phase of the previous cycle of the discontinuous conduction mode (DCM) according to certain embodiments. In some examples, the signal 2035 that indicates the detected envelope period of the previous cycle of the discontinuous conduction mode (DCM) is received by the average-switching-frequency determination unit 2110. For example, the process 2530 is performed by at least the average-switching-frequency determination unit 2110 according to at least Equation 11. As an example, the determined average switching frequency of the previous cycle of the discontinuous conduction mode (DCM) is represented by the signal 2113.

At the process 2540, the determined average switching frequency of the previous cycle of the discontinuous conduction mode (DCM) is compared with a predetermined reference frequency value to generate a comparison result according to some embodiments. For example, the determined average switching frequency of the previous cycle of the discontinuous conduction mode (DCM) is compared with the predetermined reference frequency value by calculating a ratio of the determined average switching frequency of the previous cycle of the discontinuous conduction mode (DCM) to the predetermined reference frequency value. As an example, the determined average switching frequency of the previous cycle of the discontinuous conduction mode (DCM) is compared with the predetermined reference frequency value according to Equation 12. In some examples, the comparison result is the ratio of the determined average switching frequency of the previous cycle of the discontinuous conduction mode (DCM) to the predetermined reference frequency value. In certain examples, the process 2540 is performed by at least the frequency-based N determination unit 2120.

At the process 2550, the number of cycles of critical conduction mode (CRM) during a switching phase of a current cycle of the discontinuous conduction mode (DCM) is determined based on at least information associated with the comparison result according to certain embodiments. In some examples, the current cycle of the discontinuous conduction mode (DCM) includes a switching phase and an idle phase that follows the switching phase. For example, the number of cycles of critical conduction mode (CRM) during the switching phase of the current cycle of the discontinuous conduction mode (DCM) is determined based at least in part on the comparison between the determined average switching frequency of the previous cycle of the discontinuous conduction mode (DCM) and the predetermined reference frequency value. As an example, the comparison between the determined average switching frequency of the previous cycle of the discontinuous conduction mode (DCM) and the predetermined reference frequency value is performed by calculating the ratio of the determined average switching frequency of the previous cycle of the discontinuous conduction mode (DCM) to the predetermined reference frequency value (e.g., according to Equation 12).

In certain examples, if the ratio of the determined average switching frequency of the previous cycle of the discontinuous conduction mode (DCM) to the predetermined reference frequency value is an integer, the number of cycles of critical conduction mode (CRM) during the switching phase of the current cycle of the discontinuous conduction mode (DCM) is equal to the integer, which equals the ratio of the determined average switching frequency of the previous cycle of the discontinuous conduction mode (DCM) to the predetermined reference frequency value. In some examples, if the ratio of the determined average switching frequency of the previous cycle of the discontinuous conduction mode (DCM) to the predetermined reference frequency value is not an integer, the ratio of the determined average switching frequency of the previous cycle of the discontinuous conduction mode (DCM) to the predetermined reference frequency value is rounded down to the next integer, and the number of cycles of critical conduction mode (CRM) during the switching phase of the current cycle of the discontinuous conduction mode (DCM) is equal to this next integer. For example, the process 2550 is performed by at least the frequency-based N determination unit 2120. As an example, the determined number of cycles of critical conduction mode (CRM) during the switching phase of the current cycle of the discontinuous conduction mode (DCM) is represented by the signal 2053.

As discussed above and further emphasized here, FIG. 16 is merely an example, which should not unduly limit the scope of the claims. One of ordinary skill in the art would recognize many variations, alternatives, and modifications. For example, after the process 2550 is completed for the current cycle of the discontinuous conduction mode (DCM), when the method 2500 is performed for the next cycle of the discontinuous conduction mode (DCM), the number of cycles of critical conduction mode (CRM) that is previously determined for the current cycle is received as the number of cycles of critical conduction mode (CRM) for the previous cycle at the process 2520.

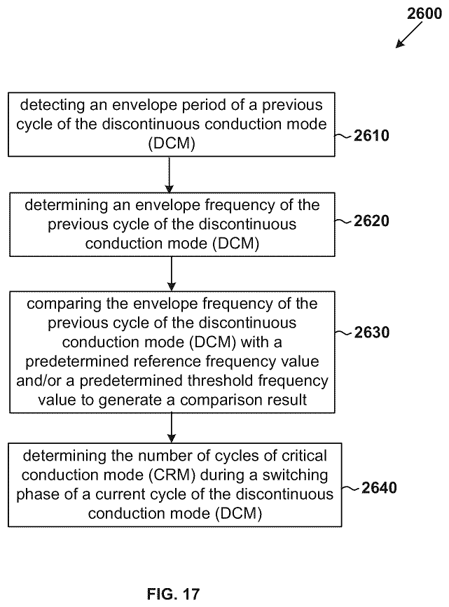

FIG. 17 is a simplified diagram showing a method for determining the number of cycles of critical conduction mode (CRM) for a switching phase of a current cycle of the discontinuous conduction mode (DCM) according to certain embodiments of the present disclosure. This diagram is merely an example, which should not unduly limit the scope of the claims. One of ordinary skill in the art would recognize many variations, alternatives, and modifications. The method 2600 includes a process 2610 for detecting an envelope period of a previous cycle of the discontinuous conduction mode (DCM), a process 2620 for determining an envelope frequency of the previous cycle of the discontinuous conduction mode (DCM), a process 2630 for comparing the envelope frequency of the previous cycle of the discontinuous conduction mode (DCM) with a predetermined reference frequency value and/or a predetermined threshold frequency value to generate a comparison result, and a process 2640 for determining the number of cycles of critical conduction mode (CRM) during a switching phase of a current cycle of the discontinuous conduction mode (DCM). For example, the method 2600 is implemented by at least the logic controller 840 that includes the current-N determination unit 2052 as part of the controller chip 710 of the asymmetrical half-bridge flyback switch-mode power converter 700 as shown by at least FIG. 11 and/or FIG. 14. As an example, N is represented by the signal 2053 that is generated by the current-N determination unit 2052. Although the above has been shown using a selected group of processes for the method, there can be many alternatives, modifications, and variations. For example, some of the processes may be expanded and/or combined. Other processes may be inserted to those noted above. Depending upon the embodiment, the sequence of processes may be interchanged with others replaced. Further details of these processes are found throughout the present specification.

At the process 2610, an envelope period of a previous cycle of the discontinuous conduction mode (DCM) is detected according to certain embodiments. For example, the previous cycle of the discontinuous conduction mode (DCM) includes a switching phase and an idle phase that follows the switching phase. As an example, the envelope period of the previous cycle of the discontinuous conduction mode (DCM) is equal to the sum of the length of the switching phase of the previous cycle of the discontinuous conduction mode (DCM) and the length of the idle phase of the previous cycle of the discontinuous conduction mode (DCM). In some examples, the process 2610 is performed by at least the envelope-period detector 2034. In certain examples, the detected envelope period of the previous cycle of the discontinuous conduction mode (DCM) is represented by the signal 2035.

At the process 2620, an envelope frequency of the previous cycle of the discontinuous conduction mode (DCM) is determined based at least in part on the detected envelope period of the previous cycle of the discontinuous conduction mode (DCM) according to some embodiments. In certain examples, the signal 2035 that indicates the detected envelope period of the previous cycle of the discontinuous conduction mode (DCM) is received by the envelope-frequency determination unit 2310. In some examples, the process 2620 is performed by at least the envelope-frequency determination unit 2310. For example, the envelope-frequency determination unit 2310 determines the envelope frequency of the previous cycle of the discontinuous conduction mode (DCM) according to at least Equation 13. As an example, the determined envelope frequency of the previous cycle of the discontinuous conduction mode (DCM) is represented by the signal 2313

At the process 2630, the envelope frequency of the previous cycle of the discontinuous conduction mode (DCM) is compared with a predetermined reference frequency value and/or a predetermined threshold frequency value to generate a comparison result, wherein the predetermined threshold frequency value is larger than the predetermined reference frequency value according to certain embodiments. In some examples, the process 2630 is performed by at least the comparison unit 2320. In certain examples, the comparison result is represented by the signal 2331. For example, the comparison result is that the envelope frequency of the previous cycle of the discontinuous conduction mode (DCM) is smaller than the predetermined reference frequency value. As an example, the comparison result is that the envelope frequency of the previous cycle of the discontinuous conduction mode (DCM) is larger than the predetermined threshold frequency value. As an example, the envelope frequency of the previous cycle of the discontinuous conduction mode (DCM) is not smaller than the predetermined reference frequency value and is also not larger than the predetermined threshold frequency value.

At the process 2640, the number of cycles of critical conduction mode (CRM) during a switching phase of a current cycle of the discontinuous conduction mode (DCM) is determined according to some embodiments. In some examples, the current cycle of the discontinuous conduction mode (DCM) includes a switching phase and an idle phase that follows the switching phase. In certain examples, the number of cycles of critical conduction mode (CRM) during the switching phase of the current cycle of the discontinuous conduction mode (DCM) is determined based at least in part on the number of cycles of critical conduction mode (CRM) during a switching phase of a previous cycle of the discontinuous conduction mode (DCM) and also the comparison result that is represented by the signal 2331. For example, the previous cycle of the discontinuous conduction mode (DCM) includes its switching phase and its idle phase that follows its switching phase. As an example, the envelope period of the previous cycle of the discontinuous conduction mode (DCM) is equal to the sum of the length of the switching phase of the previous cycle of the discontinuous conduction mode (DCM) and the length of the idle phase of the previous cycle of the discontinuous conduction mode (DCM).

In some examples, if the comparison result is that the envelope frequency of the previous cycle of the discontinuous conduction mode (DCM) is smaller than the predetermined reference frequency value, the number of cycles of critical conduction mode (CRM) during the switching phase of the current cycle of the discontinuous conduction mode (DCM) is equal to the number of cycles of critical conduction mode (CRM) during the switching phase of the previous cycle of the discontinuous conduction mode (DCM) minus one (e.g., according to Equation 14A). In certain examples, if the comparison result is that the envelope frequency of the previous cycle of the discontinuous conduction mode (DCM) is larger than the predetermined threshold frequency value, the number of cycles of critical conduction mode (CRM) during the switching phase of the current cycle of the discontinuous conduction mode (DCM) is equal to the number of cycles of critical conduction mode (CRM) during the switching phase of the previous cycle of the discontinuous conduction mode (DCM) plus one (e.g., according to Equation 14B). In some examples, if the comparison result is that the envelope frequency of the previous cycle of the discontinuous conduction mode (DCM) is not smaller than the predetermined reference frequency value and the envelope frequency of the previous cycle of the discontinuous conduction mode (DCM) is not larger than the predetermined threshold frequency value, the number of cycles of critical conduction mode (CRM) during the switching phase of the current cycle of the discontinuous conduction mode (DCM) is equal to the number of cycles of critical conduction mode (CRM) during the switching phase of the previous cycle of the discontinuous conduction mode (DCM).

As discussed above and further emphasized here, FIG. 17 is merely an example, which should not unduly limit the scope of the claims. One of ordinary skill in the art would recognize many variations, alternatives, and modifications. For example, after the process 2640 is completed for the current cycle of the discontinuous conduction mode (DCM), when the method 2600 is performed for the next cycle of the discontinuous conduction mode (DCM), the number of cycles of critical conduction mode (CRM) that is previously determined for the current cycle is used as the number of cycles of critical conduction mode (CRM) for the previous cycle at the process 2640.

Certain embodiments of the present disclosure provide an asymmetrical half-bridge flyback switch-mode power converter that determines the number of cycles of critical conduction mode (CRM) during a switching phase of the discontinuous conduction mode (DCM). In some examples, the asymmetrical half-bridge flyback switch-mode power converter changes the number of cycles of critical conduction mode (CRM) during a switching phase from one cycle to another cycle of the discontinuous conduction mode (DCM) so that the asymmetrical half-bridge flyback switch-mode power converter operates at high efficiency with different output powers.

According to some embodiments, a controller for a power converter, the power converter including a first transistor and a second transistor coupled to the first transistor, the controller including: a logic controller including a signal generator and configured to generate a first logic signal and a second logic signal; and a driver configured to generate a first control signal and a second control signal based at least in part on the first logic signal and the second logic signal, output the first control signal to the first transistor, and output the second control signal to the second transistor; wherein the signal generator is configured to generate a phase control signal; wherein the signal generator is further configured to: change the phase control signal from a first logic level to a second logic level to start a first switching phase of a first period of a discontinuous conduction mode; change the phase control signal from the second logic level to the first logic level to end the first switching phase of the first period of the discontinuous conduction mode and to start a first idle phase of the first period of the discontinuous conduction mode; and change the phase control signal from the first logic level to the second logic level to end the first idle phase of the first period of the discontinuous conduction mode and to start a second switching phase of a second period of the discontinuous conduction mode; wherein: the first period of the discontinuous conduction mode includes the first switching phase and the first idle phase; and the first switching phase of the first period of the discontinuous conduction mode includes N cycles of a critical conduction mode, N being a positive integer. For example, the controller is implemented according to at least FIG. 5, FIG. 6, FIG. 7 and/or FIG. 15.

As an example, the first logic level is a logic low level; and the second logic level is a logic high level. For example, during the first idle phase of the first period of the discontinuous conduction mode, the first control signal remains at a third logic level so that the first transistor remains being turned off; and the second control signal remains at the third logic level so that the second transistor remains being turned off. For example, the first switching phase of the first period of the discontinuous conduction mode includes: N time durations when the first control signal remains at a fourth logic level and the second control signal remains at the third logic level; and N+1 time durations when the second control signal remains at the fourth logic level and the first control signal remains at the third logic level; wherein the third logic level and the fourth logic level are different. As an example, the third logic level is a logic low level; and the fourth logic level is a logic high level. For example, one cycle of the N cycles of the critical conduction mode includes the last time duration of the N time durations, the last time duration of the N+1 time durations, and the first time duration of the N+1 time durations. As an example, another cycle of the N cycles of the critical conduction mode includes one time duration of the N time durations and one time duration of the N+1 time durations; wherein: the one time duration of the N time durations is not the last time duration of the N time durations; and the one time duration of the N+1 time durations is not the first time duration of the N+1 time durations and is not the last time duration of the N+1 time durations. For example, each cycle of the N cycles of the critical conduction mode does not share any of the N time durations with any other cycle of the N cycles of the critical conduction mode; and each cycle of the N cycles of the critical conduction mode does not share any of the N+1 time durations with any other cycle of the N cycles of critical conduction mode.

According to certain embodiments, a controller for a power converter includes: a logic controller configured to generate a first logic signal and a second logic signal; and a driver configured to generate a first control signal and a second control signal based at least in part on the first logic signal and the second logic signal; wherein the logic controller includes a determination unit configured to: receive a first input signal indicating a first envelope period of a first period of a discontinuous conduction mode; receive a second input signal indicating a first number of cycles of a critical conduction mode for a first switching phase of the first period of the discontinuous conduction mode; determine an average switching frequency for the first period of the discontinuous conduction mode based at least in part on the first input signal and the second input signal; compare the determined average switching frequency for the first period of the discontinuous conduction mode with a predetermined reference frequency value to generate a comparison result; and determine a second number of cycles of the critical conduction mode for a second switching phase of a second period of the discontinuous conduction mode based on at least information associated with the comparison result; wherein: the first switching phase of the first period of the discontinuous conduction mode includes the first number of cycles of the critical conduction mode; and the second switching phase of the second period of the discontinuous conduction mode includes the second number of cycles of the critical conduction mode. For example, the controller is implemented according to at least FIG. 5, FIG. 6, FIG. 7, FIG. 11, FIG. 12, FIG. 13, and/or FIG. 16.

As an example, the first period of the discontinuous conduction mode ends and the second period of the discontinuous conduction mode starts at a same time. For example, the determination unit is further configured to determine the average switching frequency for the first period of the discontinuous conduction mode to be equal to the first number of cycles of the critical conduction mode for the first switching phase of the first period of the discontinuous conduction mode divided by the first envelope period of the first period of the discontinuous conduction mode. As an example, the comparison result includes a ratio of the determined average switching frequency for the first period of the discontinuous conduction mode to the predetermined reference frequency value. For example, the determination unit is further configured to, if the ratio of the determined average switching frequency for the first period of the discontinuous conduction mode to the predetermined reference frequency value is an integer, determine the second number of cycles of the critical conduction mode for the second switching phase of the second period of the discontinuous conduction mode to be equal to the ratio. As an example, the determination unit is further configured to, if the ratio of the determined average switching frequency for the first period of the discontinuous conduction mode to the predetermined reference frequency value is not an integer, round down the ratio to a next integer; and determine the second number of cycles of the critical conduction mode for the second switching phase of the second period of the discontinuous conduction mode to be equal to the next integer.

According to some embodiments, a controller for a power converter includes: a logic controller configured to generate a first logic signal and a second logic signal; and a driver configured to generate a first control signal and a second control signal based at least in part on the first logic signal and the second logic signal; wherein the logic controller includes a determination unit configured to: receive a first input signal indicating an envelope period of a first period of a discontinuous conduction mode; determine an envelope frequency of the first period of the discontinuous conduction mode based at least in part on the first input signal; compare the envelope frequency of the first period of the discontinuous conduction mode with at least one value selected from a group consisting of a predetermined reference frequency value and a predetermined threshold frequency value to generate a comparison result; receive a second input signal indicating a first number of cycles of a critical conduction mode for a first switching phase of the first period of the discontinuous conduction mode; and determine a second number of cycles of the critical conduction mode for a second switching phase of a second period of the discontinuous conduction mode based on at least information associated with the comparison result and the second input signal; wherein the predetermined threshold frequency value is larger than the predetermined reference frequency value; wherein: the first switching phase of the first period of the discontinuous conduction mode includes the first number of cycles of the critical conduction mode; and the second switching phase of the second period of the discontinuous conduction mode includes the second number of cycles of the critical conduction mode. For example, the controller is implemented according to at least FIG. 5, FIG. 6, FIG. 7, FIG. 11, FIG. 14, and/or FIG. 17.

As an example, the first period of the discontinuous conduction mode ends and the second period of the discontinuous conduction mode starts at a same time. For example, the determination unit is further configured to determine the envelope frequency of the first period of the discontinuous conduction mode to be equal to one over the envelope period of the first period of the discontinuous conduction mode. As an example, the determination unit is further configured to, if the comparison result indicates that the envelope frequency of the first period of the discontinuous conduction mode is smaller than the predetermined reference frequency value, determine the second number of cycles of the critical conduction mode for the second switching phase of the second period of the discontinuous conduction mode to be equal to the first number of cycles of the critical conduction mode for the first switching phase of the first period of the discontinuous conduction mode minus one. For example, the determination unit is further configured to, if the comparison result indicates that the envelope frequency of the first period of the discontinuous conduction mode is larger than the predetermined threshold frequency value, determine the second number of cycles of the critical conduction mode for the second switching phase of the second period of the discontinuous conduction mode to be equal to the first number of cycles of the critical conduction mode for the first switching phase of the first period of the discontinuous conduction mode plus one. As an example, the determination unit is further configured to, if the comparison result indicates that the envelope frequency of the first period of the discontinuous conduction mode is smaller than the predetermined threshold frequency value and larger than the predetermined reference frequency value, determine the second number of cycles of the critical conduction mode for the second switching phase of the second period of the discontinuous conduction mode to be equal to the first number of cycles of the critical conduction mode for the first switching phase of the first period of the discontinuous conduction mode.

According to certain embodiments, a method for a power converter including a first transistor and a second transistor coupled to the first transistor, the method including: generating a first logic signal and a second logic signal; receiving the first logic signal and the second logic signal; generating a first control signal and a second control signal based at least in part on the first logic signal and the second logic signal; outputting the first control signal to the first transistor; and outputting the second control signal to the second transistor; wherein the generating a first logic signal and a second logic signal includes generating a phase control signal; wherein the generating a phase control signal includes: changing the phase control signal from a first logic level to a second logic level to start a first switching phase of a first period of a discontinuous conduction mode; changing the phase control signal from the second logic level to the first logic level to end the first switching phase of the first period of the discontinuous conduction mode and to start a first idle phase of the first period of the discontinuous conduction mode; and changing the phase control signal from the first logic level to the second logic level to end the first idle phase of the first period of the discontinuous conduction mode and to start a second switching phase of a second period of the discontinuous conduction mode; wherein: the first period of the discontinuous conduction mode includes the first switching phase and the first idle phase; and the first switching phase of the first period of the discontinuous conduction mode includes N cycles of a critical conduction mode, N being a positive integer. For example, the method is implemented according to at least FIG. 5, FIG. 6, FIG. 7 and/or FIG. 15.

According to some embodiments, a method for a power converter includes: generating a first logic signal and a second logic signal; receiving the first logic signal and the second logic signal; and generating a first control signal and a second control signal based at least in part on the first logic signal and the second logic signal; wherein the generating a first logic signal and a second logic signal includes: receiving a first input signal indicating a first envelope period of a first period of a discontinuous conduction mode; receiving a second input signal indicating a first number of cycles of a critical conduction mode for a first switching phase of the first period of the discontinuous conduction mode; determining an average switching frequency for the first period of the discontinuous conduction mode based at least in part on the first input signal and the second input signal; comparing the determined average switching frequency for the first period of the discontinuous conduction mode with a predetermined reference frequency value to generate a comparison result; and determining a second number of cycles of the critical conduction mode for a second switching phase of a second period of the discontinuous conduction mode based on at least information associated with the comparison result; wherein: the first switching phase of the first period of the discontinuous conduction mode includes the first number of cycles of the critical conduction mode; and the second switching phase of the second period of the discontinuous conduction mode includes the second number of cycles of the critical conduction mode. For example, the method is implemented according to at least FIG. 5, FIG. 6, FIG. 7, FIG. 11, FIG. 12, FIG. 13, and/or FIG. 16.

According to certain embodiments, a method for a power converter includes: generating a first logic signal and a second logic signal; receiving the first logic signal and the second logic signal; and generating a first control signal and a second control signal based at least in part on the first logic signal and the second logic signal; wherein the generating a first logic signal and a second logic signal includes: receiving a first input signal indicating an envelope period of a first period of a discontinuous conduction mode; determining an envelope frequency of the first period of the discontinuous conduction mode based at least in part on the first input signal; comparing the envelope frequency of the first period of the discontinuous conduction mode with at least one value selected from a group consisting of a predetermined reference frequency value and a predetermined threshold frequency value to generate a comparison result; receiving a second input signal indicating a first number of cycles of a critical conduction mode for a first switching phase of the first period of the discontinuous conduction mode; and determining a second number of cycles of the critical conduction mode for a second switching phase of a second period of the discontinuous conduction mode based on at least information associated with the comparison result and the second input signal; wherein the predetermined threshold frequency value is larger than the predetermined reference frequency value; wherein: the first switching phase of the first period of the discontinuous conduction mode includes the first number of cycles of the critical conduction mode; and the second switching phase of the second period of the discontinuous conduction mode includes the second number of cycles of the critical conduction mode. For example, the method is implemented according to at least FIG. 5, FIG. 6, FIG. 7, FIG. 11, FIG. 14, and/or FIG. 17.

For example, some or all components of various embodiments of the present disclosure each are, individually and/or in combination with at least another component, implemented using one or more software components, one or more hardware components, and/or one or more combinations of software and hardware components. As an example, some or all components of various embodiments of the present disclosure each are, individually and/or in combination with at least another component, implemented in one or more circuits, such as one or more analog circuits and/or one or more digital circuits. For example, various embodiments and/or examples of the present disclosure can be combined.

Although specific embodiments of the present disclosure have been described, it will be understood by those of skill in the art that there are other embodiments that are equivalent to the described embodiments. Accordingly, it is to be understood that the invention is not to be limited by the specific illustrated embodiments.

What is claimed is:

1. A controller for a power converter, the power converter including a first transistor and a second transistor coupled to the first transistor, the controller comprising:
a logic controller including a signal generator and configured to generate a first logic signal and a second logic signal; and
a driver configured to generate a first control signal and a second control signal based at least in part on the first logic signal and the second logic signal, output the first control signal to the first transistor, and output the second control signal to the second transistor;
wherein the signal generator is configured to generate a phase control signal;
wherein the signal generator is further configured to:
change the phase control signal from a first logic level to a second logic level to start a first switching phase of a first period of a discontinuous conduction mode;
change the phase control signal from the second logic level to the first logic level to end the first switching phase of the first period of the discontinuous conduction mode and to start a first idle phase of the first period of the discontinuous conduction mode; and
change the phase control signal from the first logic level to the second logic level to end the first idle phase of the first period of the discontinuous conduction mode and to start a second switching phase of a second period of the discontinuous conduction mode;
wherein:
the first period of the discontinuous conduction mode includes the first switching phase and the first idle phase; and
the first switching phase of the first period of the discontinuous conduction mode includes N cycles of a critical conduction mode, N being a positive integer.

2. The controller of claim 1 wherein:
the first logic level is a logic low level; and
the second logic level is a logic high level.

3. The controller of claim 1 wherein, during the first idle phase of the first period of the discontinuous conduction mode,
the first control signal remains at a third logic level so that the first transistor remains being turned off; and
the second control signal remains at the third logic level so that the second transistor remains being turned off.

4. The controller of claim 1 wherein the first switching phase of the first period of the discontinuous conduction mode includes:
N time durations when the first control signal remains at a fourth logic level and the second control signal remains at the third logic level; and
N+1 time durations when the second control signal remains at the fourth logic level and the first control signal remains at the third logic level;
wherein the third logic level and the fourth logic level are different.

5. The controller of claim 4 wherein:
the third logic level is a logic low level; and
the fourth logic level is a logic high level.

6. The controller of claim 4 wherein one cycle of the N cycles of the critical conduction mode includes the last time duration of the N time durations, the last time duration of the N+1 time durations, and the first time duration of the N+1 time durations.

7. The controller of claim 6 wherein:
another cycle of the N cycles of the critical conduction mode includes one time duration of the N time durations and one time duration of the N+1 time durations;
wherein:
the one time duration of the N time durations is not the last time duration of the N time durations; and
the one time duration of the N+1 time durations is not the first time duration of the N+1 time durations and is not the last time duration of the N+1 time durations.

8. The controller of claim 4 wherein:
each cycle of the N cycles of the critical conduction mode does not share any of the N time durations with any other cycle of the N cycles of the critical conduction mode; and
each cycle of the N cycles of the critical conduction mode does not share any of the N+1 time durations with any other cycle of the N cycles of critical conduction mode.

9. A controller for a power converter, the controller comprising:
a logic controller configured to generate a first logic signal and a second logic signal; and
a driver configured to generate a first control signal and a second control signal based at least in part on the first logic signal and the second logic signal;
wherein the logic controller includes a determination unit configured to:
receive a first input signal indicating a first envelope period of a first period of a discontinuous conduction mode;
receive a second input signal indicating a first number of cycles of a critical conduction mode for a first switching phase of the first period of the discontinuous conduction mode;
determine an average switching frequency for the first period of the discontinuous conduction mode based at least in part on the first input signal and the second input signal;
compare the determined average switching frequency for the first period of the discontinuous conduction mode with a predetermined reference frequency value to generate a comparison result; and
determine a second number of cycles of the critical conduction mode for a second switching phase of a second period of the discontinuous conduction mode based on at least information associated with the comparison result;
wherein:
the first switching phase of the first period of the discontinuous conduction mode includes the first number of cycles of the critical conduction mode; and
the second switching phase of the second period of the discontinuous conduction mode includes the second number of cycles of the critical conduction mode.

10. The controller of claim 9 wherein the first period of the discontinuous conduction mode ends and the second period of the discontinuous conduction mode starts at a same time.

11. The controller of claim 9 wherein the determination unit is further configured to determine the average switching frequency for the first period of the discontinuous conduction mode to be equal to the first number of cycles of the critical conduction mode for the first switching phase of the first period of the discontinuous conduction mode divided by the first envelope period of the first period of the discontinuous conduction mode.

12. The controller of claim 11 wherein the comparison result includes a ratio of the determined average switching frequency for the first period of the discontinuous conduction mode to the predetermined reference frequency value.

13. The controller of claim 12 wherein the determination unit is further configured to, if the ratio of the determined average switching frequency for the first period of the discontinuous conduction mode to the predetermined reference frequency value is an integer, determine the second number of cycles of the critical conduction mode for the second switching phase of the second period of the discontinuous conduction mode to be equal to the ratio.

14. The controller of claim 13 wherein the determination unit is further configured to, if the ratio of the determined average switching frequency for the first period of the discontinuous conduction mode to the predetermined reference frequency value is not an integer,
round down the ratio to a next integer; and
determine the second number of cycles of the critical conduction mode for the second switching phase of the second period of the discontinuous conduction mode to be equal to the next integer.

15. A controller for a power converter, the controller comprising:
a logic controller configured to generate a first logic signal and a second logic signal; and
a driver configured to generate a first control signal and a second control signal based at least in part on the first logic signal and the second logic signal;
wherein the logic controller includes a determination unit configured to:
receive a first input signal indicating an envelope period of a first period of a discontinuous conduction mode;
determine an envelope frequency of the first period of the discontinuous conduction mode based at least in part on the first input signal;
compare the envelope frequency of the first period of the discontinuous conduction mode with at least one value selected from a group consisting of a predetermined reference frequency value and a predetermined threshold frequency value to generate a comparison result;
receive a second input signal indicating a first number of cycles of a critical conduction mode for a first switching phase of the first period of the discontinuous conduction mode; and
determine a second number of cycles of the critical conduction mode for a second switching phase of a second period of the discontinuous conduction mode based on at least information associated with the comparison result and the second input signal;
wherein the predetermined threshold frequency value is larger than the predetermined reference frequency value;
wherein:
the first switching phase of the first period of the discontinuous conduction mode includes the first number of cycles of the critical conduction mode; and
the second switching phase of the second period of the discontinuous conduction mode includes the second number of cycles of the critical conduction mode.

16. The controller of claim 15 wherein the first period of the discontinuous conduction mode ends and the second period of the discontinuous conduction mode starts at a same time.

17. The controller of claim 15 wherein the determination unit is further configured to determine the envelope frequency of the first period of the discontinuous conduction mode to be equal to one over the envelope period of the first period of the discontinuous conduction mode.

18. The controller of claim 17 wherein the determination unit is further configured to, if the comparison result indicates that the envelope frequency of the first period of the discontinuous conduction mode is smaller than the predetermined reference frequency value, determine the second number of cycles of the critical conduction mode for the second switching phase of the second period of the discontinuous conduction mode to be equal to the first number of cycles of the critical conduction mode for the first switching phase of the first period of the discontinuous conduction mode minus one.

19. The controller of claim 17 wherein the determination unit is further configured to, if the comparison result indicates that the envelope frequency of the first period of the discontinuous conduction mode is larger than the predetermined threshold frequency value, determine the second number of cycles of the critical conduction mode for the second switching phase of the second period of the discontinuous conduction mode to be equal to the first number of cycles of the critical conduction mode for the first switching phase of the first period of the discontinuous conduction mode plus one.

20. The controller of claim 17 wherein the determination unit is further configured to, if the comparison result indicates that the envelope frequency of the first period of the discontinuous conduction mode is smaller than the predetermined threshold frequency value and larger than the predetermined reference frequency value, determine the second number of cycles of the critical conduction mode for the second switching phase of the second period of the discontinuous conduction mode to be equal to the first number of cycles of the critical conduction mode for the first switching phase of the first period of the discontinuous conduction mode.

21. A method for a power converter including a first transistor and a second transistor coupled to the first transistor, the method comprising:
generating a first logic signal and a second logic signal;
receiving the first logic signal and the second logic signal;
generating a first control signal and a second control signal based at least in part on the first logic signal and the second logic signal;
outputting the first control signal to the first transistor; and
outputting the second control signal to the second transistor;
wherein the generating a first logic signal and a second logic signal includes generating a phase control signal;
wherein the generating a phase control signal includes:
changing the phase control signal from a first logic level to a second logic level to start a first switching phase of a first period of a discontinuous conduction mode;
changing the phase control signal from the second logic level to the first logic level to end the first switching phase of the first period of the discontinuous conduction mode and to start a first idle phase of the first period of the discontinuous conduction mode; and
changing the phase control signal from the first logic level to the second logic level to end the first idle phase of the first period of the discontinuous conduction mode and to start a second switching phase of a second period of the discontinuous conduction mode;
wherein:
the first period of the discontinuous conduction mode includes the first switching phase and the first idle phase; and
the first switching phase of the first period of the discontinuous conduction mode includes N cycles of a critical conduction mode, N being a positive integer.

22. A method for a power converter, the method comprising:
generating a first logic signal and a second logic signal;
receiving the first logic signal and the second logic signal; and
generating a first control signal and a second control signal based at least in part on the first logic signal and the second logic signal;
wherein the generating a first logic signal and a second logic signal includes:
receiving a first input signal indicating a first envelope period of a first period of a discontinuous conduction mode;
receiving a second input signal indicating a first number of cycles of a critical conduction mode for a first switching phase of the first period of the discontinuous conduction mode;
determining an average switching frequency for the first period of the discontinuous conduction mode based at least in part on the first input signal and the second input signal;
comparing the determined average switching frequency for the first period of the discontinuous conduction mode with a predetermined reference frequency value to generate a comparison result; and
determining a second number of cycles of the critical conduction mode for a second switching phase of a second period of the discontinuous conduction mode based on at least information associated with the comparison result;
wherein:
the first switching phase of the first period of the discontinuous conduction mode includes the first number of cycles of the critical conduction mode; and
the second switching phase of the second period of the discontinuous conduction mode includes the second number of cycles of the critical conduction mode.

23. A method for a power converter, the method comprising:
generating a first logic signal and a second logic signal;
receiving the first logic signal and the second logic signal; and
generating a first control signal and a second control signal based at least in part on the first logic signal and the second logic signal;
wherein the generating a first logic signal and a second logic signal includes:
receiving a first input signal indicating an envelope period of a first period of a discontinuous conduction mode;
determining an envelope frequency of the first period of the discontinuous conduction mode based at least in part on the first input signal;
comparing the envelope frequency of the first period of the discontinuous conduction mode with at least one value selected from a group consisting of a predetermined reference frequency value and a predetermined threshold frequency value to generate a comparison result;
receiving a second input signal indicating a first number of cycles of a critical conduction mode for a first switching phase of the first period of the discontinuous conduction mode; and
determining a second number of cycles of the critical conduction mode for a second switching phase of a second period of the discontinuous conduction mode based on at least information associated with the comparison result and the second input signal;
wherein the predetermined threshold frequency value is larger than the predetermined reference frequency value;
wherein:
the first switching phase of the first period of the discontinuous conduction mode includes the first number of cycles of the critical conduction mode; and
the second switching phase of the second period of the discontinuous conduction mode includes the second number of cycles of the critical conduction mode.
